(19) United States
(12) Patent Application Publication
(10) Pub. No.: US 2024/0251807 A1
(43) Pub. Date: Aug. 1, 2024

(54) SYSTEMS AND METHODS FOR DISPERSING ACTIVE INGREDIENTS

(71) Applicant: Hazel Technologies, Inc., Chicago, IL (US)

(72) Inventors: Matthew E. Carnes, Chicago, IL (US); Adam John Dannenhoffer, Ithaca, NY (US); Brianna Therese Shores, Chicago, IL (US); Adam Truett Preslar, London (GB)

(73) Assignee: Hazel Technologies, Inc., Chicago, IL (US)

(21) Appl. No.: 18/560,674

(22) PCT Filed: May 12, 2022
(86) PCT No.: PCT/US22/28909

§ 371 Date: Nov. 13, 2023

Related U.S. Application Data
(60) Provisional application No. 63/196,861, filed on Jun. 4, 2021.
(60) Provisional application No. 63/189,027, filed on May 14, 2021.

(51) Int. Cl. A23B 7/152; A01M 13/00

(52) U.S. Cl. CPC A23B 7/152; A01M 13/00

(57) ABSTRACT

Devices, systems, and methods for releasing active ingredients, including volatile active ingredients, are described. The active ingredients may be released for agricultural applications prior to, during, and/or after harvest of produce. In some instances, the devices, systems, and/or methods promote relatively rapid release of active ingredients from a bed containing a porous and solid delivery material (e.g., a particulate material) via direction of gaseous fluid flow through the bed. For example, a pump (e.g., a fan) connected to a housing comprising the bed may propel gas (e.g., air) through the bed, thereby inducing, maintaining, and/or accelerating release of the active ingredient. In some embodiments, the devices, systems, and/or methods described herein facilitate fast, safe, and efficient fumigation of agricultural and/or horticultural products with active ingredients, before, during, and/or after their harvest.

### RELATED APPLICATIONS

This application claims priority under 35 U.S.C. § 119(e) to U.S. Provisional Patent Application No. 63/196,861, filed Jun. 4, 2021, and entitled, “Systems and Methods for Dispersing Active Ingredients,” and U.S. Provisional Patent Application No. 63/189,027, filed May 14, 2021, and entitled, “Systems and Methods for Dispersing Active Ingredients,” each of which is incorporated herein by reference in its entirety for all purposes.

### TECHNICAL FIELD

Devices and methods for release of active ingredients from delivery materials using gaseous flows are generally described.

### BACKGROUND

Chemicals have been applied to produce for a number of reasons in the agriculture industry. It has been recognized, within the context of the present disclosure, that the development of devices, systems, and methods for deployment of agricultural chemicals, including volatile chemicals, at various scales with improved safety and effectiveness is desirable.

### SUMMARY

Devices, systems, and methods for releasing active ingredients, including volatile active ingredients, are described. The active ingredients may be released for agricultural applications prior to, during, and/or after harvest of produce. In some instances, the devices, systems, and/or methods promote relatively rapid release of active ingredients from a bed containing a porous and solid delivery material (e.g., a particulate material) via direction of gaseous fluid flow through the bed. For example, a pump (e.g., a fan) connected to a housing comprising the bed may propel gas (e.g., air) through the bed, thereby inducing, maintaining, and/or accelerating release of the active ingredient. In some embodiments, the devices, systems, and/or methods described herein facilitate fast, safe, and efficient fumigation of agricultural and/or horticultural products with active ingredients, before, during, and/or after their harvest. The subject matter of the present invention involves, in some cases, interrelated products, alternative solutions to a particular problem, and/or a plurality of different uses of one or more systems and/or articles.

In one aspect, devices are provided. In some embodiments, the device comprises a housing comprising a housing inlet; a housing outlet; and an internal volume containing a bed comprising a particulate delivery material and an active ingredient, the internal volume being between the housing inlet and the housing outlet. The device can further comprise a pump comprising a pump outlet, the pump outlet fluidically connected to the housing inlet, wherein the pump is configured to direct a flow of gaseous fluid into the housing inlet, through the internal volume, and out of the housing outlet.

In some embodiments, the device comprises a bed comprising a delivery material and an active ingredient; and a pump fluidically connected to the bed, wherein the pump is configured to direct a flow of gaseous fluid through the bed.

In some embodiments, the device comprises a housing comprising a housing inlet; a housing outlet; and an internal volume configured to receive a bed comprising a delivery material and an active ingredient, the internal volume being between the housing inlet and the housing outlet. The device can further comprise a pump comprising a pump outlet, the pump outlet fluidically connected to the housing inlet; and a filter between the internal volume and the housing outlet and/or operatively coupled to the housing outlet; wherein the pump is configured to direct a flow of gaseous fluid into the housing inlet, through the internal volume, and out of the housing outlet.

In some embodiments, the device comprises a housing comprising a housing inlet; a housing outlet; and an internal volume configured to receive a bed comprising at least 1 g of a delivery material and an active ingredient, the internal volume being between the housing inlet and the housing outlet. The device can further comprise a pump comprising a pump outlet, the pump outlet fluidically connected to the housing inlet; wherein the pump is configured to direct a flow of gaseous fluid into the housing inlet, through the internal volume, and out of the housing outlet.

In one aspect, articles for release of an active ingredient are provided. In some embodiments, the article comprises a container comprising a container inlet, a container outlet, and an internal volume; and a delivery material present in a quantity of at least 1 g within the internal volume of the container; wherein the active ingredient is associated with the delivery material.

In some embodiments, the article comprises a container comprising a container inlet, a container outlet, and an internal volume; a delivery material within the internal volume of the container; and a filter configured to prevent the transmission of the delivery material through at least a portion of the container; wherein the active ingredient is associated with the delivery material.

In yet another aspect, systems are provided. In some embodiments, the system comprises a device comprising a housing comprising a housing inlet, a housing outlet, and an internal volume of the housing comprising a bed comprising a particulate delivery material associated with an active ingredient, the internal volume of the housing being between the housing inlet and the housing outlet. The system can further comprise a pump comprising a pump outlet, the pump outlet fluidically connected to the housing inlet. The system can further comprise an enclosure comprising an internal volume. The internal volume of the enclosure can be fluidically connected to the housing inlet and the housing outlet; the pump can be configured to direct a flow of gaseous fluid into the housing inlet, through the internal volume of the housing, and out of the housing outlet; and the system can be configured to retain the active ingredient.

In still another aspect, methods are provided. In some embodiments, the method comprises directing a flow of gaseous fluid into a housing that comprises a housing inlet, a housing outlet, and an internal volume containing a bed comprising a particulate delivery material and an active ingredient, such that the gaseous fluid flows into the housing inlet, through the bed, and out of the housing outlet.

In some embodiments, the method comprises directing a flow of gaseous fluid into a housing that comprises a housing inlet, a housing outlet, a filter, and an internal volume containing a bed comprising a delivery material and an active ingredient, such that the gaseous fluid flows into the housing inlet, through the bed, through the filter, and out of the housing outlet.

In some embodiments, the method comprises directing a flow of gaseous fluid through a quantity of a porous and solid delivery material, thereby releasing an effluent stream comprising an active ingredient from the delivery material at a volumetric flow rate of greater than or equal to 100 L/s.

In some embodiments, the method comprises directing a flow of gaseous fluid through a quantity of a porous and solid delivery material that comprises at least 1 g, thereby releasing an effluent stream comprising an active ingredient from the delivery material.

In some embodiments, the method comprises directing a flow of gaseous fluid through a bed comprising a porous and solid delivery material and an active ingredient, thereby releasing an effluent stream comprising the active ingredient into a refrigerated enclosure.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a cross-sectional schematic illustration of a device comprising a pump fluidically connected to a bed comprising a delivery material, according to certain embodiments;

FIGS. 2A-2E show cross-sectional schematic illustrations of devices comprising a pump and a housing comprising or configured to receive a bed comprising a delivery material, according to certain embodiments;

FIGS. 3A-3C show cross-sectional schematic illustrations of systems comprising devices and enclosures, according to certain embodiments;

FIG. 4 shows a cross-sectional schematic illustration of an exemplary composition comprising a delivery material and an active ingredient associated with the delivery material, according to some embodiments;

FIGS. 5A-5C show cross-sectional schematic illustrations of filters operatively coupled to outlets, according to some embodiments;

FIGS. 6A-6C show cross-sectional schematic illustrations of systems comprising a device comprising a pump and a bed fluidically connected to the pump within an enclosure, according to some embodiments;

FIGS. 7A-7E show cross-sectional schematic illustrations of articles comprising containers, beds, and delivery materials, according to certain embodiments;

FIG. 8 shows a graph of the levels of 1-MCP in an enclosure reached after 15 hours of release, according to some embodiments;

FIG. 9 shows a plot of 1-MCP release profiles measured over a period of time for a dry forced-air release method and for a water-based release method, according to some embodiments;

FIG. 10 shows a plot of the rate of increase of 1-MCP concentration in mol/L/min for a dry forced-air release method and for a water-based release method, according to some embodiments;

FIG. 11 shows a plot of 1-MCP release profiles measured over time in room in which a box fan was turned on (“With Pump”) and for a room in which a box fan was not turned on (“Without Pump”), according to some embodiments;

FIG. 12 shows a plot of 1-MCP release rate as a function of air speed, according to some embodiments; and

FIG. 13 shows a plot of the percent mass loss of spearmint oil from a delivery material as a function of air speed, according to some embodiments.

### DETAILED DESCRIPTION

Devices, systems, and methods for releasing active ingredients, including volatile active ingredients, are described. The active ingredients may be released for agricultural applications prior to, during, and/or after harvest of produce. In some instances, the devices, systems, and/or methods promote relatively rapid release of active ingredients from a bed containing a porous and solid delivery material (e.g., a particulate material) via direction of gaseous fluid flow through the bed. For example, a pump (e.g., a fan) connected to a housing comprising the bed may propel gas (e.g., air) through the bed, thereby inducing, maintaining, and/or accelerating release of the active ingredient. In some embodiments, the devices, systems, and/or methods described herein facilitate fast, safe, and efficient fumigation of agricultural and/or horticultural products with active ingredients, before, during, and/or after their harvest.

Fumigation can be used to apply active ingredients for agricultural applications such as, for example, in the treatment of agricultural and/or horticultural products. In many cases, the use of fumigation can be safer and/or result in more uniform application than other techniques such as liquid-based application (e.g., via sprays). Fumigation can involve filling a particular area of interest (e.g., a crop storage room) with gaseous chemicals and can be used with a variety of chemicals such as volatile organic compounds (VOCs). However, VOCs can be dangerous, as they often present high exposure risks to workers. For this reason, and others, the controlled release of volatile chemicals can be important.

A variety of VOCs can be used for agricultural applications (e.g., for postharvest treatment) including essential oils (e.g., to reduce sprouting in root produce) and cyclopropenes (e.g., 1-methylcyclopropene to delay ripening in fruit such as apples). In both cases, postharvest produce can be stored in containers (e.g., large rooms) for extended periods of time under controlled atmospheres and temperatures.

Certain techniques for applying essential oils (e.g., thermal or electro fogging) and cyclopropenes (e.g., liquid contact-induced release) face limitations due to their need for complex equipment, their high cost, and their poor adaptability (e.g., to different active ingredients and/or to different needs in agricultural supply chains). It has been realized in the context of this disclosure that directed gaseous fluid flow-driven release of active ingredients from delivery materials (e.g., porous and solid materials) can address these limitations. In some instances, such directed gaseous fluid flow-driven release can provide a simple, adaptable, and scalable platform for rapid and sustained release of active ingredients.

One non-limiting example of a class of materials that can associate with various chemicals is carbon materials. One such example is activated carbon, which can have a highly porous structure. One use of activated carbon is for the trapping of VOCs from air, with reuse requiring regeneration. One technique for release of VOCs from activated carbon is pressure swing adsorption. In pressure swing adsorption, VOCs loaded onto activated carbon at ambient or elevated pressures are then subjected to reduced pressures (e.g., by vacuum) to induce release. However, it has been realized in the context of this disclosure that pressure swing release of chemicals from activated carbon is poorly suited for fumigation due to a need for vacuum-tight enclosures and expensive vacuum pumps requiring skilled operators. Pressure swing release is also not easily portable. Another technique for release of VOCs from activated carbon uses elevated temperatures. For example, VOCs may be loaded onto active carbon at or near ambient temperatures. At increased temperatures, the binding affinity between the VOC and the activated carbon decreases and the VOCs can be released. However, it has been realized in the context of this disclosure that temperature elevation can lead to degradation and/or combustion of the VOCs in some instances. As such, this method may be impractical for release of VOCs for agricultural fumigation. Another technique for removal of VOCs from activated carbon is via extraction with solvent. In this method, a solvent or solvents is passed over a bed of activated carbon, thereby dissolving the VOCs associated with the activated carbon. The solvent is then carried away. This method may use harsh or toxic solvents to extract the VOCs and traps them in liquid state. Due to exposure risks and additional steps required to release the VOCs from the extraction solvents, this method is poorly suited for fumigation for agricultural applications. It has been realized in the context of this disclosure that directed gaseous fluid flow-driven release from delivery materials such as those comprising carbon materials (as well as other types of materials) can reduce or avoid altogether the above-mentioned problems associated with these other techniques, including for agricultural fumigation applications.

In one aspect, a device is provided. According to certain embodiments, the device comprises a bed comprising a delivery material and an active ingredient. In some embodiments, the device comprises a pump. The pump may be fluidically connected to the bed. In some embodiments, the pump is in fluidic communication with the bed. In some embodiments, the pump is configured to direct a flow of gaseous fluid through the bed. The device comprises a housing, in some embodiments. The pump may be configured to direct a flow of gaseous fluid (e.g., a gas and/or supercritical fluid) into the housing. For example, according to certain embodiments, the flow of gaseous fluid is directed into the housing such that the gaseous fluid flows into a housing inlet. In some embodiments, the flow of gaseous fluid is directed from the inlet through the bed comprising the delivery material (e.g., a particulate delivery material) and an active ingredient. According to certain embodiments, the flow of gaseous fluid through the bed releases an effluent stream comprising the active ingredient from the delivery material. In some embodiments, the flow of gaseous fluid is directed from the bed and out of a housing outlet, releasing the flow of gaseous fluid from the housing. In some embodiments, the housing comprises a filter. In some embodiments, the flow of gaseous fluid directed from the bed is directed through the filter before and/or after traveling out of the housing outlet. Some such devices and methods may advantageously accelerate release of the active ingredient compared to techniques that do not employ such directed gaseous fluid flow (e.g., via a pump). The housing, the pump, the bed, the active ingredient, and the delivery material are described in greater detail below.

In some embodiments, the device comprises a housing. The housing may comprise housing inlet. The housing may comprise a housing outlet. In some embodiments, the housing comprises an internal volume. The internal volume may be, in certain embodiments, free of solid objects in the absence of the bed. According to certain embodiments, the internal volume is between the housing inlet and the housing outlet (e.g., the housing outlet and the housing inlet may be fluidically connected to each other through the internal volume, such that a flow of gaseous fluid can be directed from the inlet to the outlet by passing through the internal volume). The housing may comprise any of a variety of suitable solid materials. In some embodiments, the housing has sufficient strength and rigidity to support a bed comprising the delivery material and withstand the forces associated with the flow of the gaseous fluid from the pump. For example, the housing may be made of a metal and/or a metal alloy, a rigid polymeric material (e.g., a suitable plastic), and/or a composite material. In some embodiments, the housing is a single solid object (e.g., a unitary object), while in other embodiments the housing comprises multiple discrete solid objects that can be attached to each other (e.g., via couplings, adhesives, welding, and the like).

According to certain embodiments, the internal volume is configured to receive a bed comprising a delivery material. For example, the internal volume may be configured to receive a removable article (e.g., a cartridge) that comprises the bed, as described in greater detail below. The internal volume may be configured to receive a removable article (e.g., a cartridge) by having a suitable size and shape that allows the internal volume to receive the removable article in which the bed is contained. In the context of the present disclosure, an article is considered to be “removable” from another article if it is capable of being removed without damaging the removable article or the article from which the removable article is removed. The removable article can be coupled to the housing using any of a variety of techniques. For example, the removable article and/or the housing may be equipped with slot and tab connections, snap fits, interference fits, threaded connections, mechanically interlocking features, detents, latches, clamps, magnets, and/or friction fits capable of coupling the removable article to the housing (e.g., at the internal volume of the housing).

In some embodiments, the internal volume contains the bed comprising the delivery material. For example, in some embodiments, the internal volume contains a removable article as described below. As another example, in some embodiments, the internal volume is configured to retain the delivery material permanently (e.g., as a single-use device).

In some embodiments, the device is configured such that the delivery material is added or removed to the internal volume without using a cartridge or other type of removable article. For example, as described in greater detail below, the delivery materials described herein may be particulate. In some such embodiments, the particulate delivery material can be poured or otherwise directly added to the internal volume.

The internal volume may occupy a relatively large percentage of the overall volume of the housing. For example, in some embodiments, the internal volume occupies at least 5%, at least 10%, at least 25%, at least 50%, at least 75%, at least 90%, or more of the overall volume of the housing. In some embodiments, the internal volume of the housing only occupies a portion of the volume of the housing. For example, in some embodiments, the internal volume occupies less than or equal to 99%, less than or equal to 95%, less than or equal to 90%, less than or equal to 75%, less than or equal to 50%, less than or equal to 25%, or less than or equal to 10% of the volume of the housing. Combinations of these ranges are also possible (e.g., at least 5% and less than or equal to 95%). In some embodiments, the internal volume of the housing is the portion of the volume of the housing that contains or is configured to contain a bed and/or a removable article containing the bed.

According to certain embodiments, the internal volume of the housing is at least partially sealed from an external environment. In a configuration where the internal volume of the housing is at least partially sealed from an external environment, transmission of gaseous fluid through a sealed surface portion of the internal volume of the housing may be blocked such that a leak rate through that portion is less than or equal to 1.0×10⁻¹ atm-cc/sec, less than or equal to 1.0×10⁻³ atm-cc/sec; less than or equal to 1.0×10⁻⁵ atm-cc/sec; less than or equal to 1.0×10⁻⁷ atm-cc/sec; less than or equal to 1.0×10⁻¹⁰ atm-cc/sec, or as low as 0 atm-cc/sec with respect to at least one gas. In some embodiments where the internal volume of the housing is at least partially sealed from an external environment, transmission of gaseous fluid through a sealed surface portion of the internal volume of the housing is blocked such that a leak rate through that portion is less than or equal to 1.0×10⁻¹ atm-cc/sec, less than or equal to 1.0×10⁻³ atm-cc/sec; less than or equal to 1.0×10⁻⁵ atm-cc/sec; less than or equal to 1.0×10⁻⁷ atm-cc/sec; less than or equal to 1.0×10⁻¹⁰ atm-cc/sec, or as low as 0 atm-cc/sec with respect to air. As would be understood by one of ordinary skill in the art, a leak rate of 1 atm-cc/second means one cubic centimeter of the gas leaks per second when there is a 1 atm pressure drop between the interior volume and the exterior environment at ambient temperature, with the volume of the gas measured at ambient atmospheric pressure and temperature of 1 atm and 1° C., respectively.

For example, in some embodiments where the internal volume of the housing is at least partially sealed from an external environment, transmission of gaseous fluid through a sealed surface portion of the internal volume of the housing is blocked such that a leak rate through that portion is less than or equal to 1.0×10⁻¹ cc/sec, less than or equal to 1.0×10⁻³ cc/sec; less than or equal to 1.0×10⁻⁵ cc/sec; less than or equal to 1.0×10⁻⁷ cc/sec; less than or equal to 1.0×10⁻¹⁰ cc/sec, or as low as 0 cc/sec with respect to at least one gas when the pressure in the interior volume is 2 atm and the pressure of the external environment is 1 atm, both at 25° C. In some embodiments, where the internal volume of the housing is at least partially sealed from an external environment, transmission of gaseous fluid through a sealed surface portion of the internal volume of the housing is blocked such that a leak rate through that portion is less than or equal to 1.0×10⁻¹ cc/sec, less than or equal to 1.0×10⁻³ cc/sec; less than or equal to 1.0×10-5 cc/sec; less than or equal to 1.0×10⁻⁷ cc/sec; less than or equal to 1.0×10⁻¹⁰ cc/sec, or as low as 0 cc/sec with respect to air when the pressure in the interior volume is 2 atm and the pressure of the external environment is 1 atm, both at 25° C.

In some embodiments, the internal volume of the housing is at least partially sealed. For example, in some embodiments, the internal volume of the housing is sealed except at a housing outlet and/or a housing inlet. In some embodiments, the internal volume of the housing is at least partially sealed by a container (e.g., of a removable article as described in greater detail below). For example, in some embodiments, the internal volume of the housing is sealed except at a container outlet and/or a container inlet. In some embodiments, the sealed surface portion makes up greater than or equal to 5%, greater than or equal to 25%, greater than or equal to 50%, greater than or equal to 75%, greater than or equal to 95%, or more of a total surface of the internal volume of the housing. In some embodiments, the sealed surface portion makes up less than or equal to 99%, less than or equal to 95%, less than or equal to 75%, less than or equal to 50%, less than or equal to 25%, or less of a total surface of the internal volume of the housing. Combinations of these ranges are possible. For example, in some embodiments, a sealed surface portion makes up greater than or equal to 5% and less than or equal to 99% of a total surface of the internal volume of the housing. As would be understood by one or ordinary skill in the art, a percentage of a total surface of an internal volume in this context refers to a percentage of surface area defined by the boundaries of the internal volume.

In some embodiments, the housing comprises a filter. The filter can be used to retain delivery materials (e.g., particulate delivery materials) within the housing, as described in greater detail below. In some embodiments, the housing comprises the filter permanently, or as a removable insert. However, the housing does not require a filter in all embodiments. In some embodiments, a filter is included within a removable article as described in greater detail below, rather than as a housing component separate from the removable article.

One advantage of certain of the devices, articles, systems, and methods described herein is that they may be configured to retain large quantities of delivery materials and/or active ingredients, as described in greater detail below. This may be beneficial, for example, when using the delivery material to deliver large quantities of the active ingredient, and/or to bring the concentration of active ingredient within an enclosure to equilibrium.

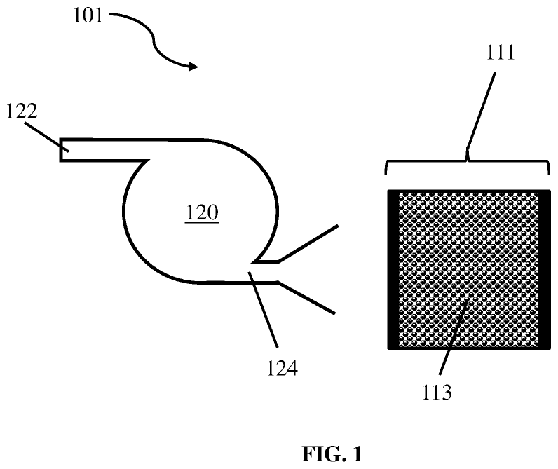

In some embodiments, the device comprises a pump fluidically connected to a bed comprising a delivery material and an active ingredient. FIG. 1 is a cross-sectional schematic illustration of device, 101, according to certain embodiments. Device 101 comprises bed 111, which comprises delivery material 113 and an active ingredient, in some embodiments. As also shown in FIG. 1, in some embodiments, device 101 comprises pump 120 fluidically connected to bed 111. As can be seen in FIG. 1, in some embodiments pump 120 is configured to direct a flow of gaseous fluid through bed 111, e.g., via pump outlet 124.

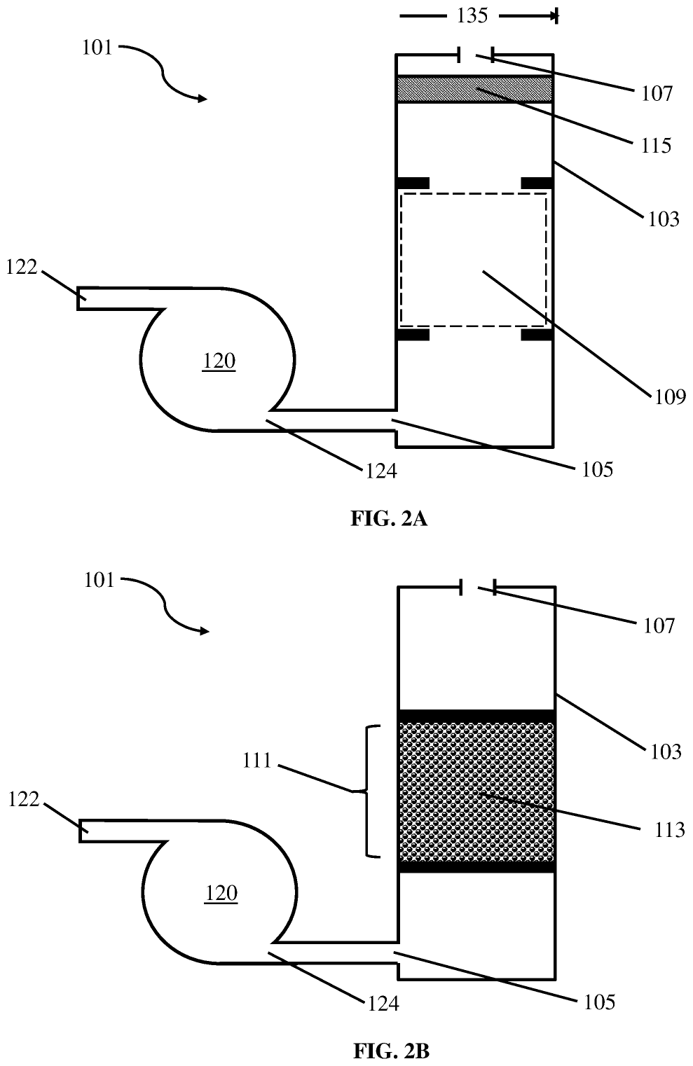

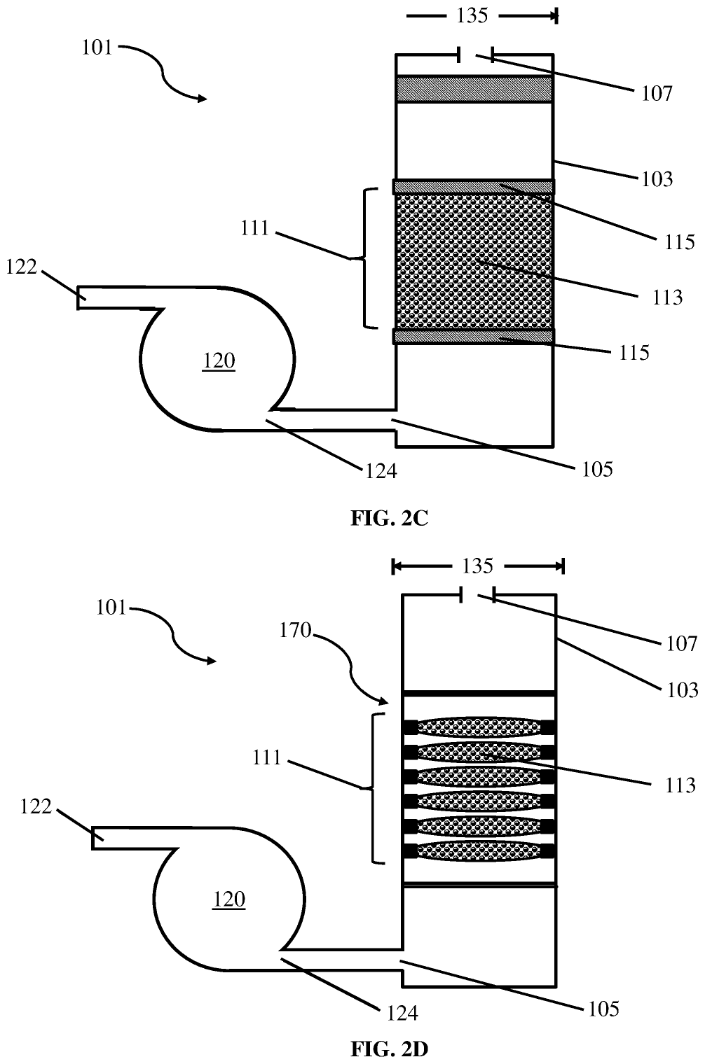

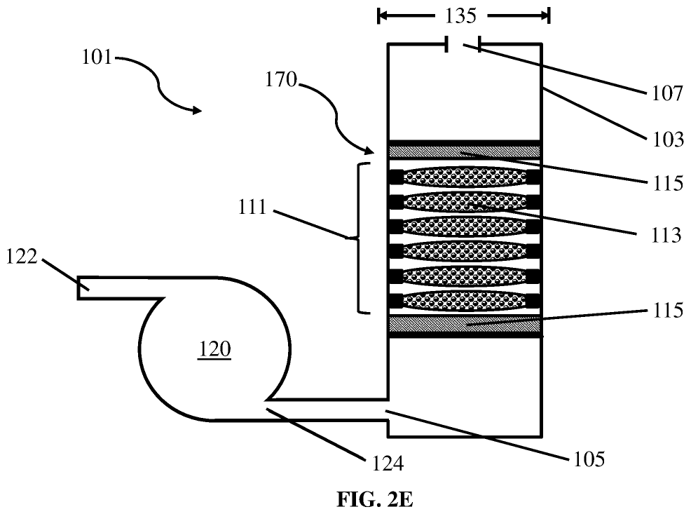

FIGS. 2A-2D are cross-sectional schematic diagrams of devices, according to certain embodiments. FIG. 2A shows exemplary device 101. Device 101 may comprise housing 103, which comprises housing inlet 105 and housing outlet 107. Device 101 further comprises pump 120, which comprises pump inlet 122 and pump outlet 124, according to certain embodiments. Although FIGS. 2A-2D show pump 120 in a configuration such that gaseous fluid travels from pump 120 to housing inlet 105, one of ordinary skill in the art would understand that other configurations are possible. For example, pump 120 could instead be configured to pull gaseous fluid into pump 120 from housing outlet 107, thereby directing ambient gaseous fluid into housing inlet 105 to replace air pulled out of housing outlet 107. As another example, the pump could be situated between housing inlet 105 and housing outlet 107, such that the pump directs gaseous fluid, in order, into housing inlet 105, through pump 120, and out of housing outlet 107. Thus, the relative position of the device and the enclosure are not limiting, and other configurations are possible.

The housing may have any appropriate dimensions. In some embodiments, the housing comprises a lateral dimension (e.g., a diameter). In the context of the present disclosure, the “lateral dimension” of the housing refers to the dimension of the housing that is perpendicular to the flow of fluid through the bed. The housing has a maximum lateral dimension, in some embodiments. For example, housing 103 has lateral dimension 135, which may be a maximum lateral dimension of the housing. In some embodiments, the housing has a maximum lateral dimension of greater than or equal to 0.05 m, greater than or equal to 0.1 m, greater than or equal to 0.2 m, greater than or equal to 0.3 m, greater than or equal to 0.4 m, greater than or equal to 0.5 m, or greater. In some embodiments, the housing has a maximum lateral dimension of less than or equal to 1 m, less than or equal to 0.8 m, less than or equal to 0.5 m, less than or equal to 0.4 m, less than or equal to 0.3 m, less than or equal to 0.2 m, or less. Combinations of these ranges are possible. For example, in some embodiments, housing has a maximum lateral dimension of greater than or equal to 0.05 m and less than or equal to 1 m.

Referring again to FIG. 2A, housing 103 comprises internal volume 109 (i.e., the volume within the dashed box in FIG. 2A) configured to receive a bed comprising a delivery material. In FIG. 2A, internal volume 109 does not contain the delivery material or the active ingredient. However, in FIGS. 2B-2D, the housing comprises bed 111 comprising delivery material 113. In FIG. 2A, housing 103 further comprises filter 115. In FIG. 2A, filter 115 is positioned such that it is between internal volume 109 and housing outlet 107. However, in some embodiments, a filter is present within internal volume 109 (e.g., as part of an article, such as a removable cartridge, comprising the bed). In some embodiments, a filter is between internal volume 109 and housing inlet 105. In some embodiments, a filter is external to housing inlet 105. According to some embodiments, a filter is external to housing outlet 107.

Turning now to FIG. 2B, in some embodiments, device 101 does not comprise a filter such as filter 115. For example, FIG. 2B presents device 101 that is similar to the device of FIG. 2A. As represented by FIG. 2B, in some embodiments internal volume 109 comprises bed 111 comprising delivery material 113. Delivery material 113 may be associated with an active ingredient, as described below. FIG. 2C presents device 101 wherein filters 115 are configured to retain uncontained bed 111 comprising delivery material 113 (e.g., loose particulate delivery material 113) within housing 103. One of filters 115 is disposed between the internal volume comprising bed 111 and housing outlet 107, in some embodiments. The other of filters 115 is disposed between the internal volume comprising bed 111 and housing inlet 105, as well as between the internal volume comprising bed 111 and pump 120, in some embodiments.

In some embodiments, the bed comprises a delivery material in the form of a loose particulate delivery material that is not contained by a removable structure such as a sachet. In FIGS. 2B-2C, bed 111 is depicted as comprising delivery material 113 in the form of a loose particulate delivery material that is not contained by a sachet. For example, in some embodiments, the particulate delivery material is constrained only by housing 103 (and filters 115 in FIG. 2C). In some embodiments, the particulate delivery material is bound by a first filter on a first side of the particulate material and a second filter on a second side of the particulate material (which may be opposite the first side). For example, in FIG. 2C, delivery material 113, which may be particulate, is bound by a first filter 115 on a first side of the delivery material and a second filter 115 on a second side of the delivery material that is opposite the first side of the delivery material. However, as described in greater detail elsewhere, other form factors for the bed are possible. For example, FIG. 2D presents an exemplary embodiment of device 101 similar to the embodiments of FIGS. 2A-2C, wherein article 170 is within an internal volume of housing 103, with bed 111 of article 170 further comprising delivery material 113 in the form of sachets comprising delivery material 113 (e.g., particulate delivery material within the sachets). FIG. 2E presents an exemplary embodiment of device 101 similar to the embodiments of FIGS. 2A-2C, wherein article 170 comprising filters 115 is within an internal volume of housing 103. Bed 111 of article 170 further comprises delivery material 113 in the form of sachets. Although multiple sachets are shown in FIGS. 2D-2E, in some embodiments the bed alternatively comprises the delivery material in the form of a single sachet, or in any combination of other form factors such as those described in greater detail.

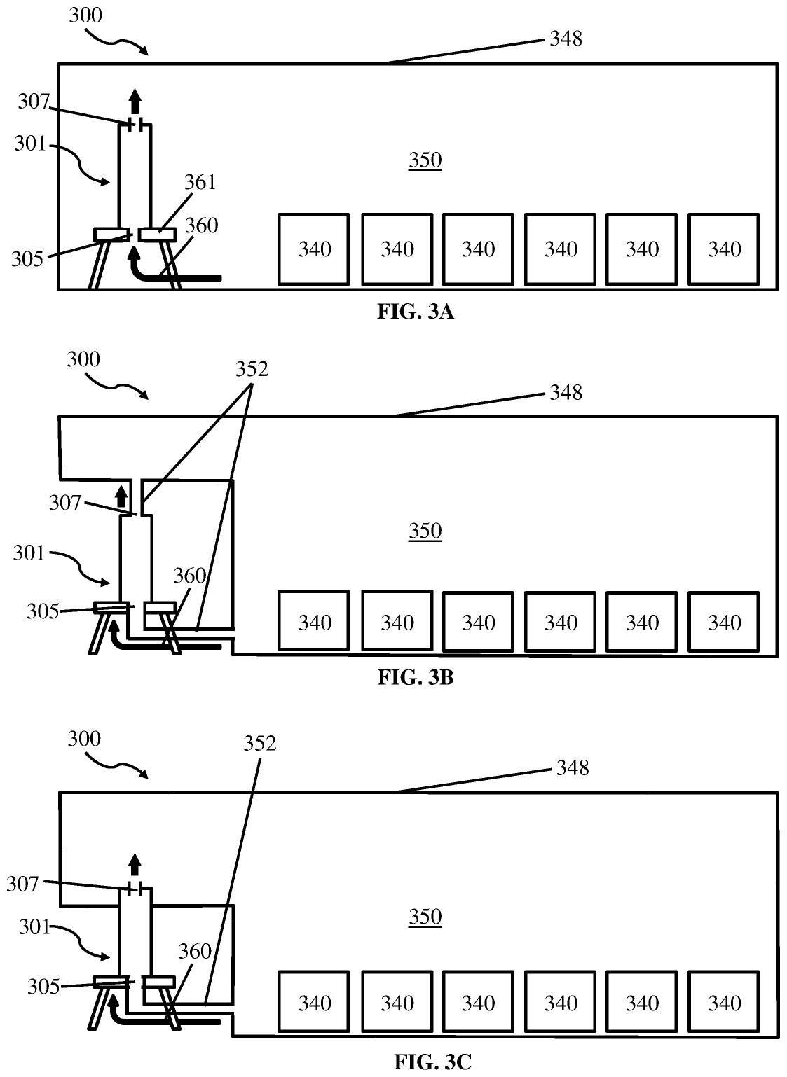

In the embodiments of FIGS. 2A-2D, the devices are illustrated as free-standing units. However, the devices may be configured to rest on a stand, to be suspended from a support, or to be otherwise supported in any suitable fashion, and the present disclosure is not limited to any particular method of support. For example, FIGS. 3A-3C, described in greater detail below, illustrate device 301 that is supported by a stand. The support technique (e.g., resting on a stand, suspended from a support) may be configured to allow for surrounding gaseous fluid (e.g., surrounding air) to enter the pump inlet and/or the housing inlet. For example, in FIG. 3A, stand 361 has an opening allowing air in internal volume 350 of enclosure 348 to enter housing inlet 305, in accordance with some embodiments.

Any of a variety of delivery materials may be employed in the devices, systems, and methods described, with the guidance of this disclosure. Examples of potentially suitable delivery materials include, but are not limited to carbon materials and/or silicate materials. In some embodiments, the delivery material comprises combinations of porous solids (e.g., soft rocks such as diatomaceous earth). In some embodiments, the delivery material comprises a gelatinous material. For example, the delivery material may be collagen-derived (e.g., gelatin). In some embodiments, the delivery material comprises a mixture of different types of materials (e.g., a mixture that includes both a carbon material and a silicate material, or a mixture that includes both diatomaceous earth and gelatin). In some embodiments, the delivery material is a solid material. In some embodiments, the delivery material is porous. In some embodiments, the delivery material is a solid and porous material.

Delivery materials are generally capable of associating and retaining a second substance under at least one set of conditions. It should be understood that while delivery materials may, in some instances, associate the second substance (e.g., on to internal or external surfaces of the delivery material) via adsorption, any of a variety of specific or non-specific interactions may contribute to association either alone or in combination, depending on the physical and chemical properties of the respective materials. A delivery material may associate other substances in an amount greater than or equal to 0.01 wt %, greater than or equal to 0.1 wt %, greater than or equal to 1 wt %, greater than or equal to 5 wt %, and/or up to 10 wt %, up to 25 wt %, up to 45 wt %, or up to 50 wt % versus the total weight of the delivery material and the associated substance.

As described in more detail below, a delivery material may comprise any of a variety of types of pores, such as macropores, mesopores, and/or micropores. The presence of pores may promote desirable release profiles for active ingredients (e.g., cyclopropenes, essential oils) by providing sufficient surface area for association of active ingredients, while in some instances tuning release rates (e.g., by affecting diffusion properties of associated active ingredient).

In some embodiments, the active ingredient (e.g., cyclopropene, essential oil) is associated with the delivery material (e.g., of a bed within the housing of the device or system). The active ingredient may be associated with the delivery material in any of a variety of manners, and methods, devices, and systems described herein are not limited to any particular mechanism of association. In some embodiments, active ingredient is adsorbed to an interior and/or exterior surface of the delivery material. Adsorption of the active ingredient to a surface may be primarily based on non-specific forces such as van der Waals forces. However, in some embodiments, an active ingredient may be specifically associated with the delivery material via any of a variety of interactions such as covalent bonds, electrostatic interactions, pi-pi stacking, or specific noncovalent affinity interactions (e.g., via a functional group and/or complexing agent immobilized on a surface of the delivery material). In some embodiments, the active ingredient is associated with the delivery material via adhesive forces. For example, a liquid active ingredient may associate with a delivery material via capillary forces when wetting a surface of the delivery material.

In some embodiments, the active ingredient is within a bulk of the delivery material. Being within a bulk of the delivery material (e.g., within an inner 80% of the macroscopic volume of the delivery material) as opposed to being solely associated with an outer macroscopic surface of the delivery material may contribute at least in part to relatively high loadings of the active ingredient as well as a tuning of release rates of the active ingredient. In some embodiments, the active ingredient is within at least some of the pores of the delivery material (e.g., adsorbed to a surface within pores of the delivery material, or otherwise being within pores of the delivery material).

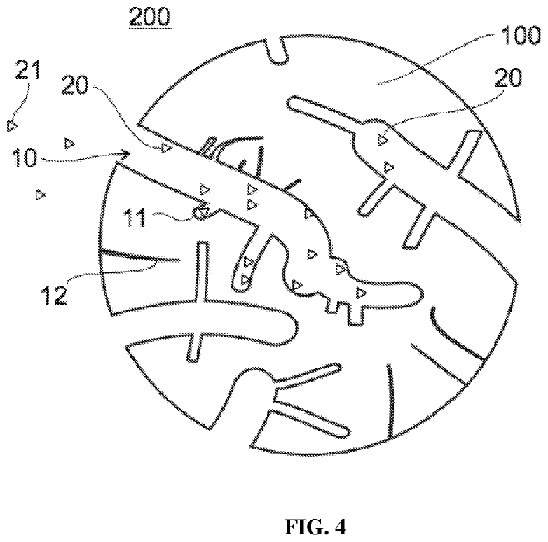

FIG. 4 shows a cross-sectional schematic illustration of a non-limiting illustrative embodiment of matrix 200 comprising active ingredient 20 and delivery material 100. In a non-limiting embodiment, a matrix consists essentially of delivery material 100 and active ingredient 20. In the schematic illustration in FIG. 4, matrix 200 contains at least one macropore 10, at least one mesopore 11, and at least one micropore 12. In a non-limiting embodiment, at least one of the macropore 10, mesopore 11, and micropore 12 contains active ingredient 20. Matrix 200 illustrates active ingredient 20 contained in macropores 10 and mesopores 11 of the matrix 200. Micropores 12 may also contain active ingredient 20. As FIG. 4 is a non-limiting example and is not drawn to scale, it should be noted that other storage concentrations of active ingredient 20 in matrix 200 can be achieved by the embodiments contemplated herein. Moreover, different positions of active ingredient 20 within the pores 10, 11, 12 of matrix 200 are also contemplated. In a non-limiting embodiment, active ingredient 20 is a cyclopropene (e.g., 1-MCP). In another non-limiting embodiment, active ingredient 20 is a molecule of an essential oil.

FIG. 4 also illustrates active ingredient 21. Active ingredient 21 is the same active ingredient as active ingredient 20; however, active ingredient 21 has been released from the delivery material 100. Release of active ingredient 21 from delivery material 100 may be induced or at least accelerated by directing a flow of a gaseous fluid (e.g., a gas such as air) past the delivery material, using, for example, the devices described in this disclosure (e.g., comprising a pump and a housing comprising the delivery material and the active ingredient). The delivery materials of this disclosure may be configured for release of active ingredient. In a non-limiting embodiment the active ingredient is in the gas phase.

In some embodiments, the active ingredient is released from the delivery material without external wetting. In certain embodiments, the active ingredient is released from the delivery material without external hydrating. In certain embodiments, the active ingredient is released from a surface of the delivery material and directly into the gaseous stream.

In some embodiments, the delivery material is insoluble in water at a temperature of 20° C. In this context, a substance is considered to be insoluble in a solvent if the solubility of that substance is less than 0.1 g per 100 mL of the solvent. In some embodiments, the delivery material has a solubility in water of less than or equal to 0.1 g, less than or equal to 0.01 g, less than or equal to 0.001 g, less than or equal to 0.0001 g, less than or equal to 0.00001 g, and/or as low as 0.000001 g or less per 100 mL of water at 20° C.

In some embodiments, the delivery material comprises one or more of macropores, mesopores, and micropores. In a non-limiting embodiment, macropores are pores having a diameter greater than 50 nm. For example, macropores may have diameters of between 50 and 1000 nm. In a non-limiting embodiment, mesopores are pores having a diameter between 2 nm and 50 nm. In a non-limiting embodiment, micropores are pores having a diameter of less than 2 nm. For example, micropores may have diameters of between 0.2 and 2 nm. Pore diameters may be determined using, for example, the method of Barrett, Joyner, and Halenda in ASTM Standard Test Method D4641-17.

In some embodiments, at least 10%, at least 25%, at least 50%, at least 75%, at least 90%, at least 95%, at least 98%, at least 99%, or more of the total pore volume of the delivery material is occupied by pores having a pore diameter of at least 0.1 nm, at least 0.2 nm, at least 0.5 nm, at least 1 nm, at least 2 nm, at least 5 nm, at least 10 nm, at least 20 nm, at least 50 nm, or greater. In some embodiments, at least 10%, at least 25%, at least 50%, at least 75%, at least 90%, at least 95%, at least 98%, at least 99%, or more of the total pore volume of the delivery material is occupied by pores having a pore diameter less than or equal to 1000 nm, less than or equal to 500 nm, less than or equal to 200 nm, less than or equal to 100 nm, less than or equal to 50 nm, less than or equal to 20 nm, less than or equal to 10 nm, less than or equal to 5 nm, less than or equal to 2 nm, or less. Combinations of these ranges are also possible.

In some embodiments, the delivery material is a solid material having a high surface area, as described in more detail below. Without wishing to be limited by any particular theory or mechanism, porous, high surface area materials may be beneficial in some applications due to their adsorption capacity and sufficient affinity arising from that adsorption capacity to exhibit volatile retention (e.g., of cyclopropenes and/or essential oils) greater than the evaporation retention of a neat liquid. In a non-limiting embodiment, a high-surface area material is a material with a total chemical surface area, internal and external, of at least 100 m²/g. In some embodiments, a high-surface area material is a material with a total chemical surface area, internal and external, greater than or equal to 400 m²/g. In some embodiments, a high-surface area material is a material with a total chemical surface area, internal and external, of at least 500 m²/g. In some embodiments, a high-surface area material is a material with a total chemical surface area, internal and external, greater than or equal to 1000 m²/g. In some embodiments, a high-surface area material is a material with a total chemical surface area, internal and external, greater than or equal to 2000 m²/g. The terms “total chemical surface area, internal and external”, “chemical surface area” and “surface area” are used interchangeably herein.

In some embodiments, the delivery material has a surface area of greater than or equal to 0.01 m²/g, greater than or equal to 0.1 m²/g, greater than or equal to 1 m²/g, greater than or equal to 10 m²/g, greater than or equal to 100 m²/g, greater than or equal to 200 m²/g, greater than or equal to 300 m²/g, greater than or equal to 400 m²/g, greater than or equal to 500 m²/g, greater than or equal to 600 m²/g, greater than or equal to 800 m²/g, greater than or equal to 900 m²/g, greater than or equal to 1000 m²/g, or greater. In some embodiments, the delivery material has a surface area of less than or equal to 1500 m²/g, less than or equal to 1300 m²/g, less than or equal to 1200 m²/g, less than or equal to 1150 m²/g, less than or equal to 1100 m²/g, or less. Combinations of these ranges (e.g., greater than or equal to 0.01 m²/g and less than or equal to 1500 m²/g, greater than or equal to 1 m²/g and less than or equal to 1500 m²/g, or greater than or equal to 100 m²/g and less than or equal to 1500 m²/g) are also possible. In an embodiment, a delivery material has a surface area in the range of 100 to 1500 m²/g. In an embodiment, a delivery material has a surface area in the range of 300 to 1500 m²/g. In an embodiment, a delivery material has a surface area in the range of 500 to 1500 m²/g. In an embodiment, a delivery material has a surface area in the range of 600 to 1500 m²/g. In an embodiment, a delivery material has a surface area in the range of 650 to 1500 m²/g. In an embodiment, a delivery material has a surface area in the range of 650 to 1300 m²/g. In an embodiment, a delivery material has a surface area in the range of 650 to 1200 m²/g. In an embodiment, a delivery material has a surface area in the range of 800 to 1200 m²/g. In an embodiment, a delivery material has a surface area in the range of 850 to 1200 m²/g. In an embodiment, a delivery material has a surface area in the range of 900 to 1200 m²/g. In an embodiment, a delivery material has a surface area in the range of 900 to 1150 m²/g. In an embodiment, a delivery material has a surface area in the range of 900 to 1500 m²/g. Those of ordinary skill in the will be aware of methods for determining the total chemical surface area, internal and external, for example, using Brunauer-Emmett-Teller (BET) analysis of nitrogen or noble gas desorption when a material (e.g., a porous material) is exposed to vacuum at a given temperature, for instance as by the ISO 9277 standard.

In some embodiments, the delivery material is a porous material. In a non-limiting embodiment, a porous delivery material is a material with an internal void volume greater than or equal to 0.1 cm³/g, greater than or equal to 0.5 cm³/g, greater than or equal to 1 cm³/g, and/or up to 1.5 cm³/g, or greater.

In some embodiments, the delivery material has a saturation limit for a given active ingredient. For example, if an active ingredient is present in an amount greater than the saturation limit of a given quantity of delivery material, the delivery material may be fully saturated (e.g., may reach a condition such that no additional active ingredient can interact with a surface of the delivery material). According to certain embodiments, the amount of active ingredient in the delivery material is at least above a certain percentage of the saturation limit for that active ingredient. For example, in some embodiments, the amount of active ingredient associated with the delivery material is at least 50%, at least 75%, at least 90%, at least 95%, at least 100%, at least 110%, at least 125%, at least 150%, or more of the saturation limit for that active ingredient.

In some embodiments, the delivery material (e.g., of the bed in the housing) comprises a carbon material. A carbon material may be of various geometries and formations including, but not limited to, macroporous, mesoporous, and microporous carbon materials, monolithic carbon materials, extruded or pelletized carbon materials, steam-activated carbon materials, oxidized carbon materials, or acid- or base-treated carbon materials. In some embodiments, the following carbon materials may be used as part of (or all of) the delivery materials for beds described in this disclosure: carbon black (e.g., such as generally indicated by CAS No.: 1333-86-4) or lampblack carbon; and/or activated carbon (also referred to as activated charcoal) (e.g., such as generally indicated by CAS No.: 7440-44-0). In some embodiments, the delivery material comprises activated carbon. In some embodiments, the carbon materials comprise carbon in powder, granule, film, or extrudate form. In some embodiments, the delivery material comprises carbon mixed with one or more adjuvants or diluents. In some embodiments, the delivery material comprises a carbon material comprising carbon derived from coconut, coal, wood, anthracite, or sand (Carbon Activated Corporation) and the like; reactivated carbon; ash, soot, char, charcoal, coal, or coke; vitreous carbon; glassy carbon; and/or bone charcoal. Each of those carbons, whether commercially acquired or manufactured by hand as known in the art can be further modified to form other delivery materials for the delivery material. Such modifications may be performed via operations including, but not limited to heat treating materials, oxidation, and/or acid- or base-treatment to arrive at other delivery materials and matrices described herein. Therefore, any carbons derived from, for example: carbon black or lampblack carbon, activated carbon or activated charcoal, carbon in powder, granule, film, or extrudate form, reactivated carbon, ash, soot, char, charcoal, coal, or coke, vitreous carbon, glassy carbon, or bone charcoal through the modification of the parent carbon with, for example, adsorption-modifying functionalities, one or more acids, bases, oxidants, hydrolyzing reagents, or a combination thereof may be used to form the delivery materials described in this disclosure (e.g., for beds within housings for directed gaseous fluid flow-driven release of active ingredients). Non-limiting examples of carbon materials are described in U.S. Patent Application Publication No. US-2019-0037839 published on Feb. 8, 2019 and entitled “Compositions for Controlled Release of Active Ingredients and Methods of Making Same,” which is incorporated herein by reference in its entirety for all purposes.

In some embodiments where the delivery material comprises a carbon material, the delivery material comprises the carbon material in an amount of greater than or equal to 75 wt %, greater than or equal to 80 wt %, greater than or equal to 90 wt %, greater than or equal to 93 wt %, greater than or equal to 94 wt %, greater than or equal to 95 wt %, and/or up to 99 wt %, or up to 100 wt % versus the total weight of the delivery material.

In some embodiments where the delivery material comprises a carbon material, the carbon material comprises carbon in an amount of greater than or equal to 75 wt %, greater than or equal to 80 wt %, greater than or equal to 90 wt %, greater than or equal to 93 wt %, greater than or equal to 94 wt %, greater than or equal to 95 wt %, and/or up to 99 wt %, or up to 100 wt % versus the total weight of the carbon material.

In some embodiments where the delivery material comprises a carbon material, a relatively high percentage of the carbon material is elemental carbon (carbon having an oxidation state of 0). In some embodiments, the carbon material comprises elemental carbon in an amount of greater than or equal to 50 atomic percent (at %), greater than or equal to 75 at %, greater than or equal to 90 at %, greater than or equal to 95 at %, greater than or equal to 98 at %, and/or up to 99 at %, or up to 100 at %.

In some embodiments, the delivery material has a relatively high iodine number. In some embodiments, the delivery material (e.g., a carbon material, a silicate material) has an iodine number of greater than or equal to 0 mg/g, greater than or equal to 100 mg/g, greater than or equal to 200 mg/g, greater than or equal to 500 mg/g, greater than or equal to 800 mg/g, greater than or equal to 1000 mg/g, and/or up to 1200 mg/g, up to 1500 mg/g, up to 2000 mg/g, or higher. Combinations of these ranges (e.g., greater than or equal to 0 mg/g and less than or equal to 2000 mg/g, greater than or equal 500 mg/g and less than or equal to 2000 mg/g, or greater than or equal to 800 mg/g and less than or equal to 1200 mg/g) are possible.

In some embodiments, the delivery material comprises a silicate material (also referred to in this disclosure as a silica-based material). Silica-based materials generally include silicon atoms and oxygen atoms at least some of which are bound to silicon atoms. The silicon atoms and the oxygen atoms may be present in the silica-based material, for example, in the form of oxidized silicon. Silica-based materials include materials that are or comprise silicon dioxide, other forms of silicates, and combinations thereof. Silica-based materials may include, in addition to the silicon and oxygen atoms, other materials such as metal oxides (e.g., aluminum oxide (Al₂O₃)). Silica-based materials may include organosilicate hybrids. In some embodiments, the amount of silicon atoms, by weight, in the silica-based material is at least 1 wt %, at least 3 wt %, at least 5 wt %, at least 10 wt %, or at least 20 wt %. In some embodiments, the amount of oxygen atoms, by weight, in the silica-based material is at least 1 wt %, at least 3 wt %, at least 5 wt %, at least 10 wt %, or at least 20 wt %. In certain embodiments, the total amount of the silicon atoms and the oxygen atoms within the silica-based material is at least 1 wt %, at least 3 wt %, at least 5 wt %, at least 10 wt %, at least 20 wt %, at least 25 wt %, at least 30 wt %, at least 40 wt %, at least 50 wt %, at least 60 wt %, at least 70 wt %, at least 80 wt %, at least 90 wt %, at least 95 wt %, or at least 99 wt %.

In a non-limiting embodiment, the delivery material (e.g., the silica-based material) is or comprises a silicate. Silicates may include neosilicates, sorosilicates, cyclosilicates, inosilicates, phyllosilicates, and tectosilicates. In some embodiments, the delivery material comprises silicate in an amount of at least 1 wt %, at least 3 wt %, at least 5 wt %, at least 10 wt %, at least 20 wt %, at least 25 wt %, at least 30 wt %, at least 40 wt %, at least 50 wt %, at least 60 wt %, at least 70 wt %, at least 80 wt %, at least 90 wt %, at least 95 wt %, and/or up to 99 wt % or 100 wt %.

In some embodiments, the delivery material comprises silicon dioxide in an amount of at least 1 wt %, at least 3 wt %, at least 5 wt %, at least 10 wt %, at least 20 wt %, at least 25 wt %, at least 30 wt %, at least 40 wt %, at least 50 wt %, at least 60 wt %, at least 70 wt %, at least 80 wt %, at least 90 wt %, at least 95 wt %, and/or up to 99 wt % or up to 100 wt %.

A silica-based material may be of various geometries and formations including, but not limited to, macroporous, mesoporous, and microporous silica-based materials, amorphous silica, fumed silica, particulate silica of all sizes, ground quartz, particulate, fumed, crystalline, precipitated, and ground silicon dioxide and associated derivatives, and combinations thereof. In some embodiments, a silica based material comprises silica gel, or precipitated, crystalline-free silica gel (such as generally indicated by CAS No.: 112926-00-8), or amorphous, fumed (crystalline free) silica (such as generally indicated by CAS No.: 112945-52-5), or mesostructured amorphous silica (such as generally indicated by CAS No.: 7631-86-9). In some embodiments, silica-based material further comprises one or more of a metal oxide, metalloid oxide, and combinations thereof. For example, in some embodiments, the silica-based delivery material further comprises one or more of zinc oxide, titanium oxide, group 13 or 14 oxide, and combinations thereof. In some embodiments, silica-based delivery material further comprises aluminum oxide or a portion of aluminum oxide.

In some embodiments, a delivery material comprising a silica-based material comprises silica. Silicate materials are available from commercial sources in a wide array of states with respect to surface areas, porosities, degrees of surface functionalization, acidity, basicity, metal contents, and other chemical and physicochemical features. Commercial silicates may be in the form of powder, granules, nanoscale particles, and porous particles. In some embodiments, the delivery material comprises silica gel. In some embodiments, the silica-based delivery material comprises one or more of macroporous, mesoporous, and microporous silica. In some embodiments the delivery material comprises precipitated, crystalline-free silica gel (such as generally indicated by CAS No.: 112926-00-8). In some embodiments, the delivery material comprises amorphous, fumed (crystalline free) silica (such as generally indicated by CAS No. 112945-52-5). In some embodiments, the delivery material comprises mesostructured amorphous silica (such as generally indicated by CAS No. 7631-86-9).

In some embodiments, the delivery material is a particulate delivery material. That is, the delivery material may be in the form of particles. It has been realized in the context of this disclosure that a particulate delivery material may afford a relatively high porosity, surface area, and/or active ingredient loading, and in some instances may provide easier handling and adaptability to various device geometries compared to non-particulate delivery materials such as bulk solid delivery materials or large-scale composites. It has also been realized in the context of this disclosure that a particulate delivery material may allow the particles, in some instances, to form a fluidized bed upon exposure to the gaseous fluid flow (e.g., to behave as a fluid comprising solid particles), which can be advantageous for the release of active ingredients. In some embodiments, at least some of the particles of the delivery material are loose particles. In this context, loose particles are particles that are not immobilized with respect to each other (e.g., via an adhesive or a binder material). It should be understood that a collection of loose particles may be constrained by exterior forces (e.g., from a container), but are still considered to be loose even in such a packed state because in the absence of the exterior forces the particles would be able to move freely with respect to each other.

In some embodiments, the particles of the particulate delivery material are relatively small. For example, in some embodiments, at least 10%, at least 25%, at least 50%, at least 75%, at least 90%, at least 95%, at least 99% or more of the total volume of the particulate delivery material is made up of particles having a largest cross-sectional dimension of less than or equal to 1000 micrometers, less than or equal to 100 micrometers, less than or equal to 10 micrometers, less than or equal to 1 micrometer, and/or as low as 500 nm, as low as 200 nm, or less. Combinations of these ranges are also possible (e.g., greater than or equal to 200 nm and less than or equal to 1000 micrometers). It should be understood that the largest cross-sectional dimension of a particle is an absolute property of the particle and can be determined my measuring each individual particle using any of a variety of techniques.

In some embodiments, the average of the largest cross-sectional dimensions of the particles of the particulate delivery material is less than or equal to 1000 micrometers, less than or equal to 100 micrometers, less than or equal to 10 micrometers, less than or equal to 1 micrometer, and/or as low as 500 nm, as low as 200 nm, or less. Combinations of these ranges (e.g., greater than or equal to 200 nm and less than or equal to 1000 micrometers) are also possible. In this context, the “average of the largest cross-sectional dimensions of the particles of the particulate delivery material” is calculated by determining the largest cross-sectional dimension of each particle and calculating the number average.

In some embodiments, when the particles of the particulate delivery material are subject to dynamic light scattering (DLS), the average hydrodynamic radius of the particles is less than or equal to 1000 micrometers, less than or equal to 100 micrometers, less than or equal to 10 micrometers, less than or equal to 1 micrometer, and/or as low as 500 nm, as low as 200 nm, or less. Combinations of these ranges (e.g., greater than or equal to 200 nm and less than or equal to 1000 micrometers) are also possible. In this context, the average hydrodynamic radius is the mean value determined from the size distribution calculated from the DLS experiment.

In some embodiments, a device comprises and/or is configured to receive a bed comprising a delivery material. For example, the bed may be a bed of particles of a particulate delivery material. In some embodiments, the bed has a form factor. The form factor may comprise a standalone delivery material. For example, the standalone delivery material may be in the form of a gel, a powder, a pellet, a film, a sheet or flake. In some embodiments, the bed form factor comprises one or more additional components configured to contain the delivery material, such as a sachet, an insert, a capsule, a pod, a compartment, or another type of container. According to certain embodiments, the form factor comprises a particulate delivery material dispersed within another material (e.g., in the form of a composite material), wherein the other material may be, for example, a woven material, a knitted material, a paint, a coating, a paper, a cardboard, a paper derivative, a fabric, a fiber, a film, a cloth, a wood, or a plastic. In some embodiments, the form factor comprises a packet, pouch, sachet, and/or pad. In some embodiments, the form factor comprises a porous material. In some embodiments, the form factor comprises a food safe material. In some embodiments, the form factor (e.g., sachet) is gas permeable.

In some embodiment, the form factor (e.g., comprising a sachet) comprises PE (polyethylene) [whether HDPE (high density polyethylene) or LDPE (low density polyethylene)], PLA (polylactic acid), starch, PP (polypropylene), nylon, PET (polyethylene terephthalate), non-woven fabric or paper, paper (e.g., medical paper), burlap (e.g., as from jute, hemp or another fiber), cellulose-based material, polyester, or any combination thereof. In some embodiments, the form factor is a sachet comprising polyethylene (e.g., TYVEK™). In some embodiments, the sachet is perforated. In some embodiments, the Gurley Hill porosity measurement of a form factor material (e.g., sachet material) is 20-50 sec/100 cm²-in, 30-40 sec/100 cm²-in, 45-60 sec/100 cm²-in, 60-150 sec/100 cm²-in, 100-400 sec/100 cm²-in, or 300-400 sec/100 cm²_in In some embodiments, the bed comprises a quantity of the delivery material. The quantity of the delivery material may be relatively large. This may advantageously allow the delivery material to release a large quantity of an active ingredient (e.g., within an enclosure). In some embodiments, the quantity of the delivery material is greater than or equal to 1 g, greater than or equal to 5 g, greater than or equal to 10 g, greater than or equal to 20 g, greater than or equal to 50 g, greater than or equal to 100 g, greater than or equal to 200 g, greater than or equal to 300 g, greater than or equal to 400 g, greater than or equal to 500 g, greater than or equal to 1 kg, greater than or equal to 1.5 kg, greater than or equal to 2 kg, greater than or equal to 3 kg, greater than or equal to 5 kg, or greater. In some embodiments, the quantity of the delivery material in the bed of the device is less than or equal to 20 kg, less than or equal to 10 kg, less than or equal to 5 kg, less than or equal to 3 kg, less than or equal to 2 kg, less than or equal to 1.5 kg, less than or equal to 1 kg, or less. Combinations of these ranges are possible. For example, in some embodiments, quantity of the delivery material is greater than or equal to 1 g and less than or equal to 20 kg, or greater than or equal to 5 g and less than or equal to 10 kg, or greater than or equal to 500 kg and less than or equal to 10 kg.

In some embodiments, the bed is within a container (e.g., of a removable article) and/or has a form factor that comprises one or more additional components configured to contain the delivery material. However, in some embodiments, the bed is neither within a container nor has a form factor that comprises one or more additional components configured to contain the delivery material. For example, in some embodiments a bed comprises a standalone delivery material (e.g., a powder) as discussed above. In certain embodiments, the housing is configured to receive an uncontained bed comprising a standalone delivery material. For example, the housing may be configured to retain an uncontained powder. In some embodiments, the housing is configured to retain an uncontained bed comprising a standalone delivery material using filters. For example, filters may be disposed between the internal volume of the housing and the housing inlet, and/or between the internal volume of the housing and the housing outlet. In some embodiments, the filters are configured (e.g., arranged within the housing and having sufficient mechanical properties) to retain the bed. For example, as described above, in some embodiments, a first filter can be located on one side of the bed and a second filter can be located on a second side of the bed (e.g., that may be opposite the first side of the bed).

As discussed above, in some embodiments, devices, articles, and/or systems described herein comprise a filter. The filter may be configured to permit the transmission of the flow of gaseous fluid (e.g., gas, supercritical fluid). The presence of the filter may block transmission of a delivery material. For example, if the delivery material is a particulate material, the filter may be configured to block transmission of the particulate material out of the bed (e.g., via entrainment of the particulate material within the flow of the gaseous fluid as it flows through the bed). This may advantageously result in increased retention of the delivery material within the internal volume of the housing, while allowing the transmission of the flow of gaseous fluid and/or the active ingredient through the filter.

The filter may have any of a variety of dispositions with respect to the bed. In some embodiments, the filter is between the bed and the outlet. FIG. 2C shows one such embodiment, where one of filters 115 is between bed 111 and outlet 107 of housing 103. This may advantageously prevent transmission of the delivery material through the outlet of the housing (e.g., transmission of the delivery material as a result of air pressure), which can lead to the loss of delivery material from the system. According to certain embodiments, the filter is configured to retain the bed. In some embodiments, the filter is positioned between the bed and the inlet. FIG. 2C shows one such embodiment, where one of filters 115 is between bed 111 and inlet 105 of housing 103. This may advantageously prevent transmission of the delivery material out of the housing via the housing inlet (e.g., transmission of the delivery material as a result of a gravitational force), which can also lead to the loss of delivery material from the system. In some embodiments, the filter is positioned between the bed and the pump. This may advantageously prevent damage to the pump due to exposure of the pump to the delivery material. In some embodiments, the filter is present in the device. In some embodiments, the filter is present in a removable article that is loaded into the housing (e.g., a removable article configured to be received by an internal volume of the housing of the device).

In some embodiments, the filter is operatively coupled to a housing inlet and/or a housing outlet. A filter operatively coupled to a housing inlet and/or a housing outlet may be disposed over the housing inlet or the housing outlet, such that gaseous fluid transmitted through the housing inlet and/or housing outlet passes through the filter. For example, a filter operatively coupled to a housing inlet and/or a housing outlet may be external to and disposed over an opening to the housing inlet and/or the housing outlet. In some embodiments, a filter operatively coupled to a housing inlet and/or a housing outlet is within the housing inlet and/or the housing outlet. In some embodiments, the device comprises a filter operatively coupled to the housing inlet and a filter operatively coupled to the housing outlet.

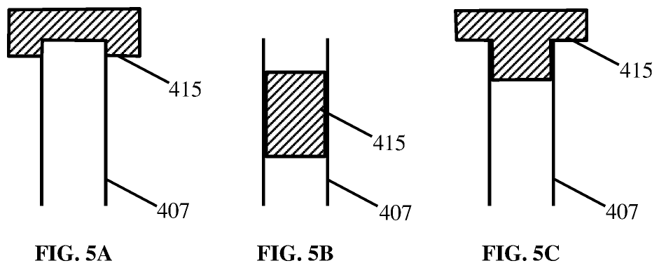

FIGS. 5A-5C show cross-sectional schematic illustrations of filters 415 operatively coupled to housing outlets 407, according to certain embodiments. In FIG. 5A, filter 415 is disposed over housing outlet 407, such that gaseous fluid transmitted through housing outlet 407 passes through filter 415, in some embodiments. In FIG. 5B, filter 415 is within housing outlet 407, according to some embodiments. Meanwhile, FIG. 5C shows that filter 415 may be both within and disposed over housing 407, in some embodiments. Of course, it should be understood that while FIGS. 5A-5C present operative couplings between filters and outlets, filters may also be operatively coupled to housing inlets, and that other types of operative couplings between filters and housing inlets and/or housing outlets are possible.

The filter may have any appropriate design. For example, the filter may comprise a particulate filter (e.g., a HEPA filter, an electrostatic filter, a media filter, a sieve, a spun glass filter, and/or a pleated filter). In some embodiments, the filter is an air filter. In some embodiments, the filter comprises a supporting layer. The supporting layer may be configured to provide mechanical support for the filter. For example, the filter may comprise a supporting layer comprising a wire mesh, a solid layer comprising holes, or any other layer suitable for providing mechanical support. Of course, the device may comprise any suitable materials, and the disclosure is not thus limited.

In some embodiments, a relatively low percentage of the surface area of the filter accessible to the active ingredient comprises a catalytic species. In this context, a catalytic species is understood to be any chemical species (e.g., ions, molecules, metal active sites) that catalyzes a reaction that causes a chemical transformation of an active ingredient (e.g., a cyclopropene, an essential oil). It has been realized in the context of this disclosure that employing filters (and, in some instances, other components of the device and system such as housing materials, container materials, etc.) having little to no catalytic species with respect to the active ingredients can reduce or prevent deleterious consumption (e.g., via degradation) of the active ingredients, thereby maintaining and/or accelerating a rate of release of the active ingredient from the device and/or rate of build-up of the active ingredient within the enclosure compared to instances in which such catalytic species are present. Examples of catalytic species include, but are not limited to, metals, metal alloys, and/or metal ions. For example, catalytic species may include copper metal, a copper alloy, and/or a copper ion (e.g., copper (II), copper(III)). As another example, catalytic species may include silver metal, a silver alloy, and/or a silver ion. In some embodiments, less than or equal to 1%, less than or equal to 0.1%, less than or equal to 0.01%, less than or equal to 0.001%, or as low as 0.0001%, or less, or even 0% of the surface area of the filter accessible to the active ingredient comprises a catalytic species (e.g., copper metal, a copper alloy, a copper ion, silver metal, a silver alloy, a silver ion).

In some embodiments, the device comprises a pump. Generally, in the context of the present disclosure, a “pump” is any apparatus capable of producing a pressure drop of gaseous fluid. In some embodiments, the pump is a mechanical pump configured to move a fluid (e.g., a gaseous fluid, such as a gas or a supercritical fluid) by mechanical action upon actuation. In some embodiments, the pump is a source of compressed fluid. For example, the pump may be a source of compressed gaseous fluid such as compressed air or a compressed inert gas such as compressed argon. One example of a source of compressed gaseous fluid is a compressed gas cylinder. The device may comprise any of a variety of suitable pumps. For example, in some embodiments, the pump is a gas pump. The pump may comprise, for example, a blower pump, a fan, a rotary vane pump, a scroll pump, a diaphragm pump, a hook and claw pump, a screw rotor pump, a dry piston pump, a sorption pump, an air compressor, a bellow, and/or a reciprocating pump. In some embodiments, the pump comprises a fan.

In some embodiments, the pump is configured to direct a flow of gaseous fluid through the delivery material. In some embodiments, the pump is fluidically connected to the housing. For example, in some embodiments, the pump is in fluidic communication with the housing. The pump may be directly fluidically connected to the housing. In some embodiments, the pump is fluidically connected to the housing inlet. For example, in some embodiments, the pump is in fluidic communication with the housing inlet. The pump may be directly fluidically connected to the housing inlet (e.g., via a conduit between the housing inlet and the pump outlet). The pump may be indirectly fluidically connected to the housing inlet (e.g., when the pump and the housing inlet are separated by a bed comprising an active ingredient). In some embodiments, the pump is fluidically connected to the housing outlet. In some embodiments, the pump is in fluidic communication with the housing outlet. The pump may be directly fluidically connected to the housing outlet (e.g., via a conduit between the housing outlet and the pump inlet). The pump may be indirectly fluidically connected to the housing outlet (e.g., when the pump and the housing outlet are separated by a bed comprising an active ingredient). In some embodiments, the pump is configured to direct the flow of gaseous fluid into the housing inlet, through the internal volume of the housing, and out of the housing outlet. The pump may direct the flow of gaseous fluid into the housing inlet, when a bed is present in the internal volume of the housing (e.g., when the bed has been received by the internal volume of the housing).

As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). A pump and a housing connected by an open conduit (thus allowing for the flow of fluid between the pump and the housing) are considered to be in fluidic communication with each other. In contrast, a pump and a housing separated by a closed valve (thus preventing the flow of fluid between the pump and the housing) are not considered to be in fluidic communication with each other.

As used herein, two elements are fluidically connected to each other when they are connected such that, under at least one configuration of the elements and any intervening elements, the two elements are in fluidic communication with each other. A pump and a housing connected by a conduit including a valve that permits flow between the pump and the housing in at least one configuration of the valve would be said to be fluidically connected to each other. To further illustrate, a pump and a housing that are connected by a valve that permits flow between the pump and the housing in a first valve configuration (e.g., an open configuration) but not a second valve configuration (e.g., a closed configuration) are still considered to be fluidically connected to each other both when the valve is in the first configuration and when the valve is in the second configuration. In contrast, a pump and a housing that are not associated with each other in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

Fluidic connections may be either direct fluidic connections or indirect fluidic connections. Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a conduit that connects a pump and a housing, and in which the pressure and temperature of the fluid is adjusted but the composition of the fluid is not altered, would be said to directly fluidically connect the pump and the housing. If, on the other hand, a separation step is performed and/or a chemical reaction is performed that substantially alters the composition of the stream contents during passage from the first component to the second component (e.g., during passage from the pump to the housing, or vice versa), the fluidic connection between the first component and the second component would not be said to be a direct fluidic connection. As another example, in some embodiments a housing inlet may be directly fluidically connected to a housing outlet (e.g., when the housing does not comprise a bed comprising a delivery material associated with an active ingredient). However, in some embodiments, the fluidic connection between the housing inlet and the housing inlet is indirect. For example, in some embodiments, an active ingredient present within a bed of the housing may be released, such that the composition of fluid is substantially changed by the release of the active ingredient.

The fluidic connections described herein may be made using any of a variety of suitable articles. In some embodiments, a fluidic connection can be made using a conduit. In certain embodiments, a fluidic connection can be made using one or more solid surfaces, such as one or more solid plates.

The pump may occupy any appropriate position with respect to the housing inlet and the housing outlet. For example, in some embodiments, the pump is fluidically connected to the housing inlet. For example, the pump may be directly fluidically connected to the housing inlet (e.g., via a conduit). In some embodiments, a pump fluidically connected to a housing inlet is configured to direct the flow of gaseous fluid from the pump to the housing inlet. In some embodiments, the pump functions as a positive pressure pump. According to some embodiments where the pump functions as a positive pressure pump, the gaseous fluid travels from the pump outlet into the housing inlet. In some embodiments where the pump functions as a positive pressure pump, the gaseous fluid travels from the housing inlet, and passes through the bed to the housing outlet. In some embodiments where the pump functions as a positive pressure pump, the gaseous fluid travels out of the housing outlet (e.g., into an enclosure or an external environment).

In some embodiments, the pump is fluidically connected to the housing outlet. For example, the pump may be directly connected to the housing outlet (e.g., via a conduit). In some embodiments, the pump is configured to direct gaseous fluid from the housing inlet to the housing outlet. In some embodiments, the pump is configured to direct gaseous fluid from the housing outlet to the pump (e.g., via suction). The gaseous fluid received by the pump may be released by the pump, e.g., into an external environment, or into a system comprising the device. In some embodiments, the pump functions as a vacuum pump. According to some embodiments where the pump functions as a vacuum pump, gaseous fluid travels into the housing inlet (e.g., from an enclosure or an external environment). According to some embodiments where the pump functions as a vacuum pump, gaseous fluid flows from the housing inlet, through the bed, and out of the housing outlet. According to some embodiments where the pump functions as a vacuum pump, gaseous fluid travels out of the housing outlet and into the pump inlet. According to some embodiments where the pump functions as a vacuum pump, gaseous fluid from the housing flows through the pump inlet and then out of the pump outlet (e.g., into an enclosure or an external environment). According to certain embodiments, the pump is disposed between the housing inlet and the housing outlet, such that the flow of gaseous fluid directed from the housing inlet passes through the pump before it is directed to the housing outlet.

The pump may have any appropriate disposition with respect to the housing. For example, in some embodiments, the pump is located outside the housing. For example, the pump may be connected to the housing via a conduit. In some embodiments, the pump is located inside the housing. For example, the pump may be located between the housing inlet and the housing outlet.

Generally, the pump may comprise any of a variety of suitable materials. According to certain embodiments, the pump is spark resistant. This may advantageously reduce a likelihood that the active ingredient will combust. Accordingly, in some embodiments, the pump may comprise spark resistant materials. Examples of spark resistant materials include, but are not limited to, nonferrous metals (e.g., aluminum, titanium), plastics, and fiberglass.

In some aspects, the disclosure is directed to a system. In some embodiments, the system is configured to retain an active ingredient. This may be advantageous, for example, because it allows contents of the system (e.g., agricultural and/or horticultural products, such as post-harvest plants and/or produce) to be exposed to the active ingredient at higher concentrations and/or for longer time periods than could otherwise be achieved with a comparable amount of the active ingredient. The system may comprise a device comprising a delivery material and an active ingredient, as described in greater detail elsewhere herein (e.g., including as described above and elsewhere herein with respect to FIGS. 1 and 2A-2D). According to certain embodiments, the system further comprises an enclosure, as described in greater detail below.

In some embodiments, the device and the enclosure together are configured to retain the active ingredient. For example, in some, but not necessarily all embodiments, the system is configured to retain at least 95 molar percent (mol %) (or at least 98 mol %, at least 99%, or more) of the active ingredient released from the device. The system may retain at least 95 mol % (or at least 98 mol %, at least 99%, or more) of active ingredient released from a device of the system for a period of at least 1 hour, at least 2 hours, at least 4 hours, at least 12 hours, at least 24 hours, at least 48 hours, at least 72 hours and/or up to 96 hours, up to 168 hours, up to 336 hours, or more. In some embodiments, the system is configured to retain the active ingredient at an equilibrium vapor concentration. For example, in some embodiments, a flow of gaseous fluid from the enclosure is directed towards a housing inlet of the device at least until a concentration of the active ingredient at the housing inlet is within 10% of, within 5% of, within 3% of, within 2% of, within 1% of, or closer to the concentration of the active ingredient at a housing outlet of the device to which the flow of gaseous fluid is directed from the inlet. FIGS. 3A-3C show system 300 comprising device 301 and enclosure 348, according to some embodiments. In some embodiments, such as those illustrated in FIGS. 3A-3C, system 300 is configured to retain an active ingredient. According to certain embodiments, an active ingredient is considered to be retained by the system, even if it is consumed within the enclosure (e.g., consumed by an agricultural and/or horticultural product within the enclosure).

In some embodiments, the system comprises an enclosure. The enclosure may have an internal volume. In some embodiments, the internal volume of the enclosure is fluidically connected to a device as described above. For example, in some embodiments, the internal volume of the enclosure is fluidically connected to a housing inlet of the device. In some embodiments, the internal volume of the enclosure is directly fluidically connected to the housing inlet of the device. In some embodiments, the internal volume of the enclosure is fluidically connected to a housing outlet of the device. For example, in some embodiments, the internal volume of the enclosure is directly fluidically connected to the housing outlet of the device. In some embodiments, the enclosure and the device together form a closed system (e.g., a system that is not fluidically connected to its surroundings). In some embodiments a pump (e.g., a pump of the device) is configured to direct the flow of gaseous fluid from the enclosure into the housing inlet, through an internal volume of the housing, and back to the enclosure via the housing outlet.

Returning now to FIGS. 3A-3C, in some embodiments, system 300 comprises enclosure 348 with internal volume 350. In some embodiments, agricultural and/or horticultural products 340 are optionally placed within the enclosure. According to certain embodiments, device 301 is placed within the enclosure, and configured such that a flow of air 360 can be directed from internal volume 350 of enclosure 348 through housing inlet 305 and housing outlet 307 of device 301, as shown in FIG. 3A. In some embodiments, device 301 is fluidically connected to internal volume 350 of enclosure 348. In some embodiments, the device is at least partially within the internal volume. For example, in some embodiments, such as the embodiment of FIG. 3A, the device 301 is fully contained within internal volume 350 of enclosure 348.

Device 301 does not necessarily need to be fully contained within internal volume 350 of enclosure 348 in all embodiments. In some embodiments, such as the embodiment illustrated in FIG. 3B, device 301 is external to the enclosure, and is fluidically connected to the enclosure via fluidic connections 352. The fluidic connections may be of any appropriate type. For example, the fluidic connections may comprise tubes, pipes, hoses, ducts, vents, and/or any other appropriate form of fluidic connection suitable for transmission of a gaseous fluid, and the disclosure is not so limited.

In some embodiments, device 301 is partially contained within internal volume 350 of enclosure 348. In FIG. 3C, for example, device 301 comprises housing outlet 307 within internal volume 350 of enclosure 348, but comprises housing inlet 305 that is connected to internal volume 350 of enclosure 348 via a fluidic connection 352. In each of FIGS. 3A-3B, the enclosure and the device are configured to retain the active ingredient, as described in greater detail elsewhere herein.

The enclosure (e.g., enclosure 348) may have any of a variety of appropriate volumes and dimensions. For example, in some embodiments, the enclosure has a volume of greater than or equal to 1 cubic meter, greater than or equal to 5 cubic meters, greater than or equal to 10 cubic meters, greater than or equal to 20 cubic meters, greater than or equal to 50 cubic meters, greater than or equal to 100 cubic meters, greater than or equal to 500 cubic meters, greater than or equal to 1000 cubic meters, greater than or equal to 5000 cubic meters, greater than or equal to 10,000 cubic meters, or greater. In some embodiments, the enclosure has a volume of less than or equal to 100,000 cubic meters, less than or equal to 50,000 cubic meters, less than or equal to 10,000 cubic meters, less than or equal to 5000 cubic meters, less than or equal to 1000 cubic meters, less than or equal to 500 cubic meters, less than or equal to 100 cubic meters, less than or equal to 50 cubic meters, or less. Combinations of these ranges are possible. For example, in some embodiments, the enclosure has a volume of greater than or equal to 1 cubic meter and less than or equal to 100,000 cubic meters.

According to certain embodiments, the internal volume of the enclosure is at least partially sealed from an external environment. In a configuration where the internal volume of the enclosure is at least partially sealed from an external environment, transmission of gaseous fluid through a sealed surface portion of the internal volume of the enclosure may be blocked such that a leak rate through that portion is less than or equal to 1.0×10⁻¹ atm-cc/sec; less than or equal to 1.0×10⁻³ atm-cc/sec; less than or equal to 1.0×10⁻⁵ atm-cc/sec; less than or equal to 1.0×10⁻⁷ atm-cc/sec; less than or equal to 1.0×10⁻¹⁰ atm-cc/sec, or as low as 0 atm-cc/sec with respect to at least one gas. In some embodiments where the internal volume of the enclosure is at least partially sealed from an external environment, transmission of gaseous fluid through a sealed surface portion of the internal volume of the enclosure is blocked such that a leak rate through that portion is less than or equal to 1.0×10⁻³ atm-cc/sec; less than or equal to 1.0×10⁻³ atm-cc/sec; less than or equal to 1.0×10⁻⁵ atm-cc/sec; less than or equal to 1.0×10⁻⁷ atm-cc/sec; less than or equal to 1.0×10⁻¹⁰ atm-cc/sec, or as low as 0 atm-cc/sec with respect to air.

In some embodiments, where the internal volume of the enclosure is at least partially sealed from an external environment, transmission of gaseous fluid through a sealed surface portion of the internal volume of the enclosure is blocked such that a leak rate through that portion is less than or equal to 1.0×10⁻¹ cc/sec, less than or equal to 1.0×10⁻³ cc/sec; less than or equal to 1.0×10⁻⁵ cc/sec; less than or equal to 1.0×10-7 cc/sec; less than or equal to 1.0×10⁻¹⁰ cc/sec, or as low as 0 cc/sec with respect to at least one gas when the pressure in the interior volume is 2 atm and the pressure of the external environment is 1 atm, both at 25° C. In some embodiments, where the internal volume of the enclosure is at least partially sealed from an external environment, transmission of gaseous fluid through a sealed surface portion of the internal volume of the enclosure is blocked such that a leak rate through that portion is less than or equal to 1.0×10⁻¹ cc/sec, less than or equal to 1.0×10⁻³ cc/sec; less than or equal to 1.0×10⁻⁵ cc/sec; less than or equal to 1.0×10⁻⁷ cc/sec; less than or equal to 1.0×10⁻¹⁰ cc/sec, or as low as 0 cc/sec with respect to air when the pressure in the interior volume is 2 atm and the pressure of the external environment is 1 atm, both at 25° C.

In some embodiments, the sealed surface portion makes up greater than or equal to 5%, greater than or equal to 25%, greater than or equal to 50%, greater than or equal to 75%, greater than or equal to 95%, or more of a surface of the internal volume of the enclosure. In some embodiments, the sealed surface portion makes up less than or equal to 99%, less than or equal to 95%, less than or equal to 75%, less than or equal to 50%, less than or equal to 25%, or less of a surface of the internal volume of the enclosure. Combinations of these ranges are possible. For example, in some embodiments, sealed surface portion makes up greater than or equal to 5% and less than or equal to 99% of a surface of the internal volume of the enclosure.

It should be understood that in some embodiments the enclosure is not sealed from the environment. At least a portion of the internal volume of the enclosure may be in fluid communication with the exterior of the enclosure under at least some configurations of the system. For example, in some embodiments the enclosure includes an opening through which fluid (e.g., gas) may flow under at least some configurations of the system. For example, the enclosure may include one or more vents. The vents may be closable (e.g., via valving). The vents may be opened and/or closed manually and/or via remote actuation (e.g., from a controller). Having at least a portion of the interior volume of the enclosure in fluid communication with the exterior of the enclosure may allow for fluid exchange (e.g., gas exchange) with the outside environment during at least some periods of time during treatment of agricultural and/or horticultural products with the active ingredient (e.g., via directed gaseous fluid flow) within the enclosure.

A system may be configured to reach a minimum concentration of the active ingredient within the enclosure.

In some embodiments, the minimum concentration of the active ingredient within the enclosure (e.g., during at least one point of and/or following release of the active ingredient from the device) is greater than or equal to 0.01 parts per million (ppm) on a mass basis, greater than or equal to 0.05 ppm on a mass basis, greater than or equal to 0.1 ppm on a mass basis, greater than or equal to 0.5 ppm on a mass basis, greater than or equal to 1 ppm on a mass basis, greater than or equal to 5 ppm on a mass basis, or greater. In some embodiments, the minimum concentration of the active ingredient within the enclosure (e.g., during at least one point of and/or following release of the active ingredient from the device) is less than or equal to 50 ppm on a mass basis, less than or equal to 10 ppm on a mass basis, less than or equal to 5 ppm on a mass basis, less than or equal to 1 ppm on a mass basis, less than or equal to 0.5 ppm on a mass basis, less than or equal to 0.1 ppm on a mass basis, or less. Combinations of these ranges are possible. For example, in some embodiments, the minimum concentration of the active ingredient within the enclosure (e.g., during at least one point of and/or following release of the active ingredient from the device) is greater than or equal to 0.01 ppm and less than or equal to 50 ppm on a mass basis.

In some embodiments, the minimum concentration of the active ingredient within the enclosure (e.g., during at least one point of and/or following release of the active ingredient from the device) is greater than or equal to 0.01 parts per million (ppm) on a molar basis, greater than or equal to 0.05 ppm on a molar basis, greater than or equal to 0.1 ppm on a molar basis, greater than or equal to 0.5 ppm on a molar basis, greater than or equal to 1 ppm on a molar basis, greater than or equal to 5 ppm on a molar basis, or greater. In some embodiments, the minimum concentration of the active ingredient within the enclosure (e.g., during at least one point of and/or following release of the active ingredient from the device) is less than or equal to 50 ppm on a molar basis, less than or equal to 10 ppm on a molar basis, less than or equal to 5 ppm on a molar basis, less than or equal to 1 ppm on a molar basis, less than or equal to 0.5 ppm on a molar basis, less than or equal to 0.1 ppm on a molar basis, or less. Combinations of these ranges are possible. For example, in some embodiments, the minimum concentration of the active ingredient within the enclosure (e.g., during at least one point of and/or following release of the active ingredient from the device) is greater than or equal to 0.01 ppm on a molar basis and less than or equal to 50 ppm on a molar basis.

A system may be configured to reach an average concentration of the active ingredient within the enclosure. In this context, the average concentration refers to the spatially averaged concentration within the enclosure.

In some embodiments, the average concentration of the active ingredient within the enclosure (e.g., during at least one point of and/or following release of the active ingredient from the device) is greater than or equal to 0.01 parts per million (ppm) on a mass basis, greater than or equal to 0.05 ppm on a mass basis, greater than or equal to 0.1 ppm on a mass basis, greater than or equal to 0.5 ppm on a mass basis, greater than or equal to 1 ppm on a mass basis, greater than or equal to 5 ppm on a mass basis, or greater. In some embodiments, the average concentration of the active ingredient within the enclosure (e.g., during at least one point of and/or following release of the active ingredient from the device) is less than or equal to 50 ppm on a mass basis, less than or equal to 10 ppm on a mass basis, less than or equal to 5 ppm on a mass basis, less than or equal to 1 ppm on a mass basis, less than or equal to 0.5 ppm on a mass basis, less than or equal to 0.1 ppm on a mass basis, or less. Combinations of these ranges are possible. For example, in some embodiments, the average concentration of the active ingredient within the enclosure (e.g., during at least one point of and/or following release of the active ingredient from the device) is greater than or equal to 0.01 ppm and less than or equal to 50 ppm on a mass basis.

In some embodiments, the average concentration of the active ingredient within the enclosure (e.g., during at least one point of and/or following release of the active ingredient from the device) is greater than or equal to 0.01 parts per million (ppm) on a molar basis, greater than or equal to 0.05 ppm on a molar basis, greater than or equal to 0.1 ppm on a molar basis, greater than or equal to 0.5 ppm on a molar basis, greater than or equal to 1 ppm on a molar basis, greater than or equal to 5 ppm on a molar basis, or greater. In some embodiments, the average concentration of the active ingredient within the enclosure (e.g., during at least one point of and/or following release of the active ingredient from the device) is less than or equal to 50 ppm on a molar basis, less than or equal to 10 ppm on a molar basis, less than or equal to 5 ppm on a molar basis, less than or equal to 1 ppm on a molar basis, less than or equal to 0.5 ppm on a molar basis, less than or equal to 0.1 ppm on a molar basis, or less. Combinations of these ranges are possible. For example, in some embodiments, the average concentration of the active ingredient within the enclosure (e.g., during at least one point of and/or following release of the active ingredient from the device) is greater than or equal to 0.01 ppm on a molar basis and less than or equal to 50 ppm on a molar basis.

In some embodiments, a system may be configured to reach a minimum concentration or an average concentration of the active ingredient within the enclosure within a relatively short period of time. This may, in some instances, allow for relatively rapid treatment of agricultural and/or horticultural products located within the system (e.g., within the enclosure) with the active ingredients compared to techniques that release the active ingredient more slowly. In some embodiments, a system may be configured to reach a minimum concentration or an average concentration of the active ingredient within the enclosure in less than or equal to 1 day, less than or equal to 10 hours, less than or equal to 5 hours, less than or equal to 3 hours, less than or equal to 2 hours, less than or equal to 1 hours, less than or equal to 10 minutes less than or equal to 5 minutes, less than or equal to 1 minute, or less. In some embodiments, a system may be configured to reach a minimum concentration or an average concentration of the active ingredient within the enclosure within a time period that is greater than or equal to 1 second, greater than or equal to 10 seconds, greater than or equal to 1 minute, greater than or equal to 10 minutes, greater than or equal to 1 hour, greater than or equal to 2 hours, greater than or equal to 3 hours, or greater. Combinations of these ranges are possible. For example, in some embodiments, a system may be configured to reach a minimum concentration of the active ingredient within the enclosure within a time period that is greater than or equal to 1 second and less than or equal to 1 day. As a more specific example, in some embodiments, a system may be configured to reach a minimum concentration of the active ingredient within the enclosure within a time period that is greater than or equal to 1 second and less than or equal to 5 hours.

Combinations of the preceding ranges are possible. For example, a system may be configured to reach a minimum concentration or an average concentration of the active ingredient of greater than or equal to 1 ppm (on a mass basis or a molar basis) within the enclosure within less than or equal to 5 hours. In some embodiments, a system may be configured to reach a minimum concentration or an average concentration of the active ingredient of greater than or equal to 0.5 ppm (on a mass basis or a molar basis) within the enclosure within less than or equal to 1 day. In some embodiments, a system may be configured to reach a minimum concentration or an average concentration of the active ingredient of greater than or equal to 0.1 ppm (on a mass basis or a molar basis) within the enclosure within less than or equal to 1 day.

In some embodiments, the system comprises one or more agricultural and/or horticultural products. Agricultural and/or horticultural products include, but are not limited to, produce and plants or plant components. For example, the system may comprise one or more agricultural and/or horticultural products (e.g., produce, plants, and/or components of plants) within the internal volume of the enclosure. In some embodiments, the agricultural and/or horticultural product is exposed to the active ingredient within the system. For example, the agricultural and/or horticultural product may be exposed to gaseous fluid comprising the active ingredient. The agricultural and/or horticultural product may be exposed to active ingredient released from the delivery material in the bed. The released active ingredient may be transported to the agricultural and/or horticultural product via diffusion. In some embodiments, the released active ingredient is transported to the agricultural and/or horticultural product via convection (e.g., within the enclosure). In some embodiments, the released active ingredient may be transported to the agricultural and/or horticultural product via driven fluid flow. In some embodiments, the released active ingredient may be transported to the agricultural and/or horticultural product via a combination of diffusion, convection, and/or mechanically driven (e.g., pumped) fluid flow. In some embodiments, an agricultural and/or horticultural product of the system (e.g., in the enclosure) is pre-harvest (e.g., a complete, living plant, which may comprise produce). In some embodiments, an agricultural and/or horticultural product of the system (e.g., in the enclosure) is post-harvest. Examples of post-harvest plants include uprooted plants, as well as produce such as fruits, leaves, flowers, seeds, legumes, roots, tubers, and/or bulbs. Of course, it should be understood that these agricultural and/or horticultural products are nonlimiting and any other type of agricultural and/or horticultural product may be included in the system. Examples of fruits include but are not limited to berries, such as strawberries, raspberries, blackberries, blueberries, elderberries, gooseberries, and grapes. Examples of leaves include but are not limited to leafy vegetables such as lettuce, spinach, and cabbage and herbs such as basil, oregano, and dill. Examples of flowers include but are not limited to edible flowers, such as broccoli and cauliflower, and non-edible flowers, such as cannabis flowers. Examples of seeds include but are not limited to corn, wheat, rice, barley, and oats. Examples of legumes include but are not limited to soybeans, lima beans, peas, peanuts, kidney beans, navy beans. Examples of roots include but are not limited to potatoes, carrots, and beets. Examples of tubers include but are not limited to potatoes and sweet potatoes.

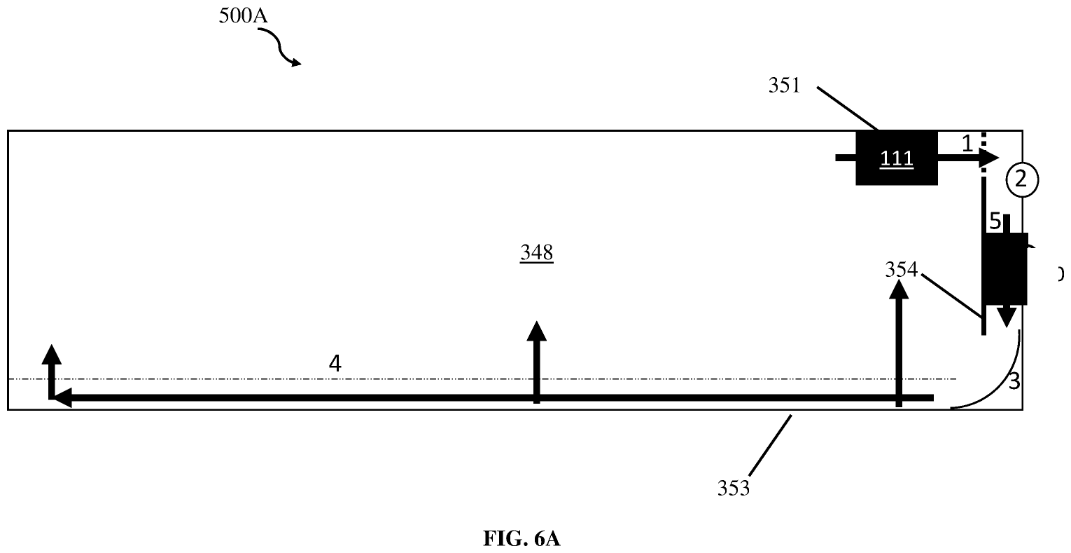

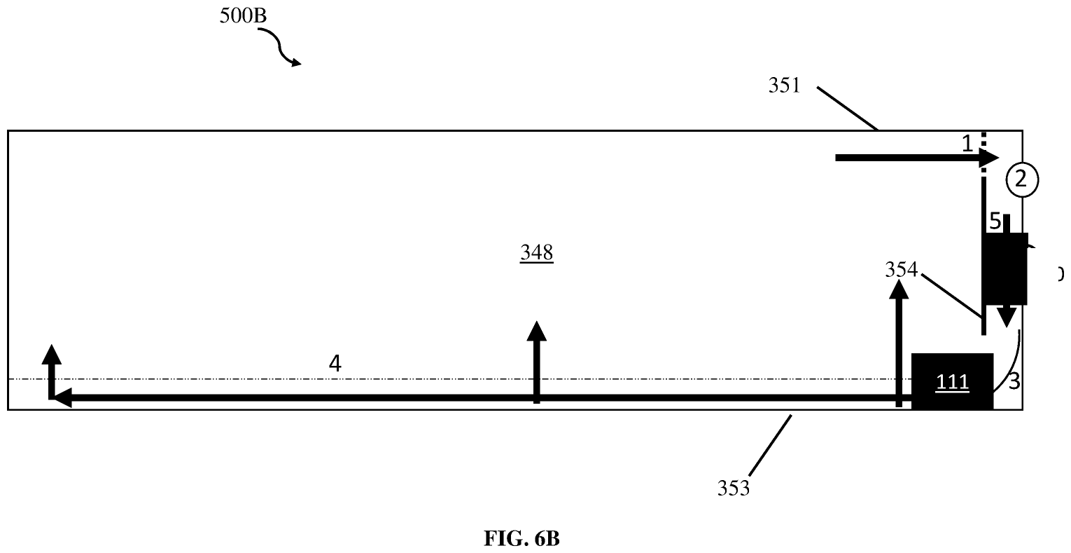

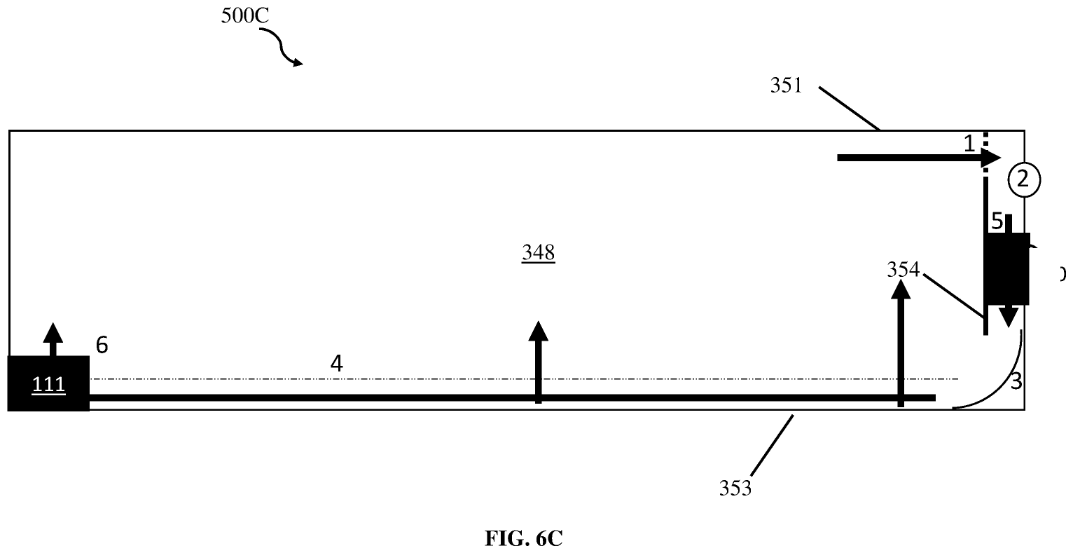

In some embodiments, the device of this disclosure (e.g., comprising a pump fluidically connected to a bed) is at least partially within the enclosure. In some instances, the bed (e.g., comprising a delivery material and an active ingredient) is within the enclosure. In some, but not necessarily all instances, the pump is within the enclosure. FIG. 6A, for example, shows a cross-sectional schematic diagram of one such embodiment where system 500A comprises bed 111 and pump 120 fluidically connected to bed 111, each within enclosure 348.

The configuration shown in FIG. 6A is one example of a system in which gaseous fluid flow within the enclosure can be effectively directed to objects within the enclosure, such as agricultural and/or horticultural products. For example, gaseous fluid such as air within enclosure 348 may be directed through an intake at location 1, past vent 2, and to pump 120 at location 5, as indicated by the arrows. Pump 120 is shown as a block in FIG. 6A, but it should be understood that any of a variety of the pump configurations shown and described in this disclosure may be employed. For example, pump 120 may comprise a fan. In FIG. 6A, bed 111 is located near location 1 such that at least some gaseous fluid directed from elsewhere in enclosure 348 into the intake at location passes through bed 111. Passing through bed 111 may result in the formation of an effluent stream comprising an active ingredient from the bed, as described in this disclosure. While bed 111 is shown as a block in FIG. 6A, such a depiction is for convenience, and bed 111 may have any of the configurations and compositions described elsewhere in this disclosure (e.g., as in FIGS. 1, 2B-2E, and 7A-7E). For example, in some embodiments, the bed in the enclosure (e.g., bed 111 in enclosure 348 in FIG. 6A) comprises one or more sachets comprising the delivery material (e.g., a particulate delivery material such as particulate carbon material and/or silicate material) and an active ingredient. While the bed (e.g., bed 111) may, in some instances, be in an internal volume of a housing with a housing inlet and housing outlet, such a configuration is not necessary. For example, in some embodiments represented by FIG. 6A, bed 111 may be a sachet affixed to surface 351 of enclosure 348. Flow of gaseous fluid past the intake at location 1 may be directed to location 5 (where pump 120 can be located) via a fluidic pathway established by the presence of solid plate 354.

As mentioned above, enclosure 348 in FIG. 6A may comprise vent 2. Vent 2 may be in fluidic communication with fluid exterior to enclosure 348. For example, vent 2 may draw in fresh fluid (e.g., fresh air) as gaseous fluid having passed by the intake at location 1 passes vent 2. Gaseous fluid may also flow from inside enclosure 348 to outside enclosure 348 via vent 2 and/or any imperfections in sealing of enclosure 348. The system may be configured such that such a fluid exchange (e.g., via vent 2) is controlled (e.g., automatedly, such as via a computer-implemented control system configured to actuate valving at vent 2). The system may be configured such that such a fluid exchange (e.g., via vent 2) occurs at any of a variety of time frequencies. For example, the system may perform such a fluid exchange greater than or equal to 1 time, greater than or equal to 2 times, greater than or equal to 3 times, and/or up to 4 times, up to 5 times, or more per hour. Fluid exchange (e.g., via vent 2) may be initiated in response to a stimulus based on a measurement of a parameter within the enclosure, such as an O₂ or CO₂ concentration measurement. In some embodiments, vent 2 is left open and is not controlled during at least a portion (or all) of a period of time during which enclosure 348 in FIG. 6A is operated. However, in some embodiments, the vent is kept closed and no fluid exchange is allowed to occur (e.g., when the enclosure contains agricultural and/or horticultural products that are not expected to respire or need fresh air).

In FIG. 6A, gaseous fluid may be directed by pump 120 at location 5 in the direction of the arrows shown toward fluid-directing-structure 3, which can be configured (e.g., via its shape, orientation, and/or placement) to direct the gaseous fluid along surface 353 of enclosure 348 in the direction of the arrow shown. One example of a suitable fluid-directing structure is a bevel plate. Direction of the gaseous fluid (e.g., air comprising at least some of the active ingredient from the delivery material of bed 111) along surface 353 may be assisted by fluid-directing structure 4. Fluid-directing structure 4 may be configured (e.g., via its shape, orientation, and/or placement) to also allow flow of the gaseous fluid (e.g., air) toward an interior portion of enclosure 348, as shown by the arrows perpendicular to surface 353. For example, fluid-directing-structure 4 may comprise one or more I-beams that establish open channels for gaseous fluid flow. In some embodiments, agricultural and/or horticultural products (e.g., in pallets) are located on a fluid-directing-structure (e.g., I-beams) such that gaseous fluid flow normal to a surface of the enclosure passes the products, allowing exposure of the products to active ingredient in the gaseous fluid. Presence of the products (e.g., in pallets) may restrict flow of gaseous fluid into the interior of the enclosure to spaces between products, which may promote further flow of the gaseous fluid along the surface of the enclosure (e.g., along surface 353 in FIG. 6A). Such flow characteristics within the enclosure may, in some instances, promote good mixing of gaseous fluid (e.g., refrigerated air) and relatively uniform temperature through the interior of the enclosure. As shown by the different arrow sizes in FIG. 6A, flux of the gaseous fluid toward interior of enclosure 348 may decrease as a distance from pump 120 and/or fluid-directing-structure 3 (e.g., a bevel plate) increases.

The bed may be located in any of a variety of locations in the enclosure. For example, in FIG. 6A, bed 111 is located near the intake at location 1. In some such embodiments, bed 111 (e.g., one or more sachets with delivery material and active ingredient) is affixed to surface 351 (e.g., a top surface of the enclosure such as the roof of a truck container). However, other locations are possible. For example, FIG. 6B shows a cross-sectional schematic diagram of an embodiment where system 500B comprises bed 111 at location 3 (e.g., affixed to fluid-directing structure 3 such as a bevel plate). In this embodiment, gaseous fluid is directed from pump 120 (e.g., part of a refrigeration unit) at location 5 through bed 111 (e.g., comprising one or more sachets comprising delivery material and an active ingredient) near location 3 to form an effluent stream of gaseous fluid comprising the active ingredient that is directed along surface 353. As another example, FIG. 6C a cross-sectional schematic diagram of an embodiment where system 500C comprises bed 111 at location 6 near a far end of enclosure 348 with respect to pump 120 at location 5 and fluid-directing-structure 3. For example, in some embodiments where the enclosure is part of a vehicle (e.g., a refrigerated vehicle), a door may be located near location 6, and bed 111 may be located near the door.

In some embodiments, the enclosure is a refrigerated enclosure. A refrigerated enclosure generally refers to any enclosure whose temperature is at least partially controlled by a refrigeration unit. Refrigeration units, as is generally understood, can comprise one or more refrigerant-cooled compressors and a pump configured to direct gaseous fluid (e.g., air) into and/or out of the compressor. For example, a refrigeration unit may comprise a fan that can direct gaseous fluid (e.g., air) through a refrigeration unit housing, through the compressor where a temperature of the gaseous fluid is decreased, and out of the refrigeration unit housing. In some embodiments, the pump of the device (e.g., that directs gaseous fluid through the bed) is part of a refrigeration unit. For example, the operation of the fan of a refrigeration unit comprising the fan and a compressor may serve to direct gaseous fluid flow within the refrigerated enclosure such that it passes through the bed. In some embodiments, the refrigerated enclosure is configured to maintain an average temperature within the enclosure within any of the temperature ranges described below with respect to the temperature at which an active ingredient is released. For example, the refrigerated enclosure may be configured to maintain a temperature of greater than or equal to −80° C. and less than or equal to 25° C., or greater than or equal to −2° C. and less than or equal to 15° C., or greater than or equal to −1° C. and less than or equal to 13° C. In some embodiments, enclosure 348 in FIGS. 6A, 6B, and 6C is a refrigerated enclosure. For example, pump 120 may be part of a refrigeration unit (e.g., comprising the pump such as a fan and a compressor) at location 5. In some embodiments, the pump of the enclosure is part of a refrigeration unit configured to produce a condenser air flow of at least 3,000 cubic meters per hour, at least 3,500 cubic meters per hour, at least 3,800 cubic meters per hour, and/or up to 4,000 cubic meters per hour (e.g., when operated at a frequency of 60 Hz). In some embodiments, the enclosure has a unit heat leakage of less than or equal to 5 W/K, less than or equal to 4 W/K, and/or as low as 3 W/K, or lower.

In some embodiments, the enclosure (e.g., within which at least part of the device is located) is part of, or configured to be part of, a vehicle. The vehicle can be a machine that transports cargo on land, in the air, and/or in water. Examples vehicles include, but are not limited to, automobiles (including cars and trucks), locomotives, aircraft (e.g., airplanes), and watercraft (e.g., ships). For example, a vehicle such as an automobile (e.g., a truck) may comprise such an enclosure. In some embodiments, the enclosure is part of a freight container. For example, the enclosure may be part of an intermodal freight container. In some embodiments, an enclosure configured to be part of a vehicle is integrally connected to the vehicle. In some embodiments, an enclosure configured to be part of a vehicle is a detachable from the vehicle. For example, the enclosure may be part of a trailer that can connect to a trailer truck (e.g., to form a semi-tractor-trailer truck comprising the enclosure). An enclosure that is part of a vehicle or configured to be part of a vehicle need not necessarily be attached or attachable to other components of the vehicle. In some embodiments where the enclosure is part of a vehicle or is configured to be part of a vehicle, the enclosure is a shipping container (e.g., a removable shipping container) on a platform of the vehicle. For example, the enclosure may be a shipping container resting on a flat trailer bed. As another example, the enclosure may be a shipping container resting on a surface of a ship or another shipping container on the ship. In some instances, systems 500A, 500B, or 500C shown in FIGS. 6A-6C are part of or configured to be part of a vehicle. In some such embodiments where the enclosure is part of or configured to be part of a vehicle, the enclosure is a refrigerated enclosure. For example, the enclosure may be a refrigerated shipping container. Such a vehicle comprising a refrigerated enclosure (e.g., in the form of enclosure 348 in FIG. 6A, 6B, or 6C) may be useful for transporting potentially perishable products such as certain agricultural and/or horticultural products, as such products may take longer to perish at relatively low temperatures that can be afforded by refrigeration. As such, in some embodiments, a refrigerated vehicle comprising an enclosure such as that described in FIGS. 6A, 6B, and 6C may be able to efficiently treat frozen or chilled agricultural and/or horticultural products with active ingredients (e.g., gaseous active ingredients) during transportation under refrigerated conditions. Refrigerated vehicles (e.g., refrigerated trucks) are commercially available and may have any of a variety of enclosure sizes. In some embodiments, the enclosure (e.g., refrigerated enclosure) of a vehicle has internal dimensions of a length of 2-4 m, a width of 2-4 m, and a height of 2-4 m. In some embodiments, the refrigerated enclosure can be or be part of a refrigerated container (also referred to in the art as a “reefer”).

According to some aspects, the disclosure is directed towards articles for release of an active ingredient. The article can, in some embodiments, contain delivery material, which can be loaded with one or more active ingredients. In some embodiments, the article may be configured to be received by any of the devices described in greater detail above or elsewhere herein. In some embodiments, the article can be removable from any of the devices described above or elsewhere herein. In some embodiments, the article is in the form of a cartridge.

In some embodiments, the article comprises a container. The container comprises a container inlet, according to certain embodiments. The container comprises a container outlet, according to certain embodiments. In some embodiments, the container comprises an internal volume.

According to certain embodiments, the internal volume of the container comprises a bed comprising a delivery material (e.g., a delivery material associated with an active ingredient), as described elsewhere herein. The article further comprises a filter, in some embodiments. The filter may be configured to reduce or prevent the transmission of the delivery material out of the container. For example, the filter may be configured to reduce or prevent the transmission of the delivery material through the container inlet and/or the container outlet. Similarly, the filter may be configured to reduce or prevent the transmission of the delivery material into the pump.

In various embodiments, the article is configured to be received into an internal volume of any of the devices described above or elsewhere herein. In some embodiments, the article is configured such that a flow of gaseous fluid directed through the device travels into the article via the container inlet and out of the article via the container outlet. In some embodiments, the flow of air through the container is used to release an effluent stream comprising the active ingredient. For example, the effluent stream may be released from the delivery material in the bed of the article.

Use of such articles within a device or system as described above may have several advantages. For example, in some embodiments, the article is removable from the device, advantageously allowing its replacement with a new article comprising a higher concentration of an active ingredient. In some embodiments, the article is disposable. In some embodiments, the article is reusable (e.g., by adding active ingredient to the delivery material of the article after the delivery material has been depleted of an initial concentration of the active ingredient). In some embodiments, the container is configured such that flow of gaseous fluid (e.g., airflow) directed to a housing outlet from a housing inlet of the device must pass through the container of the article. Advantageously, this may increase a rate of release of the active ingredient from the delivery material. Without wishing to be bound by theory, the increased rate of release of the active ingredient from delivery material may result from an increase in the volume of gaseous fluid exposed to the delivery material and/or an increase in the rate at which the effluent stream is removed from the delivery material.

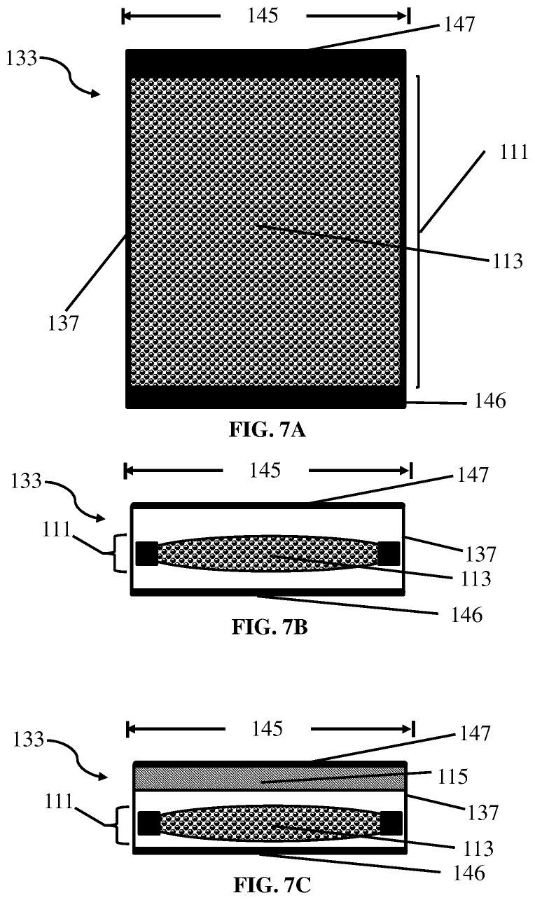

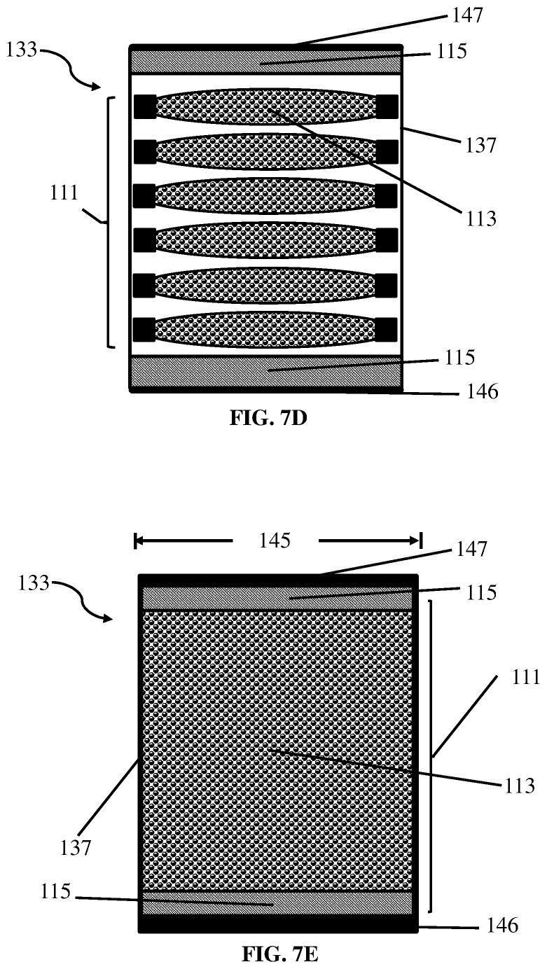

FIGS. 7A-7D are cross-sectional schematic diagrams of articles 133 configured to release active ingredients, according to certain embodiments. FIG. 7A shows article 133, which comprises bed 111 comprising delivery material 113 in the form of a particulate material. Bed 111 is located within container 137, which comprises container inlet 146 (located within the bold line) and container outlet 147 (located within the bold line). Article 133 comprises a maximum lateral dimension (e.g., a diameter) 145, in some embodiments. Article 133 may have a maximum lateral dimension of greater than or equal to 0.05 m, greater than or equal to 0.1 m, greater than or equal to 0.2 m, greater than or equal to 0.3 m, greater than or equal to 0.4 m, greater than or equal to 0.5 m, or greater. In some embodiments, the article has a maximum lateral dimension of less than or equal to 1 m, less than or equal to 0.8 m, less than or equal to 0.5 m, less than or equal to 0.4 m, less than or equal to 0.3 m, less than or equal to 0.2 m, or less. Combinations of these ranges are possible. For example, in some embodiments, article has a maximum lateral dimension of greater than or equal to 0.05 m, and less than or equal to 1 m.

FIG. 7B shows an article similar to the article of FIG. 7A, in which bed 111 comprising delivery material 113 has the form of a sachet. FIG. 7C shows an article similar to the article of FIG. 7A, further comprising filter 115, which is configured to prevent transmission of delivery material 113 through at least a portion of container 137 (specifically, the filter is positioned between delivery material 113 and container outlet 147, in embodiments such as that of FIG. 7B). In this article, bed 111 comprising delivery material 113 has the form of a sachet. FIG. 7D shows an article similar to the article of FIG. 7C, wherein the bed comprises more than one sachet, and wherein the article further comprises two filters 115, which are configured to reduce or prevent transmission of delivery material 113 through at least a portion of container 137 (specifically, the filters are positioned between delivery material 113 and container inlet 146, as well as between delivery material 113 and container outlet 147, in embodiments such as that of FIG. 7D). FIG. 7E shows an article similar to the article of FIG. 7A, wherein the article further comprises two filters 115, which are configured to reduce or prevent transmission of delivery material 113 through at least a portion of container 137 (specifically, the filters are positioned between delivery material 113 and container inlet 146, as well as between delivery material 113 and container outlet 147, in embodiments such as that of FIG. 7E). Of course, articles with configurations other than those of FIGS. 7A-7D are contemplated, and other configurations of filters and delivery materials are possible.

As mentioned above, the devices, systems, and methods described in this disclosure may comprise and/or involve release of active ingredients. The active ingredients may be associated with the delivery material (e.g., a porous and solid delivery material) of the composition. The active ingredient may be useful for applications in at least one of agriculture, pest control, odor control, and food preservation.

In some embodiments, the active ingredient suitable for treating at least one type of agricultural and/or horticultural product. For example, the active ingredient may be generally non-toxic to at least one type of agricultural and/or horticultural product. In some embodiments, the active ingredient is generally non-toxic to an agricultural and/or horticultural product to which it is applied (e.g., following directed gaseous fluid flow-accelerated release from a delivery material). In some embodiments, the active ingredient is volatile (e.g., at 25° C.) and is generally non-toxic to an agricultural and/or horticultural product to which it is applied. For example, the active ingredient may comprise a volatile organic compound that is generally non-toxic to at least one type of agricultural and/or horticultural product (e.g., an agricultural and/or horticultural product to which it is applied). With the benefit of this disclosure, one or ordinary skill in the art would be able to determine whether an active ingredient is generally non-toxic to an agricultural and/or horticultural product (e.g., by setting up a benchtop screening test to expose the product to the active ingredient at a suitable set of doses to assess phytotoxicity, or by referring to agricultural industry academic or reference literature). In some embodiments, the active ingredient affects a biological process of at least one type of agricultural and/or horticultural product. For example, the active ingredient may affect a biological process (e.g., ripening, sprouting, microbe growth, fungal growth, loss or change in pigmentation, endogenous production of a hormone such as ethylene) by initiating and/or accelerating the biological process. In some embodiments, the active ingredient affects a biological process (e.g., ripening, sprouting, microbe growth, fungal growth) by decelerating and/or stopping the biological process. In some embodiments, the active ingredient affects a biological process of an agricultural and/or horticultural product to which it is applied (e.g., following directed gaseous fluid flow-accelerated release from a delivery material). In some embodiments, the active ingredient is volatile (e.g., at 25° C.) and affects a biological process of an agricultural and/or horticultural product to which it is applied. For example, the active ingredient may comprise a volatile organic compound that affects a biological process of at least one type of agricultural and/or horticultural product (e.g., an agricultural and/or horticultural product to which it is applied). With the benefit of this disclosure, one or ordinary skill in the art would be able to determine whether an active ingredient affects a biological process of an agricultural and/or horticultural product (e.g., by setting up a benchtop screening test to expose the product to the active ingredient at a suitable set of doses to assess change in biological activity, or by referring to agricultural industry academic or reference literature). For example, some active ingredients such as 1-methylcylopropene can affect the shelf-life of agricultural and/or horticultural products such as fruit. The shelf-life of a fruit exposed to an active ingredient can be measured by comparing a loss in firmness in the fruit compared to a control experiment. Other biological processes that can be assessed by simple screening tests include, but are not limited to loss of stem health, reduction in ethylene production, acceleration of loss of green color or softening (which are processes that can be caused by active ingredients such as ethylene), and extent or avoidance of damage from species such as fungi. In some embodiments, the active ingredient is generally non-toxic to and affects a biological process of at least one type of agricultural and/or horticultural good (e.g., an agricultural and/or horticultural product to which it is applied).

In some embodiments, the active ingredient comprises a compound that accelerates ripening of produce. In some embodiments, the active ingredient comprises a compound that slows the ripening of produce.

In some embodiments, the active ingredient comprises an ethylene inhibitor. Ethylene inhibitors are generally known, and can, in some instances improve the quality and/or shelf life of produce (e.g., by delaying ripening of produce). In some embodiments, the ethylene inhibitor comprises a cyclopropene, which is described in more detail below.

In some embodiments, the active ingredient comprises an inhibitor of ethylene biosynthesis; an inhibitor of a fruit and vegetable membrane degrading phospholipase (e.g., N-(2-chloro-4-pyrridinyl)N-phenyl urea); a volatile plant hormone; a mint extract; a phenolic compound (e.g., phenol, guaiacol); hydrogen peroxide; hexanal; a Fenugreek extract; an ethylene promoter; a plant growth regulator; a biopesticide; a phospholipase-D inhibitor; an antimicrobial; an antifungal; an antibacterial; and/or an antiviral.

In some embodiments, the active ingredient comprises ethylene.

In some embodiments, the active ingredient comprises a plant growth regulator. For example, the active ingredient may comprise ethephon.

In some embodiments, the active ingredient comprises a sprout suppressant. In other words, the active ingredient may reduce, delay, or prevent sprouting in sprouting-susceptible agricultural products such as sprouting-susceptible produce. The active ingredient may, in accordance with certain embodiments, be or comprise any of the sprout suppressants described below (alone or as mixtures comprising one or more sprout suppressants). For example, the active ingredient may comprise an essential oil. Non-limiting examples of essential oils are described in more detail below. A non-limiting example of an essential oil that is a sprout suppressant is spearmint oil or spearmint extract. In some embodiments, the sprout suppressant comprises carvone. For example, the sprout suppressant may comprise an oil or extract comprising carvone. As another example, the sprout suppressant may comprise isopropyl-N-(3-chlorophenyl) carbamate. In some embodiments, the sprout suppressant comprises 3-decen-2-one and/or 1,4-dimethylnaphthalene. In some embodiments, the sprout suppressant comprises limonene. As another example, in some embodiments the sprout suppressant comprises citral.

As mentioned above, the active ingredient (e.g., sprout suppressant) may comprise carvone. It should be understood that carvone has two possible enantiomers. One enantiomer of carvone is (R)-(−)-carvone, and the other enantiomer of carvone is (S)-(+)-carvone. As would be generally understood, references made to an active ingredient comprising carvone elsewhere in this disclosure each mean the active ingredient comprises one or both enantiomers of carvone. In some embodiments, the active ingredient comprises carvone, and at least some (e.g., at least 10 wt %, at least 25 wt %, at least 50 wt %, at least 75 wt %, at least 90 wt %, at least 95 wt %, at least 98 wt %, at least 99 wt %, at least 99.9%, or all) of the carvone of the active ingredient is (R)-(−)-carvone. In some embodiments, the active ingredient comprises carvone, and at least some (e.g., at least 10 wt %, at least 25 wt %, at least 50 wt %, at least 75 wt %, at least 90 wt %, at least 95 wt %, at least 98 wt %, at least 99 wt %, at least 99.9%, or all) of the carvone of the active ingredient is (S)-(+)-carvone. In some embodiments, the active ingredient comprises carvone, and at least some (e.g., at least 10 wt %, at least 25 wt %, at least 50 wt %, at least 75 wt %, at least 90 wt %, at least 95 wt %, at least 98 wt %, at least 99 wt %, at least 99.9%) of the carvone of the active ingredient is (R)-(−)-carvone and at least some (e.g., at least 10 wt %, at least 25 wt %, at least 50 wt %, at least 75 wt %, at least 90 wt %, at least 95 wt %, at least 98 wt %, at least 99 wt %, at least 99.9%) of the carvone of the active ingredient is (S)-(+)-carvone. For example, the active ingredient may comprise a racemic mixture of (R)-(−)-carvone and (S)-(+)-carvone.

In some embodiments, the active ingredient (e.g., sprout suppressant) comprises an essential oil comprising (R)-(−)-carvone. For example, the active ingredient may comprise spearmint oil (or spearmint extract), which comprises (R)-(−)-carvone.

In some embodiments, the active ingredient (e.g., sprout suppressant) comprises an essential oil comprising (S)-(+)-carvone. For example, the active ingredient may comprise caraway seed oil, which comprises (S)-(+)-carvone.

In some embodiments, the active ingredient (e.g., sprout suppressant comprises citral). In some embodiments, the active ingredient (e.g., sprout suppressant) comprises an essential oil comprising citral. For example, the active ingredient may comprise lemongrass, which comprises citral.

In some embodiments, the active ingredient comprises a sprout suppressant comprising a compound that can affect a biological mechanism of produce, thereby reducing, delaying or eliminating sprouting in the produce. For example, the sprout suppressant may comprise a compound having a moiety that inhibits a biological pathway in the produce that normally leads to sprouting. In some embodiments, the sprout suppressant comprises a compound having a moiety that promotes a biological pathway in the produce that reduces or eliminates sprouting in the produce. As one non-limiting example, it is believed that having an alpha-beta-unsaturated carbonyl group (e.g., an alpha-beta-unsaturated ketone, an alpha-beta-unsaturated aldehydes) can contribute to a compound having sprout-suppressing properties. Examples of compounds described in this disclosure having an alpha-beta-unsaturated carbonyl group include carvone and citral.

In some embodiments, the active ingredient comprises thymol, hexanal, carvacrol, eugenol, eugenyl acetate, eucalyptol, menthol, farnesol, clove oil, lemongrass, limonene, and/or vanillin.

In some embodiments, the active ingredient comprises eugenol and/or eugenyl acetate. In some embodiments, the active ingredient comprises an essential oil comprising eugenol and/or eugenyl acetate. For example, the active ingredient may comprise clove oil.

In some embodiments, the active ingredient comprises jasmonic acid and/or methyl jasmonate. In some embodiments, the active ingredient comprises an essential oil comprising jasmonic acid and/or methyl jasmonate. For example, the active ingredient may comprise jasmine oil.

In some embodiments, the active ingredient comprises thymol. In some embodiments, the active ingredient comprises an essential oil comprising thymol. For example, the active ingredient may comprise thyme oil.

In some embodiments, the active ingredient comprises carvacrol. In some embodiments, the active ingredient comprises an essential oil comprising carvacrol. For example, the active ingredient may comprise oregano oil.

In some embodiments, the active ingredient comprises an organic acid and/or derivative thereof. For example, in some embodiments, the active ingredient comprises jasmonic acid and/or derivatives thereof. In some embodiments, the active ingredient comprises glyoxylic acid and/or derivatives thereof. A derivative of an acid species such as jasmonic acid or glyoxylic acid may be, for example, a conjugate base of the acid (e.g., jasmonate, glyoxylate) or an ester of the acid (e.g., methyl jasmonate, ethyl jasmonate, methyl glyoxylate, ethyl glyoxylate). Other non-limiting examples of organic acids (and their derivatives) for the active ingredient include fumaric acid; citric acid; sorbic acid; succinic acid; propionic acid; acetic acid, and combinations thereof.

In some embodiments, the active ingredient comprises an ester-derivative of an organic acid. For example, in some embodiments, the active ingredient comprises a formate ester such as an alkyl formate. In some such embodiments, the active ingredient comprises ethyl formate. In some embodiments, the active ingredient comprises an acetate ester such as an alkyl acetate. For example, the active ingredient may comprise ethyl acetate. In some embodiments, the active ingredient comprises a hormone. One example of a potential hormone used as an active ingredient is an insect hormone. One such example is a Lepidopteran hormone.

In some embodiments, the active ingredient is volatile. The volatility of a substance relates to the vapor pressure of the substance. In some embodiments, a volatile active ingredient has a vapor pressure of greater than or equal to 0.2 Pa, greater than or equal to 0.5 Pa, greater than or equal to 1 Pa, greater than or equal to about 2 Pa, greater than or equal to about 3 Pa, greater than or equal to about 5 Pa, greater than or equal to about 10 Pa, greater than or equal to about 15 Pa, and/or up to about 20 Pa, up to about 50 Pa, up to about 100 Pa, up to about 200 Pa, up to about 500 Pa, up to about 600 Pa, or greater at at least one temperature (e.g., from about 263 K to about 313 K from about 268 K to about 303 K, from about 272 K to about 288 K, or at about 293 K). In some embodiments, the active ingredient comprises a volatile organic compound (VOC). In some embodiments, the active ingredient comprises a mixture of different VOCs.

As mentioned above, in some embodiments the active ingredient comprises a volatile plant hormone. In some such embodiments, the volatile plant hormone comprises methyl salicylate; methyl jasmonate; (Z)-3hexenyl acetate; (z)-3-hexenal; (E)-beta-farnesene; (E)-beta-caryophyllene, (E)-beta-ocimene, Linalool, (E)-4,8-dimethyl-1,3,7-nonatriene; menthol; and/or (E,E)-4,8,12-trimethyl-1,3,7,11-tridecatetraene.

In some embodiments, the active ingredient comprises a cyclopropene. As used herein cyclopropene compounds are also referred to interchangeably as “cyclopropene” or “cyclopropenes”. Additionally, one or more cyclopropene compounds as used herein can mean one cyclopropene compound or more than one cyclopropene compound (e.g., two cyclopropene compounds, three cyclopropene compounds, or more). In some embodiments, cyclopropenes comprise organic compounds containing any unsubstituted or substituted three-carbon cyclic ring with an unsaturated or olefinic bond (of the root formula C₃Hₓ), or any organic compound containing a cyclopropene moiety. The simplest example of this class of molecules is cyclopropene, the simplest cycloalkene. The cyclopropene unit has a triangular structure. Cyclopropenes also include cyclopropene derivatives, such as 1-methylcyclopropene (1-MCP; molecular formula C₄H₆), or other cyclopropene derivatives (including, but not limited to borirenes, phosphirenes, and silirenes, which are boron-, phosphorus-, and silicon-substituted cyclopropenes respectively). In some embodiments, the active ingredient in the bed comprising the delivery material is 1-MCP.

As used herein, a cyclopropene compound, also referred to herein interchangeably as a cyclopropene or cyclopropenes, is any compound with the formula

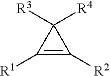

where each R¹, R², R³ and R⁴ is independently selected from the group consisting of H and a chemical group of the formula:

-(L)ₙ-Z,

where n is an integer from 0 to 12, each L is a bivalent radical, and Z is a monovalent radical. Non-limiting examples of L groups include radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (e.g., any one of R¹, R², R³ and R⁴) the total number of heteroatoms (e.g., atoms that are neither H nor C) is from 0 to 6. Independently, in any one R group the total number of non-hydrogen atoms is 50 or less. Non-limiting examples of Z groups are hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups may be independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and naphthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl. In another embodiment, R¹ is (C₁-C₄) alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.” In some embodiments, the active ingredient comprises an essential oil. In some embodiments, the active ingredient comprises a botanical extract. In some embodiments, the active ingredient is organic certified. In some embodiments, the active ingredient comprises a mixture of essential oils. In some embodiments, the essential oil has detectable concentrations of terpenes and/or terpenoids. In a non-limiting embodiment, an active ingredient comprises a terpene and/or a terpenoid. Non-limiting examples of terpenes include acyclic and cyclic terpenes, monoterpenes, diterpenes, oligoterpenes, and polyterpenes with any degree of substitution. In a non-limiting embodiment, an essential oil comprises at least one of a terpene, a terpenoid, or a phenolic compound (e.g., phenol, guaiacol). In an embodiment, the active ingredient comprises one or more of spearmint oil, caraway seed oil, dill seed oil, orange peel oil, mandarin orange peel oil, kuromoji oil, gingergrass oil, peppermint oil, clove oil, garlic oil, ruta chalepensis L. oil, eucalyptus oil, coriander oil, sagebrush oil, rosemary oil, muna oil, jasmine oil, methyl jasmonate, carvone, and rapeseed oil. In an embodiment, the active ingredient comprises carvone. In some embodiments, the active ingredient comprises carvone. For example, the active ingredient may comprise an essential oil comprising carvone. In an embodiment, the active ingredient is selected from the group consisting of spearmint oil, caraway seed oil, dill seed oil, orange peel oil, mandarin orange peel oil, kuromoji oil, gingergrass oil, peppermint oil, clove oil, garlic oil, ruta chalepensis L. oil, eucalyptus oil, coriander oil, sagebrush oil, rosemary oil, muna oil, methyl jasmonate, carvone, rapeseed oil, and combinations thereof. In some embodiments, the active ingredient comprises an essential oil comprising oregano oil; clove oil; lemongrass oil; peppermint oil; acacia oil; dill oil; neem oil; orange peel oil; lemon peel oil; rosemary oil; and/or thyme oil. As would be understood by one of ordinary skill in the art, in an embodiment where the active ingredient comprises essential oil(s), the weight percent of active ingredient in the delivery material is equivalent to the sum of the weight percentages of the essential oil active ingredients present in the delivery material.

In some embodiments, a flow of gaseous fluid (e.g., a gas such as air) is flowed through a porous and solid delivery material comprising a carbon material (e.g., activated carbon) associated with a cyclopropene (e.g., 1-MCP), thereby releasing an effluent stream (e.g., a gaseous effluent stream) comprising the cyclopropene. The delivery material comprising the carbon material may be particulate. In some embodiments, the delivery material is part of a bed fluidically connected to a pump. The pump may at least partially induce the flow of the gaseous fluid. The effluent stream may be released into an enclosure comprising an agricultural and/or a horticultural product. The flow of gaseous fluid may be at least partially controlled by a controller (e.g., a controller operatively coupled to a computer-implemented control system).

In some embodiments, a flow of gaseous fluid (e.g., a gas such as air) is flowed through a porous and solid delivery material comprising a carbon material (e.g., activated carbon) associated with an essential oil (e.g., spearmint oil, caraway oil, clove oil), thereby releasing an effluent stream (e.g., a gaseous effluent stream) comprising at least a component of the essential oil. The delivery material may be particulate. In some embodiments, the delivery material is part of a bed fluidically connected to a pump. The pump may at least partially induce the flow of the gaseous fluid. The effluent stream may be released into an enclosure comprising an agricultural and/or a horticultural product. The flow of gaseous fluid may be at least partially controlled by a controller (e.g., a controller operatively coupled to a computer-implemented control system).

In some embodiments, a flow of gaseous fluid (e.g., a gas such as air) is flowed through a porous and solid delivery material comprising a silicate material (e.g., silica) associated with a cyclopropene (e.g., 1-MCP), thereby releasing an effluent stream (e.g., a gaseous effluent stream) comprising the cyclopropene. The delivery material be particulate. In some embodiments, the delivery material is part of a bed fluidically connected to a pump. The pump may at least partially induce the flow of the gaseous fluid. The effluent stream may be released into an enclosure comprising an agricultural and/or a horticultural product. The flow of gaseous fluid may be at least partially controlled by a controller (e.g., a controller operatively coupled to a computer-implemented control system).

In some embodiments, a flow of gaseous fluid (e.g., a gas such as air) is flowed through a porous and solid delivery material comprising a silicate material (e.g., silica) associated with an essential oil (e.g., spearmint oil, caraway oil, clove oil), thereby releasing an effluent stream (e.g., a gaseous effluent stream) comprising at least a component of the essential oil. The delivery material may be particulate. In some embodiments, the delivery material is part of a bed fluidically connected to a pump. The pump may at least partially induce the flow of the gaseous fluid. The effluent stream may be released into an enclosure comprising an agricultural and/or a horticultural product. The flow of gaseous fluid may be at least partially controlled by a controller (e.g., a controller operatively coupled to a computer-implemented control system).

In some embodiments, the bed comprising the delivery material comprises a single active ingredient. In other embodiments, the bed comprises more than one active ingredient, for example, two active ingredients, three active ingredients, four active ingredients, or more. The bed may comprise any suitable amount of the active ingredient. In some cases, the active ingredient is present in the bed in at least about 0.01 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more, versus the total weight of the bed (e.g., the bed comprising the delivery material and the active ingredient). In other words, in non-limiting embodiments, the bed comprises active ingredient in a weight percent of at least about 0.01 wt %, at least about 0.05 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more, of the total weight of the bed (e.g., the bed comprising the delivery material and the active ingredient). In some embodiments, the active ingredient is present in the bed at between about 0.01 wt % and about 30 wt %, between about 0.05 wt % and about 30 wt %, between about 0.1 wt % and about 30 wt %, between about 0.5 wt % and about 30 wt %, between about 1 wt % and about 30 wt %, between about 1.5 wt % and about 30 wt %, between about 2 wt % and about 30 wt %, or between about 5 wt % and about 30 wt %, between about 0.01 wt % and about 15 wt %, between about 0.01 wt % and about 10 wt %, between about 0.01 wt % and about 5 wt %, between about 0.1 wt % and about 10 wt %, between about 0.1 wt % and about 5 wt %, between about 1 wt % and about 5 wt %, between about 1 wt % and about 10 wt %, between about 1 wt % and about 15 wt %, between about 2 wt % and about 10 wt %, between about 2 wt % and about 7 wt %, between about 5 wt % and about 10 wt % versus the total weight of the bed (e.g., the bed comprising the delivery material and the active ingredient).

In some embodiments, at least 50 wt %, at least 75 wt %, at least 90 wt %, at least 95 wt %, at least 98 wt %, at least 99 wt %, or more of the total active ingredients (by total weight of the active ingredients) associated with the delivery material (e.g., in the bed) have a biological effect (e.g., ethylene inhibition or promotion, pesticide effects, antimicrobial effects) on agricultural or horticultural products (e.g., plants, produce).

The weight percent of active ingredient present in material (e.g., bed comprising delivery material and the active ingredient) is determined by measuring the concentration of representative active ingredients of the bed using a solvent extraction method (e.g., a hexane extraction method, an ethyl acetate extraction method, an extraction method using a mixture of hexane and ethyl acetate, a methanol extraction method). In a non-limiting embodiment, solvent application for purposes of performing hexane extraction in order to measure the weight percent of active ingredient present versus the total weight of the bed is performed as follows. A known mass of the bed is placed in a vial (e.g., a 20 mL scintillation vial). A volume of 1.50 mL of hexane is added to the vial. The vial is then sealed and placed on a shaker table for 60 minutes. An aliquot of 1.0 μL of the hexane solution sample of active ingredient collected is then measured (e.g., using a gas chromatograph (GC)). The concentration (e.g., in mass per μL) of active ingredient as calculated from the GC measurement is then multiplied by the volume of solvent used for extraction (1.50 mL, as stated above) to get the total mass of active ingredient in the bed. The mass of active ingredient is then divided by the total mass of the bed sample previously placed in the vial to arrive at the weight percent of active ingredient in the bed. If more than one representative compound active ingredient is a component of the active ingredient, the weight percent of active ingredient present in the bed is equivalent to the sum of the weight percents of the representative active ingredients in the bed.

The area of the GC peak may be calibrated by comparison against an internal standard. In each instance, the flame ionization detector (FID) response of the GC instrument is calibrated by the injection of variable quantities of a known standard of the pure analyte and using methods understood to those skilled in the art. In some embodiments, the pure analyte is the representative active ingredient as discussed above.

In some embodiments, a delivery material is configured to release the active ingredient at a temperature. In this context, the temperature refers to the temperature of the area surrounding the site of release of the active ingredient. For example, in embodiments in which the active ingredient is released into an enclosure (e.g., comprising an agricultural and/or horticultural product), the temperature refers to an average temperature in that enclosure (e.g., as measured by one or more thermometers within the enclosure). The temperature at which the delivery material is configured to release the active ingredient may be measured, for example, placing a thermocouple in contact with fluid in the area surrounding the site of release of the active ingredient.

In some embodiments, the device (e.g., the delivery material) is configured to release the active ingredient at a temperature of greater than or equal to −80° C., greater than or equal to −20° C., greater than or equal to −2° C., greater than or equal to −1° C. greater than or equal to 0° C., greater than or equal to 2° C., greater than or equal to 4° C., greater than or equal to 10° C., greater than or equal to 15° C., greater than or equal to 20° C., or greater. In some embodiments, the device (e.g., the delivery material) is configured to release the active ingredient at a temperature of less than or equal to 50° C., less than or equal to 30° C., less than or equal to 25° C., less than or equal to 22° C., less than or equal to 20° C., less than or equal to 15° C., less than or equal to 13° C., less than or equal to 11° C., less than or equal to 10° C., less than or equal to 6° C., or less. Combinations of these ranges are possible. As one example, in some embodiments, the device (e.g., the delivery material) is configured to release the active ingredient at a temperature of greater than or equal to −80° C., and less than or equal to 50° C. For example, in some embodiments, the device (e.g., the delivery material) is configured to release the active ingredient at a temperature of greater than or equal to −2° C., and less than or equal to 50° C. As a more specific example, in some embodiments, the device (e.g., the delivery material) is configured to release the active ingredient at a temperature of greater than or equal to −2° C., and less than or equal to 30° C. As an even more specific example, in some embodiments, the device (e.g., the delivery material) is configured to release the active ingredient at a temperature of greater than or equal to 2° C., and less than or equal to 25° C. As yet an even more specific example, in some embodiments, the device (e.g., the delivery material) is configured to release the active ingredient at a temperature of greater than or equal to 2° C., and less than or equal to 6° C. As another example, in some embodiments, the device (e.g., the delivery material) is configured to release the active ingredient at a temperature of greater than or equal to −2° C., and less than or equal to 15° C. As another example, in some embodiments, the device (e.g., the delivery material) is configured to release the active ingredient at a temperature of greater than or equal to −1° C., and less than or equal to 13° C.

In some embodiments, the temperature of the delivery material (which, in this context, refers to the spatially averaged temperature of the delivery material) during the release of at least a portion (e.g., at least 10 wt %, at least 25 wt %, at least 50 wt %, at least 75 wt %, at least 85 wt %, at least 95 wt %, at least 99 wt %, or all) of the active ingredient is greater than or equal to −80° C., greater than or equal to −20° C., greater than or equal to −2° C., greater than or equal to −1° C. greater than or equal to 0° C., greater than or equal to 2° C., greater than or equal to 4° C., greater than or equal to 10° C., greater than or equal to 15° C., greater than or equal to 20° C., or greater. In some embodiments, the temperature of the delivery material during the release of at least a portion (e.g., at least 10 wt %, at least 25 wt %, at least 50 wt %, at least 75 wt %, at least 85 wt %, at least 95 wt %, at least 99 wt %, or all) of the active ingredient is less than or equal to 50° C., less than or equal to 30° C., less than or equal to 25° C., less than or equal to 22° C., less than or equal to 20° C., less than or equal to 15° C., less than or equal to 11° C., less than or equal to 10° C., less than or equal to 6° C., or less. Combinations of these ranges are possible (e.g., greater than or equal to −80° C. and less than or equal to 50° C.; greater than or equal to −2° C. and less than or equal to 50° C.; greater than or equal to −2° C. and less than or equal to 30° C.; greater than or equal to 2° C. and less than or equal to 25° C.; greater than or equal to 2° C. and less than or equal to 6° C.; greater than or equal to −2° C. and less than or equal to 15° C., greater than or equal to −1° C., and less than or equal to 13° C.).

The release of the active ingredient at low temperatures (e.g., temperatures greater than or equal to 2° C., and less than or equal to 6° C.) may provide a number of advantages. For example, in some embodiments, post-harvest agricultural and/or horticultural product s (e.g., produce) is best stored at temperatures greater than or equal to 2° C., and less than or equal to 6° C. A release rate of the active ingredient may be relatively low compared to a corresponding release rate at a higher temperature such as regular room temperature (e.g., around 22° C.), in some embodiments, at low temperatures. Therefore, accelerating release of the active ingredient, e.g., using a device or system described herein, may advantageously improve the delivery of the active ingredient within this temperature range.

In some embodiments, the active ingredient is released from the delivery material as an effluent stream. For example, a volatile active ingredient may be released from a delivery material into a flow of gaseous fluid directed past the delivery material (e.g., through a bed comprising the delivery material). In some embodiments, the effluent stream comprises the released active ingredient in the form of a gas. However, in some embodiments, the effluent stream comprises the active ingredient in a phase other than a gas phase. For example, the effluent stream may comprise the released active ingredient in a condensed phase of an aerosol (e.g., within liquid droplets or fine particles of the aerosol). In some embodiments, the stream comprises the released active ingredient in a supercritical fluid.

In some embodiments, the device is configured such that the effluent stream comprises the active ingredient in an amount that is greater than or equal to an amount of the active ingredient in the gaseous fluid that enters the bed comprising the delivery material. In some embodiments, a ratio of the concentration of the active ingredient in the effluent stream to the concentration of the active ingredient in the gaseous fluid that enters the bed is greater than or equal to 1, greater than or equal to 1.1, greater than or equal to 1.2, greater than or equal to 1.5, greater than or equal to 2, greater than or equal to 5, greater than or equal to 10, greater than or equal to 50, greater than or equal to 100, greater than or equal to 500, greater than or equal to 1,000, greater than or equal to 10,000, and/or up to 100,000 or more. Combinations of these ranges are possible.

When the device comprises a filter between the bed of the device and a housing outlet of the device, the filter may be chosen such that the effluent stream is transmitted through the filter, while the delivery material is retained within the bed. Depending on the embodiment, this may be an advantage for releasing the active ingredient in the form of a gaseous fluid. However, in some embodiments, filters are configured to permit the transmission of an aerosol while preventing transmission of the delivery material. This may be achieved, for example, using a filter that selectively blocks the transmission of particles or droplets based on size, and by using a delivery material comprising particles with an average particle size (e.g., average diameter) that is larger than an average particle size of the droplets or fine particles of the aerosol (e.g., by a factor of greater than or equal to 1.5×, greater than or equal to 2×, greater than or equal to 5×, greater than or equal to 10×, greater than or equal to 20×, greater than or equal to 50×, greater than or equal to 100×, or greater.

In some embodiments, the device or a component thereof (e.g., a pump) is configured to direct a flow of gaseous fluid. Any of a variety of appropriate types of gaseous fluid may be used. In some embodiments, the gaseous fluid comprises a gas. For example, the gaseous fluid may be a gas. The gas may comprise an inert gas, such as nitrogen, helium, and/or argon. In some embodiments, the gas is or comprises air. According to certain embodiments, the gas comprises an active ingredient, as described elsewhere herein. In some embodiments, the gaseous fluid comprises a supercritical fluid. The supercritical fluid may have a temperature and pressure above a thermodynamic critical point, such that it has intermediate characteristics of both gaseous and liquid phases. Examples of supercritical fluids include, but are not limited to, carbon dioxide above a temperature of 31° C. and a pressure of 7400 kPa, and water above a temperature of 374° C. and a pressure of 22100 kPa. In some embodiments, the gaseous fluid comprises a combination of a gas and a supercritical fluid. The gaseous fluid may comprise multiple different types of gases and/or supercritical fluids. For example, the gaseous fluid may comprise a mixture of gases.

The flow of gaseous fluid can have any of a variety of average linear velocities. Generally, the average linear velocity of a fluid is the linear velocity of the fluid, spatially averaged across a cross-sectional area across which the fluid flows. The average linear velocity may be sufficiently high to facilitate release of the active ingredient from the delivery material in the bed. In some embodiments, the flow of gaseous fluid has an average linear velocity (e.g., at the housing inlet and/or at the housing outlet) of greater than or equal to 0.1 m/s, greater than or equal to 0.2 m/s, greater than or equal to 0.3 m/s, greater than or equal to 0.6 m/s, greater than or equal to 1 m/s, greater than or equal to 2 m/s, greater than or equal to 3 m/s, greater than or equal to 6 m/s, or greater. In some embodiments, the flow of gaseous fluid has an average linear velocity (e.g., at the housing inlet and/or at the housing outlet) of less than or equal to 20 m/s, less than or equal to 10 m/s, less than or equal to 6 m/s, less than or equal to 3 m/s, less than or equal to 2 m/s, less than or equal to 1 m/s, or less. Combinations of these ranges are possible. For example, in some embodiments, the flow of gaseous fluid has an average linear velocity (e.g., at the housing inlet and/or at the housing outlet) of greater than or equal to 0.1 m/s, and less than or equal to 20 m/s. The average linear velocity may be measured by measuring a cross-sectional area and a volumetric flow rate (e.g., where the volumetric flow rate is measured by an in-line flow meter as described below) and dividing the volumetric flow rate by the cross-sectional area.

The flow of gaseous fluid can have any of a variety of maximum linear velocities. The maximum linear velocity may be sufficiently high to facilitate release of the active ingredient from the delivery material in the bed. In some embodiments, the flow of gaseous fluid has a maximum linear velocity (e.g., at the housing inlet and/or at the housing outlet) of greater than or equal to 0.1 m/s, greater than or equal to 0.2 m/s, greater than or equal to 0.3 m/s, greater than or equal to 0.6 m/s, greater than or equal to 1 m/s, greater than or equal to 2 m/s, greater than or equal to 3 m/s, greater than or equal to 6 m/s, greater than or equal to 12 m/s, or greater. In some embodiments, the flow of gaseous fluid has a maximum linear velocity (e.g., at the housing inlet and/or at the housing outlet) of less than or equal to 50 m/s, less than or equal to 20 m/s, less than or equal to 10 m/s, less than or equal to 6 m/s, less than or equal to 3 m/s, less than or equal to 2 m/s, less than or equal to 1 m/s, or less. Combinations of these ranges are possible. For example, in some embodiments, the flow of gaseous fluid has a maximum linear velocity (e.g., at the housing inlet and/or at the housing outlet) of greater than or equal to 0.1 m/s, and less than or equal to 50 m/s. The maximum linear velocity may be measured by using an anemometer, positioned at the center of the gaseous flow.

The flow of gaseous fluid can also have any of a variety of suitable volumetric flow rates. In some embodiments, the flow of gaseous fluid has a volumetric flow rate (e.g., at the housing inlet and/or at the housing outlet) of greater than or equal to 100 L/s, greater than or equal to 200 L/s, greater than or equal to 300 L/s, greater than or equal to 400 L/s, greater than or equal to 450 L/s, greater than or equal to 500 L/s, greater than or equal to 1,000 L/s, greater than or equal to 2000 L/s, greater than or equal to 5,000 L/s, or greater. In some embodiments, the flow of gaseous fluid has a volumetric flow rate (e.g., at the housing inlet and/or at the housing outlet) of less than or equal to 50,000 L/s, less than or equal to 20,000 L/s, less than or equal to 10,000 L/s, less than or equal to 5,000 L/s, less than or equal to 2,000 L/s, less than or equal to 1,000 L/s, less than or equal to 500 L/s, less than or equal to 450 L/s, less than or equal to 400 L/s, less than or equal to 300 L/s, or less. Combinations of these ranges are possible. For example, in some embodiments, the flow of gas has a volumetric flow rate (e.g., at the housing inlet and/or at the housing outlet) of greater than or equal to less than or equal to 100 L/s, and less than or equal to less than or equal to 50,000 L/s. The volumetric flow rate of a gas may be determined, for example, using an in-line flow meter.

In some embodiments, release of the active ingredient can be actuated by a controller. For example, a controller may be used to control a device or system as described elsewhere herein. In some embodiments, the pump can be actuated by the controller (e.g., the pump may be turned on, turned off, or adjusted). According to some embodiments, the controller can be operated according to a program. For example, one or more processors (e.g., of a computer-implemented control system) may be programmed to operate a controller to actuate the pump. As one example, one or more processors (e.g., of a computer-implemented control system) may be programmed to send signals at predetermined time intervals to a controller causing the controller to actuate the pump to increase a rate of directed gaseous fluid flow (e.g., by turning on the pump or accelerating action of the pump such as a rotation rate of a fan) and/or to decrease a rate of directed gaseous fluid flow (e.g., by turning off the pump or decelerating action of the pump such as a rotation rate of a fan). Such a process of actuating the pump may be useful for metering out active ingredient from the delivery material to treat agricultural and/or horticultural products (e.g., at discrete time intervals). As another example, one or more processors (e.g., of a computer-implemented control system) may be programmed to send signals for actuating the pump in response to receiving a signal (e.g., from a detector) indicating a measured parameter meeting or exceeding a predetermined threshold (e.g., a temperature reading in a housing and/or enclosure, a concentration of a certain species such as a gas measured in the housing and/or enclosure). For example, an enclosure (e.g., a storage container or room or a container of a vehicle such as refrigerated truck) may be equipped with a detector such as a thermometer or a gas detector (e.g., an oxygen sensor, a carbon dioxide sensor, an ethylene detector) operatively coupled to a computer-implemented control system. That control system may comprise one or more processors (e.g., via a wired connection or wireless). The one or more processors may be programmed (e.g., with a closed loop process) to adjust a setting of the pump to modulate a flow rate of gaseous fluid through the pump based in response to signals received from the detector to achieve a desired gaseous atmosphere in the container (e.g., a desired concentration of the active ingredient). In some such embodiments the detector is positioned among the agricultural and/or horticultural products (e.g., attached to a pallet containing the products). In some embodiments the detector is integrated with the enclosure (e.g., affixed to a surface of the enclosure).

In some embodiments, the controller may be operated by a user (e.g., using a wired input device or an input device wirelessly coupled to the controller). For example, the system may be placed in a closed room, the user may leave the room, and then the user may begin release of the active ingredient by activating the system via a remotely controlled user interface (which may be wired or wireless). For example, the controller may be operated by a program of one or more processors of a computer-implemented control system configured to convert input from a user into a signal that is sent to the controller and, based on that input, actuate the pump. The actuation signal may increase or decrease a flow rate of gaseous fluid (e.g., by turning the pump on/off or by accelerating/decelerating the pump via movement of valves or modulate of a rotation rate of a motor), depending on, for example, a magnitude or sign of the signal.

As described above, certain embodiments of the inventive systems and/or methods include one or more processors, for example, associated with the pump or another component of the release system. The one or more processors may be associated with or part of a controlled release system. For example, the one or more processors may be programmed to send a signal to actuate a pump at an appropriate level to cause a flow rate of directed gaseous fluid through a bed comprising a delivery material and active ingredient sufficient to maintain a specified release rate and/or duration of release of the active ingredient from the bed based on pre-programmed and/or dynamically-updated parameters that can include, but are not limited to the type of active ingredient, the type of delivery material, the size and/or loading of the bed, the temperature, and/or the humidity. The processor may be part of, according to certain embodiments, a computer-implemented control system. The computer-implemented control system can be used to operate various components of the system. In general, any calculation methods, steps, simulations, algorithms, systems, and system elements described herein may be implemented and/or controlled using one or more computer-implemented control system(s), such as the various embodiments of computer-implemented systems described below. The methods, steps, control systems, and control system elements described herein are not limited in their implementation to any specific computer system described herein, as many other different machines may be used.

The computer-implemented control system can be part of or coupled in operative association with one or more articles (e.g., pumps) and/or other system components that might be automated, and, in some embodiments, is configured and/or programmed to control and adjust operational parameters, as well as analyze and calculate values, for example any of the values described above. In some embodiments, the computer-implemented control system(s) can send and receive reference signals to set and/or control operating parameters of system apparatus. In other embodiments, the computer-implemented system(s) can be separate from and/or remotely located with respect to the other system components and may be configured to receive data from one or more inventive systems via indirect and/or portable means, such as via portable electronic data storage devices, such as magnetic disks, or via communication over a computer network, such as the Internet or a local intranet.

The computer-implemented control system(s) may include several known components and circuitry, including a processor, a memory system, input and output devices and interfaces (e.g., an interconnection mechanism), as well as other components, such as transport circuitry (e.g., one or more busses), a video and audio data input/output (I/O) subsystem, special-purpose hardware, as well as other components and circuitry, as described below in more detail. Further, the computer system(s) may be a multi-processor computer system or may include multiple computers connected over a computer network.

The computer-implemented control system(s) may include a processor, for example, a commercially available processor such as one of the series x86; Celeron, Pentium, and Core processors, available from Intel; similar devices from AMD and Cyrix; the 680×0 series microprocessors available from Motorola; and the PowerPC microprocessor from IBM. Many other processors are available, and the computer system is not limited to a particular processor.

A processor typically executes a program called an operating system, of which WindowsNT, Windows95 or 98, Windows XP, Windows Vista, Windows 7, Windows 10, UNIX, Linux, DOS, VMS, MacOS, OS8, and OS X are examples, which controls the execution of other computer programs and provides scheduling, debugging, input/output control, accounting, compilation, storage assignment, data management and memory management, communication control and related services. The processor and operating system together define, in accordance with certain embodiments, a computer platform for which application programs in high-level programming languages are written. The computer-implemented control system is not limited to a particular computer platform. In accordance with certain embodiments, the processor generally manipulates the data within the integrated circuit memory element in accordance with the program instructions and then copies the manipulated data to the non-volatile recording medium after processing is completed. A variety of mechanisms are known for managing data movement between the non-volatile recording medium and the integrated circuit memory element, and the computer-implemented control system(s) that implements the methods, steps, systems control and system elements control described above is not limited thereto. The computer-implemented control system(s) is not limited to a particular memory system.

At least part of such a memory system described above may be used to store one or more data structures (e.g., look-up tables) or equations such as calibration curve equations. For example, at least part of the non-volatile recording medium may store at least part of a database that includes one or more of such data structures. Such a database may be any of a variety of types of databases, for example, a file system including one or more flat-file data structures where data is organized into data units separated by delimiters, a relational database where data is organized into data units stored in tables, an object-oriented database where data is organized into data units stored as objects, another type of database, or any combination thereof.

It should be appreciated that one or more of any type of computer-implemented control system may be used to implement various embodiments described herein. Aspects of the invention may be implemented in software, hardware or firmware, or any combination thereof. The computer-implemented control system(s) may include specially programmed, special purpose hardware, for example, an application-specific integrated circuit (ASIC). Such special-purpose hardware may be configured to implement one or more of the methods, steps, algorithms, systems control, and/or system elements control described above as part of the computer-implemented control system(s) described above or as an independent component.

The computer-implemented control system(s) and components thereof may be programmable using any of a variety of one or more suitable computer programming languages. In addition, the methods, steps, algorithms, systems control, and/or system elements control may be implemented using any of a variety of suitable programming languages. Such languages may include procedural programming languages, for example, LabView, C, Pascal, Fortran, and BASIC, object-oriented languages, for example, C++, Java, and Eiffel, and other languages, such as a scripting language or even assembly language. In some embodiments, the computer programming language is Python. In some embodiments, the computer programming language is SQL. Such methods, steps, algorithms, systems control, and/or system elements control, either individually or in combination, may be implemented as a computer program product tangibly embodied as computer-readable signals on a computer-readable medium, for example, a non-volatile recording medium, an integrated circuit memory element, or a combination thereof. For each such method, step, simulation, algorithm, system control, or system element control, such a computer program product may comprise computer-readable signals tangibly embodied on the computer-readable medium that define instructions, for example, as part of one or more programs, that, as a result of being executed by a computer, instruct the computer to perform the method, step, algorithm, system control, and/or system element control.

The following publications are incorporated herein by reference in their entirety for all purposes: U.S. Patent Application Publication No. US-2019-0037839 published on Feb. 8, 2019 and entitled “Compositions for Controlled Release of Active Ingredients and Methods of Making Same”, and International Patent Application Publication No. WO2017/143311 published on Aug. 24, 2017 and entitled “Compositions for Controlled Release of Active Ingredients and Methods of Making Same.”

U.S. Provisional Patent Application No. 63/189,027, filed May 14, 2021 and entitled “Systems and Methods for Dispersing Active Ingredients” is incorporated herein by reference in its entirety for all purposes.

The following examples are intended to illustrate certain embodiments of the present invention, but do not exemplify the full scope of the invention.

### Example 1

This example describes release of an active ingredient into an enclosure using a device and system as described in this disclosure. Specifically, gaseous 1-MCP buildup and retention in an enclosure in the form of a sealed apple room was compared to buildup and retention in an unsealed apple storage room.

A pump in the form of a 20″×20″ box fan was placed inside of a 33,264 cubic foot apple storage room kept at a temperature between 2-6° C., with the fan facing up and elevated several inches from the ground to allow space for air to enter the fan from below. The device was assembled by placing a metal air filter housing and a 20″×20″ air filter (Nordic Pure® Part 20201.8-3) on top of the fan, to which was added a 0.5 kg bed of a particulate delivery material in the form of activated carbon powder associated with an activate ingredient in the form of 1-MCP. Another identical 20″×20″ air filter was placed on top of the 1-MCP-loaded activated carbon and secured with a clamp. The apple storage room was vacated by the user and sealed before the fan was turned on. At the same time, in an adjacent, identical apple storage room, a second, identical device described above was set up with 0.5 kg bed of activated carbon powder associated with 1-MCP. Before the fan was turned on in this second room, a small 20″×20″ portal door into the room was taped in an open position in order to keep the second room unsealed so as to simulate a faulty seal or leaky room. The fan was left running in both the sealed and unsealed apple storage rooms overnight, and 1-MCP levels were observed in the atmosphere of each room using a calibrated volatile organic compound detector making use of a C₂H₄ sensor. The C₂H₄ sensor was calibrated for 1-MCP by comparison with gas chromatography readings, and reported values in millivolts which were subtracted from baseline readings for the detector and then converted via the calibration curve to concentration measurements. The detector reported a value every minute, permitting graphing of concentrations over time and calculation of release rates of 1-MCP using slopes at the beginning of release.

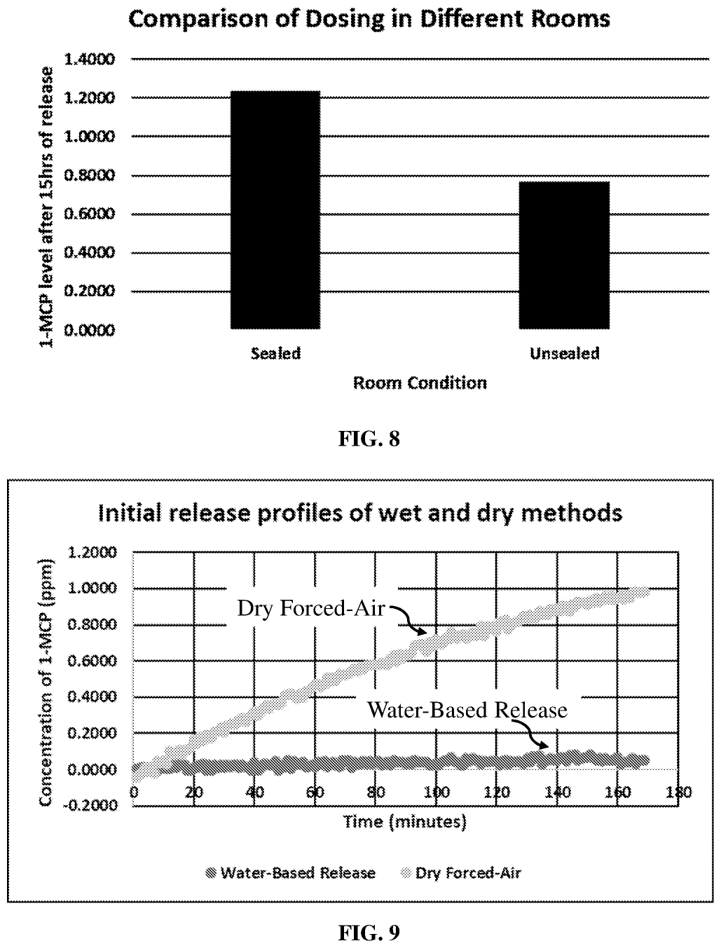

FIG. 8 shows the measured 1-MCP in the sealed apple storage room and the unsealed apple storage room after 15 hours of running the fans. While the sealed room maintained a greater 1-MCP level, the unsealed room maintained a significant level of 1-MCP, demonstrating that release of active ingredients using the directed gaseous fluid flow devices and methods of this disclosure can at least in some instances allow for suitable 1-MCP levels even with leaky enclosures. This is not generally observed with certain other techniques for releasing volatile active ingredients into enclosures, such as water-based release techniques.

### Example 2

This example describes a comparison of active ingredient release profiles and rates using a device and system of this disclosure as compared to an existing technique. Specifically, gaseous 1-MCP release via pump-driven gaseous fluid flow was compared to water-based release of 1-MCP.

A pump in the form of a duct fan was placed inside of a 30,624 cubic foot apple storage room kept between 2-6° C. The fan was placed facing up onto two iron bars to allow space for air to enter below the fan. The device was assembled by placing a 12″ mesh sieve on top of the duct fan, to which was added a 1 kg bed of a particulate delivery material in the form of activated carbon powder associated with an activated ingredient in the form of 1-MCP. The sieve and delivery material was then contained by placing a pair of nylon stockings over the opening of the sieve and sealing it all with duct tape. The room was vacated by the user and sealed before the fan was turned on. When the air flow began, the concentration of 1-MCP in the sealed apple storage room was observed to increase by measurements from the detector making use of the C₂H₄ sensor described in Example 1. At the same time, a comparative experiment was performed by placing, in an adjacent identical apple storage room, a bucket containing 12 L of distilled water and 4 aerators (each of which produced 0.024 cubic feet per min, 0.096 cubic feet per minute total). The aerators in the bucket were turned on and 1 kg of the same activated carbon delivery material associated with 1-MCP was placed in the bucket. The room was then vacated by the user and sealed while the 1-MCP was released. The 1-MCP levels in the sealed apple storage room for the second, comparative experiment was measured in the same manner as described above.

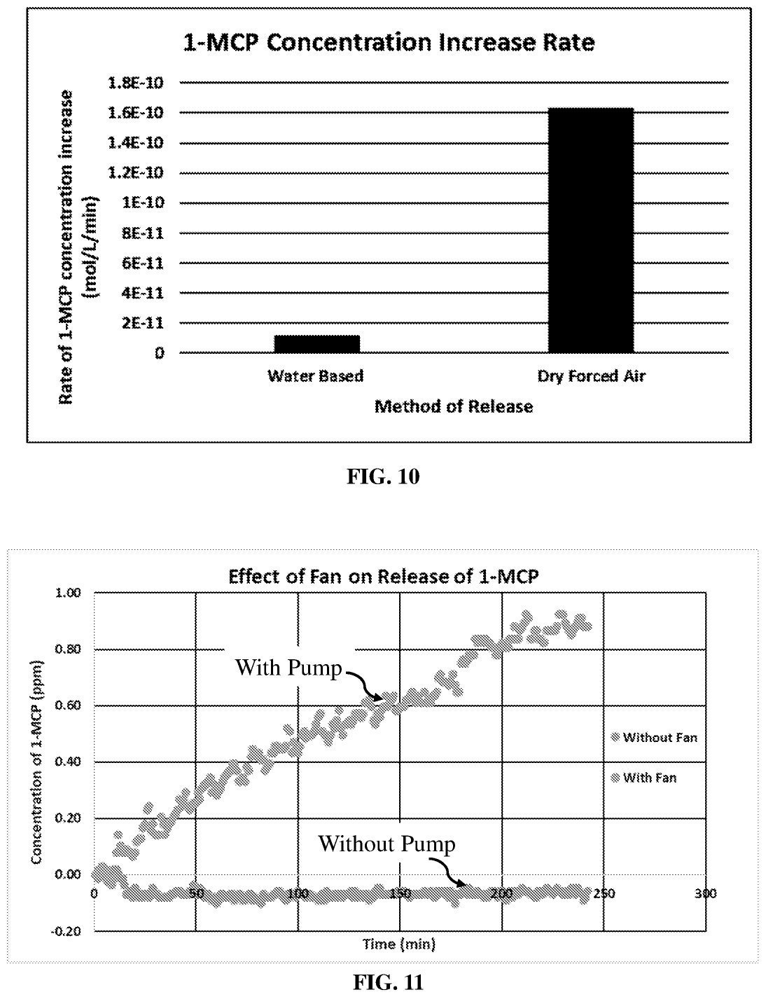

FIG. 9 shows a plot of the 1-MCP release profiles measured over the first 170 minutes for the method employing the duct fan (“dry forced-air” release method) and for the water-based release method. FIG. 10 shows a plot of the rate of increase of 1-MCP concentration in mol/L/min for the dry forced-air release method and the water-based release method. The rate of increase was calculated by taking the initial slope of the concentration profiles shown in FIG. 9. The results of this experiment demonstrate a significantly increased (16-fold) rate of release for the dry forced-air release method using the device comprising the duct fan pump compared to water-based release, with sustained release of 1-MCP past 170 minutes.

### Example 3

This example describes the effect of directing gaseous fluid flow through a delivery material on the rate of release of active ingredients. Specifically, gaseous 1-MCP release via pump-driven gas flow was compared to release in the absence of pump-driven flow.

A pump in the form of a 20″×20″ box fan was placed inside of a 33,264 cubic foot apple storage room kept at a temperature between 2-6° C., with the fan facing up and elevated several inches from the ground to allow space for air to enter the fan from below. The device was assembled by placing a metal air filter housing and a 20″×20″ air filter (Nordic Pure® Part 20201.8-3) on top of the fan, to which was added a 0.5 kg bed of a particulate delivery material in the form of activated carbon powder associated with an activated ingredient in the form of 1-MCP. Another identical 20″×20″ air filter was placed on top of the 1-MCP-loaded activated carbon and secured with a clamp. The apple storage room was vacated by the user and sealed before the fan was turned on. At the same time, in an adjacent, identical apple storage room, a second, identical device described above was set up with a 0.5 kg bed of activated carbon powder associated with 1-MCP. However, the fan of this second device was not turned on. The fan in the first sealed apple storage room was left running overnight, and 1-MCP levels were observed in the atmosphere of each room using measurements from the detector making use of the C₂H₄ sensor described in Example 1.

FIG. 11 shows a plot of the 1-MCP release profiles measured over the first 240 minutes for the room in which the box fan was turned on (“With Pump”) and for the room in which the box fan was not turned on (“Without Pump”). The results demonstrate that 1-MCP was released at a greater rate and in greater amounts when the pump was used to flow gas through the bed of the delivery material compared to when no pump was used under otherwise identical conditions.

### Example 4

This example describes the release rate of an active ingredient from a delivery material as a function of gaseous fluid flow rate through the delivery material. Specifically, the rate of gaseous 1-MCP release via pump-driven air flow was measured as a function of the air flow rate.

In a sealed apple storage room of approximately 30,000 cubic feet, 0.5 kg of a particulate delivery material in the form of activated carbon powder associated with an activated ingredient in the form of 1-MCP was held in front of pumps in the form of fans with known air speeds for greater than 2 hours each. The fan type and geometry was varied to access various air speeds. The concentration of 1-MCP in the atmosphere of the sealed apple storage room was monitored using measurements from a detector making use of the C₂H₄ sensor described in Example 1, and release rates were calculated at five different air speeds, as well as at a flow rate of 0 m/s.

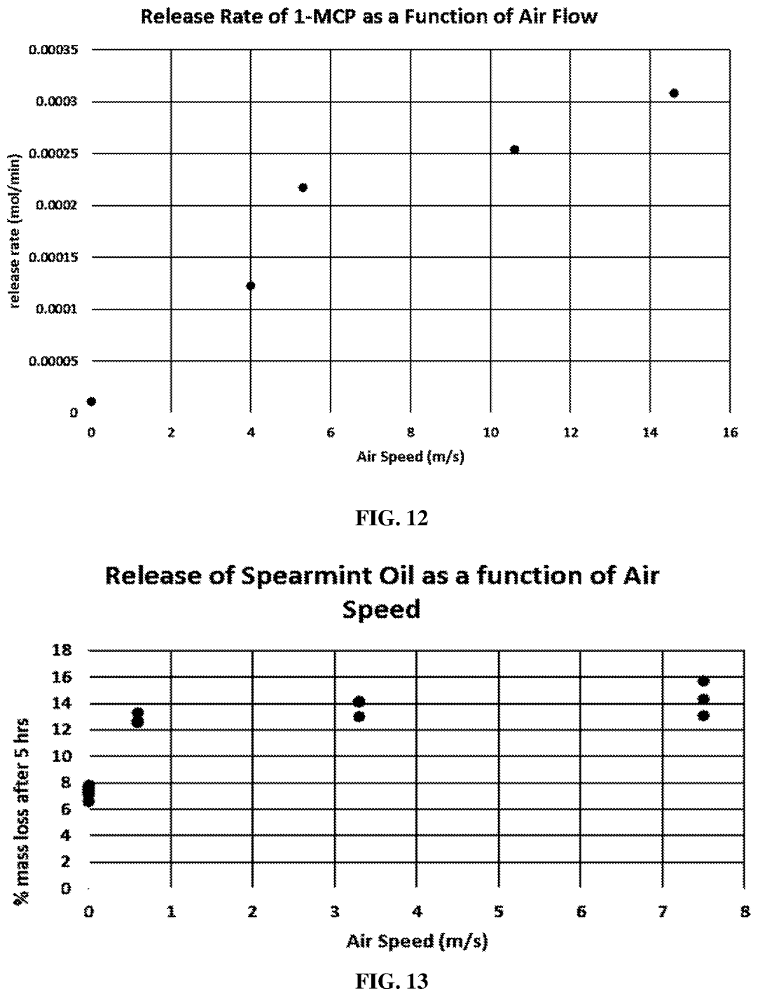

FIG. 12 shows a plot of the 1-MCP release rate as a function of air speed. The results demonstrate that the 1-MCP was released from the activated carbon powder at a greater rate when faster air speeds were used.

### Example 5

This example describes the release rate of an active ingredient from a delivery material as a function of gaseous fluid flow rate through the delivery material. Specifically, the rate of spearmint oil release via pump-driven air flow was measured as a function of the air flow rate.

A particulate delivery material in the form of activated carbon associated with spearmint oil was exposed to air flow at a temperature of 22° C. at various air speeds ranging from still air (0 m/s) to a strong fan (7.5 m/s). The mass was measured before and after air exposure for 5 hours to determine the loss of spearmint oil from the sample.

FIG. 13 shows a plot of the percent mass loss of spearmint oil from the delivery material as a function of air speed. The plot shows that there was some release of spearmint oil material in still air, but even a small increase of air flow was enough to greatly increase the amount of spearmint oil released after 5 hours. The amount of spearmint oil released was relatively insensitive to increased air flow beyond 0.5 m/s.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage. Unless clearly indicated to the contrary, concentrations and percentages described herein are on a mass basis.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A device, comprising:
a housing, comprising:
a housing inlet;
a housing outlet; and
an internal volume containing a bed comprising a particulate delivery material and an active ingredient, the internal volume being between the housing inlet and the housing outlet; and
a pump comprising a pump outlet, the pump outlet fluidically connected to the housing inlet, wherein the pump is configured to direct a flow of gaseous fluid into the housing inlet, through the internal volume, and out of the housing outlet.

2. A device, comprising:
a bed comprising a delivery material and an active ingredient; and
a pump fluidically connected to the bed, wherein the pump is configured to direct a flow of gaseous fluid through the bed.

3. A device, comprising:
a housing, comprising:
a housing inlet;
a housing outlet; and
an internal volume configured to receive a bed comprising a delivery material and an active ingredient, the internal volume being between the housing inlet and the housing outlet;
a pump comprising a pump outlet, the pump outlet fluidically connected to the housing inlet; and
a filter between the internal volume and the housing outlet and/or operatively coupled to the housing outlet;
wherein the pump is configured to direct a flow of gaseous fluid into the housing inlet, through the internal volume, and out of the housing outlet.

4. A device, comprising:
a housing, comprising:
a housing inlet;
a housing outlet; and
an internal volume configured to receive a bed comprising at least 1 g of a delivery material and an active ingredient, the internal volume being between the housing inlet and the housing outlet; and
a pump comprising a pump outlet, the pump outlet fluidically connected to the housing inlet;
wherein the pump is configured to direct a flow of gaseous fluid into the housing inlet, through the internal volume, and out of the housing outlet.

5. The device of any one of claims 1-4, wherein the flow of gaseous fluid has a volumetric flow rate of greater than or equal to 100 L/s at the housing outlet.

6. The device of any one of claims 1-5, wherein the flow of gaseous fluid has an average linear velocity of greater than or equal to 0.1 m/s at the housing outlet.

7. The device of any one of claims 1, 3, and 5-6, wherein the internal volume is configured to receive at least 1 g of the delivery material.

8. The device of any one of claims 3-7, wherein the pump is configured to direct the flow of gaseous fluid into the housing inlet after the device has received the bed.

9. The device of any one of claims 1 and 3-8, wherein the housing has a maximum lateral dimension greater than or equal to 0.2 m.

10. The device of any one of claims 1 and 4-9, further comprising a filter between the internal volume and the housing outlet and/or operatively coupled to the housing outlet

11. The device of any one of claims 1 and 3-10, further comprising a filter between the internal volume and the pump.

12. The device of any one of claims 1 and 4-11, further comprising a filter between the internal volume and the housing inlet.

13. The device of any one of claims 1 and 3-12, wherein the housing inlet and the housing outlet are fluidically connected to an internal volume of an enclosure.

14. The device of claim 13, wherein the device and the enclosure together are configured to retain at least 95 mol % of a released active ingredient for a period of at least 1 hour.

15. The device of any one of claims 13-14, wherein the device and the enclosure together are configured to retain the active ingredient at an equilibrium vapor concentration.

16. The device of any one of claims 13-15, wherein the device is at least partially contained within the internal volume of the enclosure.

17. The device of any one of claims 13-16, wherein the device is fully contained within the internal volume of the enclosure.

18. The device of any one of claims 13-15, wherein the device is external to the internal volume of the enclosure.

19. The device of any one of claims 13-18, wherein the housing inlet and/or the housing outlet are fluidically connected to the enclosure via a conduit.

20. The device of any one of claims 1 and 3-19, wherein the pump is between the housing inlet and the housing outlet.

21. The device of any one of claims 1-20, wherein the pump comprises a fan.

22. The device of any one of claims 1 and 4-21, wherein the filter is between the internal volume and the housing outlet.

23. The device of any one of claims 3 and 10-22, wherein the filter is operatively coupled to the housing outlet.

24. The device of any one of claims 1-23, wherein the gaseous fluid comprises a gas.

25. The device of any one of claims 1-24, wherein the gaseous fluid is a gas.

26. The device of any one of claims 1-24, wherein the gaseous fluid comprises a supercritical fluid.

27. The device of any one of claims 1-26, wherein the active ingredient is configured to be released at a temperature of greater than or equal to −2° C. and less than or equal to 50° C.

28. The device of any one of claims 1-27, wherein the active ingredient comprises a cyclopropene.

29. The device of any one of claims 1-28, wherein the active ingredient comprises 1-MCP.

30. The device of any one of claims 1-29, wherein the delivery material comprises a carbon material.

31. The device of any one of claims 1-30, wherein the delivery material comprises activated carbon.

32. The device of any one of claims 1-31, wherein the delivery material is activated carbon.

33. The device of any one of claims 1-32, wherein the delivery material is particulate.

34. The device of any one of claims 1-33, wherein the active ingredient is configured to be released at a temperature of greater than or equal to −2° C. and less than or equal to 15° C.

35. The device of any one of claims 1-34, wherein the active ingredient is configured to be released at a temperature of greater than or equal to −2° C. and less than or equal to 6° C.

36. The device of any one of claims 1-35, wherein the active ingredient comprises at least one of: an ethylene inhibitor; an inhibitor of ethylene biosynthesis; an inhibitor of a fruit and vegetable membrane degrading phospholipase; a sprout suppressant; an organic acid; a derivative of an organic acid; an ester-derivative of an organic acid; a volatile plant hormone; an essential oil; a terpene; a terpenoid; a mint extract; a phenolic compound; hydrogen peroxide; hexanal; a Fenugreek extract; an ethylene promoter; a plant growth regulator; a biopesticide; a phospholipase-D inhibitor; an antimicrobial; an antifungal; an antibacterial; an antiviral; thymol; hexanal; carvacrol; eugenol; eugenyl acetate; eucalyptol; menthol; farnesol; clove oil; lemongrass; limonene; and/or vanillin.

37. The device of any one of claims 1-36, wherein the active ingredient comprises an ethylene inhibitor.

38. The device of any one of claims 1-37, wherein the active ingredient comprises an inhibitor of a fruit and vegetable membrane degrading phospholipase, and wherein the inhibitor of a fruit and vegetable membrane degrading phospholipase comprises N-(2-chloro-4-pyrridinyl)N-phenyl urea.

39. The device of any one of claims 1-38, wherein the active ingredient comprises a sprout suppressant, and wherein the sprout suppressant comprises at least one of: an essential oil; carvone; isopropyl-N-(3-chlorophenyl) carbamate; 3-decen-2-one; 1,4-dimethylnaphthalene; and/or citral.

40. The device of any one of claims 1-39, wherein the active ingredient comprises an organic acid, and wherein the organic acid comprises at least one of: jasmonic acid; glyoxylic acid; fumaric acid; citric acid; sorbic acid; succinic acid; propionic acid; and/or acetic acid.

41. The device of any one of claims 1-40, wherein the active ingredient comprises an organic acid derivative, and wherein the organic acid derivative comprises at least one of: jasmonate; glyoxylate; methyl jasmonate; ethyl jasmonate; methyl glyoxylate; and/or ethyl glyoxylate.

42. The device of any one of claims 1-41, wherein the active ingredient comprises an ester-derivative of an organic acid, and wherein the ester-derivative of the organic acid comprises an alkyl formate.

43. The device of any one of claims 1-42, wherein the active ingredient comprises a volatile plant hormone, and wherein the volatile plant hormone comprises at least one of: methyl salicylate; methyl jasmonate; (Z)-3hexenyl acetate; (z)-3-hexenal; (E)-beta-farnesene; (E)-beta-caryophyllene, (E)-beta-ocimene, Linalool, (E)-4,8-dimethyl-1,3,7-nonatriene; menthol; and/or (E,E)-4,8,12-trimethyl-1,3,7,11-tridecatetraene.

44. The device of any one of claims 1-43, wherein the active ingredient comprises an essential oil, and wherein the essential oil comprises at least one of: a terpene; a terpenoid; a phenolic compound; oregano oil; clove oil; lemongrass oil; peppermint oil; acacia oil; dill oil; neem oil; orange peel oil; lemon peel oil; rosemary oil; thyme oil; spearmint oil; caraway seed oil; dill seed oil; orange peel oil; mandarin orange peel oil; kuromoji oil; gingergrass oil; peppermint oil; clove oil; garlic oil; Ruta chalepensis L. oil; eucalyptus oil; coriander oil; sagebrush oil; rosemary oil; muna oil; jasmine oil; methyl jasmonate; and/or rapeseed oil.

45. The device of any one of claims 1-44, wherein the active ingredient comprises a terpene, and wherein the terpene comprises at least one of: an acyclic terpene; a cyclic terpene; a monoterpene; a diterpene; an oligoterpene; and/or a polyterpene.

46. The device of any one of claims 1-45, wherein the active ingredient comprises carvacrol.

47. The device of any one of claims 1-46, wherein the active ingredient comprises limonene.

48. The device of any one of claims 1-47, wherein the active ingredient comprises ethyl formate.

49. The device of any one of claims 1-48, wherein the active ingredient comprises spearmint oil.

50. The device of any one of claims 1-49, wherein the active ingredient comprises carvone.

51. The device of any one of claims 1-50, wherein the delivery material comprises a silicate material.

52. The device of any one of claims 1-51, wherein the delivery material comprises silica.

53. The device of any one of claims 1-52, wherein the pump comprises a compressed gas cylinder.

54. The device of any one of claims 1 and 3-53, wherein the pump outlet is in fluidic communication with the housing inlet.

55. A system, comprising the device of any one of claims 1-54 at least partially within an enclosure.

56. The system of claim 55, wherein the bed is within the enclosure.

57. The system of any one of claims 55-56, wherein the pump is within the enclosure.

58. The system of any one of claims 55-57, wherein the enclosure is a refrigerated enclosure.

59. The system of any one of claims 55-58, wherein the bed comprises one or more sachets comprising the delivery material and the active ingredient.

60. The system of any one of claims 1-59, wherein the pump is part of a refrigeration unit

61. The system of any one of claims 55-60, wherein the enclosure is part of or configured to be part of a vehicle.

62. An article for release of an active ingredient, the article comprising:
a container comprising a container inlet, a container outlet, and an internal volume; and
a delivery material present in a quantity of at least 1 g within the internal volume of the container;
wherein the active ingredient is associated with the delivery material.

63. An article for release of an active ingredient, the article comprising:
a container comprising a container inlet, a container outlet, and an internal volume;
a delivery material within the internal volume of the container; and
a filter configured to prevent the transmission of the delivery material through at least a portion of the container;
wherein the active ingredient is associated with the delivery material.

64. The article of any one of claims 62-63, wherein the article has a maximum lateral dimension greater than or equal to 0.2 m.

65. The article of any one of claims 62-64, wherein the article is configured to be received into an internal volume of a device that comprises a pump configured to direct a flow of gaseous fluid through the container, thereby releasing an effluent stream comprising the active ingredient from the delivery material.

66. The article of any one of claims 62-65, wherein the delivery material is contained within one or more sachets.

67. The article of any one of claims 62-66, wherein the delivery material is particulate.

68. The article of any one of claims 62-67, wherein the delivery material is solid and porous.

69. The article of any one of claims 62-68, wherein the active ingredient is configured to be released at a temperature of greater than or equal to −2° C. and less than or equal to 50° C.

70. The article of any one of claims 62-69, wherein the active ingredient comprises a cyclopropene.

71. The article of any one of claims 62-70, wherein the active ingredient comprises 1-MCP.

72. The article of any one of claims 62-71, wherein the delivery material comprises a carbon material.

73. The article of any one of claims 62-72, wherein the delivery material comprises activated carbon.

74. The article of any one of claims 62-73, wherein the delivery material is activated carbon.

75. The article of any one of claims 62-74, wherein the active ingredient is configured to be released at a temperature of greater than or equal to −2° C. and less than or equal to 15° C.

76. The article of any one of claims 62-75, wherein the active ingredient is configured to be released at a temperature of greater than or equal to −2° C. and less than or equal to 6° C.

77. The article of any one of claims 62-76, wherein the active ingredient comprises at least one of: an ethylene inhibitor; an inhibitor of ethylene biosynthesis; an inhibitor of a fruit and vegetable membrane degrading phospholipase; a sprout suppressant; an organic acid; a derivative of an organic acid; an ester-derivative of an organic acid; a volatile plant hormone; an essential oil; a terpene; a terpenoid; a mint extract; a phenolic compound; hydrogen peroxide; hexanal; a Fenugreek extract; an ethylene promoter; a plant growth regulator; a biopesticide; a phospholipase-D inhibitor; an antimicrobial; an antifungal; an antibacterial; an antiviral; thymol; hexanal; carvacrol; eugenol; eugenyl acetate; eucalyptol; menthol; farnesol; clove oil; lemongrass; limonene; and/or vanillin.

78. The article of any one of claims 62-77, wherein the active ingredient comprises an ethylene inhibitor.

79. The article of any one of claims 62-78, wherein the active ingredient comprises an inhibitor of a fruit and vegetable membrane degrading phospholipase, and wherein the inhibitor of a fruit and vegetable membrane degrading phospholipase comprises N-(2-chloro-4-pyrridinyl)N-phenyl urea.

80. The article of any one of claims 62-79, wherein the active ingredient comprises a sprout suppressant, and wherein the sprout suppressant comprises at least one of: an essential oil; carvone; isopropyl-N-(3-chlorophenyl) carbamate; 3-decen-2-one; 1,4-dimethylnaphthalene; and/or citral.

81. The article of any one of claims 62-80, wherein the active ingredient comprises an organic acid, and wherein the organic acid comprises at least one of: jasmonic acid; glyoxylic acid; fumaric acid; citric acid; sorbic acid; succinic acid; propionic acid; and/or acetic acid.

82. The article of any one of claims 62-81, wherein the active ingredient comprises an organic acid derivative, and wherein the organic acid derivative comprises at least one of: jasmonate; glyoxylate; methyl jasmonate; ethyl jasmonate; methyl glyoxylate; and/or ethyl glyoxylate.

83. The article of any one of claims 62-82, wherein the active ingredient comprises an ester-derivative of an organic acid, and wherein the ester-derivative of the organic acid comprises an alkyl formate.

84. The article of any one of claims 62-83, wherein the active ingredient comprises a volatile plant hormone, and wherein the volatile plant hormone comprises at least one of: methyl salicylate; methyl jasmonate; (Z)-3hexenyl acetate; (z)-3-hexenal; (E)-beta-farnesene; (E)-beta-caryophyllene, (E)-beta-ocimene, Linalool, (E)-4,8-dimethyl-1,3,7-nonatriene; menthol; and/or (E,E)-4,8,12-trimethyl-1,3,7,11-tridecatetraene.

85. The article of any one of claims 62-84, wherein the active ingredient comprises an essential oil, and wherein the essential oil comprises at least one of: a terpene; a terpenoid; a phenolic compound; oregano oil; clove oil; lemongrass oil; peppermint oil; acacia oil; dill oil; neem oil; orange peel oil; lemon peel oil; rosemary oil; thyme oil; spearmint oil; caraway seed oil; dill seed oil; orange peel oil; mandarin orange peel oil; kuromoji oil; gingergrass oil; peppermint oil; clove oil; garlic oil; Ruta chalepensis L. oil; eucalyptus oil; coriander oil; sagebrush oil; rosemary oil; muna oil; jasmine oil; methyl jasmonate; and/or rapeseed oil.

86. The article of any one of claims 62-85, wherein the active ingredient comprises a terpene, and wherein the terpene comprises at least one of: an acyclic terpene; a cyclic terpene; a monoterpene; a diterpene; an oligoterpene; and/or a polyterpene.

87. The article of any one of claims 62-86, wherein the active ingredient comprises carvacrol.

88. The article of any one of claims 62-87, wherein the active ingredient comprises limonene.

89. The article of any one of claims 62-88, wherein the active ingredient comprises ethyl formate.

90. The article of any one of claims 62-89, wherein the active ingredient comprises spearmint oil.

91. The article of any one of claims 62-90, wherein the active ingredient comprises carvone.

92. The article of any one of claims 62-91, wherein the delivery material comprises a silicate material.

93. The article of any one of claims 62-92, wherein the delivery material comprises silica.

94. A device comprising an article as in any one of claims 62-93 within an internal volume of a housing, wherein the housing comprises a housing inlet, a housing outlet, and a pump fluidically connected to the housing inlet.

95. A system, comprising a device as in claim 94 and an enclosure, the enclosure comprising an internal volume, wherein the internal volume of the enclosure is fluidically connected to the housing inlet and the housing outlet of the device.

96. A system, comprising:
a device comprising:
a housing, comprising:
a housing inlet,
a housing outlet, and
an internal volume of the housing comprising a bed comprising a particulate delivery material associated with an active ingredient, the internal volume of the housing being between the housing inlet and the housing outlet; and
a pump comprising a pump outlet, the pump outlet fluidically connected to the housing inlet; and
an enclosure comprising an internal volume;
wherein:
the internal volume of the enclosure is fluidically connected to the housing inlet and the housing outlet;
the pump is configured to direct a flow of gaseous fluid into the housing inlet, through the internal volume of the housing, and out of the housing outlet; and
the system is configured to retain the active ingredient.

97. The system of claim 96, wherein the flow of gaseous fluid has a volumetric rate of greater than or equal to 100 L/s at the housing outlet.

98. The system of any one of claims 96-97, wherein the flow of gaseous fluid has an average linear velocity of greater than or equal to 0.1 m/s at the housing outlet.

99. The system of any one of claims 96-98, wherein the bed comprises at least 1 g of the delivery material.

100. The system of any one of claims 96-99, wherein the housing has a maximum lateral dimension greater than or equal to 0.2 m.

101. The system of any one of claims 96-100, wherein the device further comprises a filter between the internal volume and the housing outlet and/or operatively coupled to the housing outlet.

102. The system of any one of claims 96-101, wherein the device further comprises a filter between the internal volume and the pump.

103. The system of any one of claims 96-102, wherein the device further comprises a filter between the internal volume and the housing inlet.

104. The system of any one of claims 96-103, wherein the system is configured to retain the active ingredient at an equilibrium vapor concentration.

105. The system of any one of claims 96-104, wherein the system is configured to retain at least 95 mol % of a released active ingredient for a period of at least 1 hour over which the pump is operated.

106. The system of any one of claims 96-105, wherein the device is at least partially contained within the internal volume of the enclosure.

107. The system of any one of claims 96-106, wherein the device is fully contained within the internal volume of the enclosure.

108. The system of any one of claims 96-105, wherein the device is external to the internal volume of the enclosure.

109. The system of any one of claims 96-108, wherein the housing inlet and/or the outlet are fluidically connected to the enclosure via a conduit.

110. The system of any one of claims 96-109, wherein the delivery material is contained within one or more sachets.

111. The system of any one of claims 96-110, wherein the system comprises one or more agricultural and/or horticultural products within the internal volume of the enclosure.

112. The system of any one of claim 111, wherein at least one of the one or more agricultural and/or horticultural products is post-harvest.

113. The system of any one of claims 111-112, wherein at least one of the one or more agricultural and/or horticultural products is pre-harvest.

114. The system of any one of claims 111-113, wherein the one or more agricultural and/or horticultural products are exposed to the active ingredient.

115. The system of any one of claims 96-114, wherein the active ingredient is volatile.

116. The system of any one of claims 96-115, wherein the gaseous fluid comprises a gas.

117. The system of any one of claims 96-116, wherein the gaseous fluid is a gas.

118. The system of any one of claims 96-116, wherein the gaseous fluid comprises a supercritical fluid.

119. The system of any one of claims 96-118, wherein the system is configured such that the active ingredient is released at a temperature of greater than or equal to −80° C. and less than or equal to 50° C.

120. The system of any one of claims 96-119, wherein the system is configured such that the active ingredient is released at a temperature of greater than or equal to −2° C. and less than or equal to 50° C.

121. The system of any one of claims 96-120, wherein the active ingredient comprises a cyclopropene.

122. The system of any one of claims 96-121, wherein the active ingredient comprises 1-MCP.

123. The system of any one of claims 96-122, wherein the pump comprises a fan.

124. The system of any one of claims 96-123, wherein the delivery material comprises a carbon material.

125. The system of any one of claims 96-124, wherein the delivery material comprises activated carbon.

126. The system of any one of claims 96-125, wherein the delivery material is activated carbon.

127. The system of any one of claims 96-126, wherein the delivery material is particulate.

128. The system of any one of claims 96-127, wherein the system is configured such that the active ingredient is released at a temperature of greater than or equal to −2° C. and less than or equal to 15° C.

129. The system of any one of claims 96-128, wherein the system is configured such that the active ingredient is released at a temperature of greater than or equal to −2° C. and less than or equal to 6° C.

130. The system of any one of claims 96-129, wherein the active ingredient comprises at least one of: an ethylene inhibitor; an inhibitor of ethylene biosynthesis; an inhibitor of a fruit and vegetable membrane degrading phospholipase; a sprout suppressant; an organic acid; a derivative of an organic acid; an ester-derivative of an organic acid; a volatile plant hormone; an essential oil; a terpene; a terpenoid; a mint extract; a phenolic compound; hydrogen peroxide; hexanal; a Fenugreek extract; an ethylene promoter; a plant growth regulator; a biopesticide; a phospholipase-D inhibitor; an antimicrobial; an antifungal; an antibacterial; an antiviral; thymol; hexanal; carvacrol; eugenol; eugenyl acetate; eucalyptol; menthol; farnesol; clove oil; lemongrass; limonene; and/or vanillin.

131. The system of any one of claims 96-130, wherein the active ingredient comprises an ethylene inhibitor.

132. The system of any one of claims 96-131, wherein the active ingredient comprises an inhibitor of a fruit and vegetable membrane degrading phospholipase, and wherein the inhibitor of a fruit and vegetable membrane degrading phospholipase comprises N-(2-chloro-4-pyrridinyl)N-phenyl urea.

133. The system of any one of claims 96-132, wherein the active ingredient comprises a sprout suppressant, and wherein the sprout suppressant comprises at least one of: an essential oil; carvone; isopropyl-N-(3-chlorophenyl) carbamate; 3-decen-2-one; 1,4-dimethylnaphthalene; and/or citral.

134. The system of any one of claims 96-133, wherein the active ingredient comprises an organic acid, and wherein the organic acid comprises at least one of: jasmonic acid; glyoxylic acid; fumaric acid; citric acid; sorbic acid; succinic acid; propionic acid; and/or acetic acid.

135. The system of any one of claims 96-134, wherein the active ingredient comprises an organic acid derivative, and wherein the organic acid derivative comprises at least one of: jasmonate; glyoxylate; methyl jasmonate; ethyl jasmonate; methyl glyoxylate; and/or ethyl glyoxylate.

136. The system of any one of claims 96-135, wherein the active ingredient comprises an ester-derivative of an organic acid, and wherein the ester-derivative of the organic acid comprises an alkyl formate.

137. The system of any one of claims 96-136, wherein the active ingredient comprises a volatile plant hormone, and wherein the volatile plant hormone comprises at least one of: methyl salicylate; methyl jasmonate; (Z)-3hexenyl acetate; (z)-3-hexenal; (E)-beta-farnesene; (E)-beta-caryophyllene, (E)-beta-ocimene, Linalool, (E)-4,8-dimethyl-1,3,7-nonatriene; menthol; and/or (E,E)-4,8,12-trimethyl-1,3,7,11-tridecatetraene.

138. The system of any one of claims 96-137, wherein the active ingredient comprises an essential oil, and wherein the essential oil comprises at least one of: a terpene; a terpenoid; a phenolic compound; oregano oil; clove oil; lemongrass oil; peppermint oil; acacia oil; dill oil; neem oil; orange peel oil; lemon peel oil; rosemary oil; thyme oil; spearmint oil; caraway seed oil; dill seed oil; orange peel oil; mandarin orange peel oil; kuromoji oil; gingergrass oil; peppermint oil; clove oil; garlic oil; Ruta chalepensis L. oil; eucalyptus oil; coriander oil; sagebrush oil; rosemary oil; muna oil; jasmine oil; methyl jasmonate; and/or rapeseed oil.

139. The system of any one of claims 96-138, wherein the active ingredient comprises a terpene, and wherein the terpene comprises at least one of: an acyclic terpene; a cyclic terpene; a monoterpene; a diterpene; an oligoterpene; and/or a polyterpene.

140. The system of any one of claims 96-139, wherein the active ingredient comprises carvacrol.

141. The system of any one of claims 96-140, wherein the active ingredient comprises limonene.

142. The system of any one of claims 96-141, wherein the active ingredient comprises ethyl formate.

143. The system of any one of claims 96-142, wherein the active ingredient comprises spearmint oil.

144. The system of any one of claims 96-143, wherein the active ingredient comprises carvone.

145. The system of any one of claims 96-144, wherein the delivery material comprises a silicate material.

146. The system of any one of claims 96-145, wherein the delivery material comprises silica.

147. The system of any one of claims 96-146, wherein the pump comprises a compressed gas cylinder.

148. The system of any one of claims 96-147, wherein the pump outlet is in fluidic communication with the housing inlet.

149. The system of any one of claims 96-148, wherein the enclosure is a refrigerated enclosure.

150. The system of any one of claims 96-149, wherein the bed comprises one or more sachets comprising the delivery material and the active ingredient.

151. The system of any one of claims 96-150, wherein the pump is part of a refrigeration unit

152. The system of any one of claims 96-151, wherein the enclosure is part of or configured to be part of a vehicle.

153. A method, comprising:
directing a flow of gaseous fluid into a housing that comprises a housing inlet, a housing outlet, and an internal volume containing a bed comprising a particulate delivery material and an active ingredient, such that the gaseous fluid flows into the housing inlet, through the bed, and out of the housing outlet.

154. A method, comprising:
directing a flow of gaseous fluid into a housing that comprises a housing inlet, a housing outlet, a filter, and an internal volume containing a bed comprising a delivery material and an active ingredient, such that the gaseous fluid flows into the housing inlet, through the bed, through the filter, and out of the housing outlet.

155. A method, comprising:
directing a flow of gaseous fluid through a quantity of a porous and solid delivery material, thereby releasing an effluent stream comprising an active ingredient from the delivery material at a volumetric flow rate of greater than or equal to 100 L/s.

156. A method, comprising:
directing a flow of gaseous fluid through a quantity of a porous and solid delivery material that comprises at least 1 g, thereby releasing an effluent stream comprising an active ingredient from the delivery material.

157. A method, comprising:
directing a flow of gaseous fluid through a bed comprising a porous and solid delivery material and an active ingredient, thereby releasing an effluent stream comprising the active ingredient into a refrigerated enclosure.

158. The method of claim 157, wherein the bed is contained within an internal volume of a housing comprising a housing inlet and a housing outlet.

159. The method of any one of claims 155-158, wherein the effluent stream is a gas.

160. The method of any one of claims 153-154 or 158-159, wherein the flow of gaseous fluid has a volumetric flow rate of greater than or equal to 100 L/s at the housing outlet.

161. The method of any one of claims 153-154 or 158-160, wherein the flow of gaseous fluid has an average linear velocity of greater than or equal to 0.1 m/s at the housing outlet.

162. The method of any one of claims 153-154 and 158-161, wherein the bed comprises at least 1 g of the delivery material.

163. The method of any one of claims 153-154 and 158-162, wherein the housing has a maximum lateral dimension greater than or equal to 0.2 m.

164. The method of any one of claims 153-163, wherein the flow of gaseous fluid is directed by a pump.

165. The method of claim 164, wherein the housing further comprises a filter between the internal volume and the pump.

166. The method of any one of claims 153-154 and 158-165, wherein the housing further comprises a filter between the internal volume and the housing inlet.

167. The method of any one of claims 153-154 and 158-166, further comprising continuing to direct the flow of gaseous fluid at least until a concentration of the active ingredient at the housing inlet is within 5% of the concentration of the active ingredient at the housing outlet.

168. The method of any one of claims 153-167, wherein the gaseous fluid comprises a gas.

169. The method of any one of claims 153-168, wherein the gaseous fluid is a gas.

170. The method of any one of claims 153-168, wherein the gaseous fluid comprises a supercritical fluid.

171. The method of any one of claims 153-170, wherein the active ingredient is released at a temperature of greater than or equal to −80° C. and less than or equal to 50° C.

172. The method of any one of claims 153-171, wherein the active ingredient is released at a temperature of greater than or equal to −2° C. and less than or equal to 50° C.

173. The method of any one of claims 153-172, wherein the active ingredient comprises a cyclopropene.

174. The method of any one of claims 153-173, wherein the active ingredient comprises 1-MCP.

175. The method of any one of claims 153-174, further comprising exposing an agricultural and/or a horticultural product to the released active ingredient.

176. The method of any one of claims 153-175, wherein the delivery material comprises a carbon material.

177. The method of any one of claims 153-176, wherein the delivery material comprises activated carbon.

178. The method of any one of claims 153-177, wherein the delivery material is activated carbon.

179. The method of any one of claims 153-178, wherein the delivery material is particulate.

180. The method of any one of claims 153-179, wherein the active ingredient is released at a temperature of greater than or equal to −2° C. and less than or equal to 15° C.

181. The method of any one of claims 153-180, wherein the active ingredient is released at a temperature of greater than or equal to −2° C. and less than or equal to 6° C.

182. The method of any one of claims 153-181, wherein the active ingredient comprises at least one of: an ethylene inhibitor; an inhibitor of ethylene biosynthesis; an inhibitor of a fruit and vegetable membrane degrading phospholipase; a sprout suppressant; an organic acid; a derivative of an organic acid; an ester-derivative of an organic acid; a volatile plant hormone; an essential oil; a terpene; a terpenoid; a mint extract; a phenolic compound; hydrogen peroxide; hexanal; a Fenugreek extract; an ethylene promoter; a plant growth regulator; a biopesticide; a phospholipase-D inhibitor; an antimicrobial; an antifungal; an antibacterial; an antiviral; thymol; hexanal; carvacrol; eugenol; eugenyl acetate; eucalyptol; menthol; farnesol; clove oil; lemongrass; limonene; and/or vanillin.

183. The method of any one of claims 153-182, wherein the active ingredient comprises an ethylene inhibitor.

184. The method of any one of claims 153-183, wherein the active ingredient comprises an inhibitor of a fruit and vegetable membrane degrading phospholipase, and wherein the inhibitor of a fruit and vegetable membrane degrading phospholipase comprises N-(2-chloro-4-pyrridinyl)N-phenyl urea.

185. The method of any one of claims 153-184, wherein the active ingredient comprises a sprout suppressant, and wherein the sprout suppressant comprises at least one of: an essential oil; carvone; isopropyl-N-(3-chlorophenyl) carbamate; 3-decen-2-one; 1,4-dimethylnaphthalene; and/or citral.

186. The method of any one of claims 153-185, wherein the active ingredient comprises an organic acid, and wherein the organic acid comprises at least one of: jasmonic acid; glyoxylic acid; fumaric acid; citric acid; sorbic acid; succinic acid; propionic acid; and/or acetic acid.

187. The method of any one of claims 153-186, wherein the active ingredient comprises an organic acid derivative, and wherein the organic acid derivative comprises at least one of: jasmonate; glyoxylate; methyl jasmonate; ethyl jasmonate; methyl glyoxylate; and/or ethyl glyoxylate.

188. The method of any one of claims 153-187, wherein the active ingredient comprises an ester-derivative of an organic acid, and wherein the ester-derivative of the organic acid comprises an alkyl formate.

189. The method of any one of claims 153-188, wherein the active ingredient comprises a volatile plant hormone, and wherein the volatile plant hormone comprises at least one of: methyl salicylate; methyl jasmonate; (Z)-3hexenyl acetate; (z)-3-hexenal; (E)-beta-farnesene; (E)-beta-caryophyllene, (E)-beta-ocimene, Linalool, (E)-4,8-dimethyl-1,3,7-nonatriene; menthol; and/or (E,E)-4,8,12-trimethyl-1,3,7,11-tridecatetraene.

190. The method of any one of claims 153-189, wherein the active ingredient comprises an essential oil, and wherein the essential oil comprises at least one of: a terpene; a terpenoid; a phenolic compound; oregano oil; clove oil; lemongrass oil; peppermint oil; acacia oil; dill oil; neem oil; orange peel oil; lemon peel oil; rosemary oil; thyme oil; spearmint oil; caraway seed oil; dill seed oil; orange peel oil; mandarin orange peel oil; kuromoji oil; gingergrass oil; peppermint oil; clove oil; garlic oil; Ruta chalepensis L. oil; eucalyptus oil; coriander oil; sagebrush oil; rosemary oil; muna oil; jasmine oil; methyl jasmonate; and/or rapeseed oil.

191. The method of any one of claims 153-190, wherein the active ingredient comprises a terpene, and wherein the terpene comprises at least one of: an acyclic terpene; a cyclic terpene; a monoterpene; a diterpene; an oligoterpene; and/or a polyterpene.

192. The method of any one of claims 153-191, wherein the active ingredient comprises carvacrol.

193. The method of any one of claims 153-192, wherein the active ingredient comprises limonene.

194. The method of any one of claims 153-193, wherein the active ingredient comprises ethyl formate.

195. The method of any one of claims 153-194, wherein the active ingredient comprises spearmint oil.

196. The method of any one of claims 153-195, wherein the active ingredient comprises carvone.

197. The method of any one of claims 153-196, wherein the delivery material comprises a silicate material.

198. The method of any one of claims 153-197, wherein the delivery material comprises silica.

199. The method of any one of claims 153-156 and 159-198, wherein the bed is within an enclosure.

200. The method of claim 199, wherein the enclosure is a refrigerated enclosure.

201. The method of any one of claims claim 157-198, wherein the bed is within the refrigerated enclosure.

202. The method of any one of claims 164-201, wherein the pump is within the enclosure.

203. The method of any one of claims 153-154 and 157-202, wherein the bed comprises one or more sachets comprising the delivery material and the active ingredient.

204. The method of any one of claims 164-203, wherein the pump is part of a refrigeration unit

205. The method of any one of claims 199-204, wherein the enclosure is part of or configured to be part of a vehicle.

206. The method of any one of claims 153-205 performed using:
(a) the device of any one of claims 1-54 and 95,
(b) the system of any one of claims 55-61 and 95-152, and/or
(c) the article of any one of claims 62-93.
